(19) United States
(12) Patent Application Publication
(10) Pub. No.: US 2016/0251964 A1
(43) Pub. Date: Sep. 1, 2016

(54) APPARATUS AND METHODS FOR ENERGY CONVERSION

(71) Applicants: Luis Indefonso Solorzano, Cutler Bay, FL (US); Eudes Vera, Barcelona (VE)

(72) Inventors: Luis Indefonso Solorzano, Cutler Bay, FL (US); Eudes Vera, Barcelona (VE)

(21) Appl. No.: 14/953,653

(22) Filed: Nov. 30, 2015

Related U.S. Application Data
(63) Continuation-in-part of application No. 12/589,578, filed on Oct. 26, 2009, now abandoned.

(51) Int. Cl. F01D 5/12; F03B 13/10; F03B 3/04; F01D 25/24; F03D 1/06; F03D 9/00; F03D 9/32; F01D 15/10; F03B 3/18; F03D 1/04

(52) U.S. Cl. CPC F01D 5/12; F03B 3/18; F03B 13/10; F03B 3/04; F03D 1/04; F03D 1/06; F03D 9/002; F03D 9/32; F01D 15/10; F01D 25/24; F05D 2220/30; F05D 2240/30

(57) ABSTRACT

The present invention provides an energy conversion turbine having at least the following components: a central shaft having a rotational axis, a series of blades in mechanical connection with and disposed around the central shaft, wherein the turbine is configured such that fluid flowing about the blades causes the temperature about one blade face to become lower than the temperature about the opposing blade face. Each blade may be airfoil-shaped and may have at least one curved face such that, when facing an incident fluid flow, the fluid flow passing over one side of the airfoil has a greater velocity than that passing over the opposing side, this achieving the temperature differential required. The airfoils may be mounted between two concentric cylinders, the concentric cylinders being coaxial with the rotational axis of the central shaft. Typically, the turbine is rotationally mounted within a Venturi-like throat, and in some forms of the invention fluid straighteners are disposed at either or both ends of the throat, and in between two consecutive turbines. Some forms also provide a fluid flow accelerator upstream from the turbine and a fluid flow decelerator downstream from the turbine. Also provided are methods for generating power, such as electrical power using the turbine.

### FIELD OF THE INVENTION

The present invention relates to generally the field of energy conversion. More particularly, the invention relates to apparatus and methods for generating power (such as electrical power) for use by a population of consumers or even a single consumer.

### BACKGROUND OF THE INVENTION

With global energy consumption increasing day by day there is a high demand for energy, and particularly energy produced by methods which do not contribute to global warming. Where fossil fuels are used for energy generation, it is generally desired to improve the efficiency of turbines used to convert the chemical energy of the fuel into other forms of energy such as kinetic or electrical energy. For turbines having a higher efficiency, lower amounts of fuel need be be combusted to provide a unit of output energy.

Since the earth's natural energy reserves are becoming depleted and prices of oil and natural gas are relatively high, new sources of clean, abundant and inexpensive energy are urgently required.

It is surprising that despite the huge energy reservoirs contained in the atmosphere and in rivers, streams, lakes, and submarine currents all over the world, only a very small proportion is harvested by present day energy conversion apparatus and at high cost. For example, prior art wind turbines used for generating power in excess of 1 MW are of significant size and weight, and furthermore are very expensive to build. Another disadvantage is the very low efficiency of generation, which is constrained (at least theoretically) by Betz's limit Even domestic scale wind turbines are not overly useful given the low efficiencies inherent in the designs.

It is an aspect of the present invention to overcome or ameliorate a problem of prior art energy conversion means. Alternatively, it is an aspect to provide an economically viable alternative to prior art energy conversion means.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides an energy conversion turbine comprising: a central shaft having a rotational axis, a plurality of blades in mechanical connection with and disposed around the central shaft, wherein the turbine is configured such that fluid flowing about the blades causes the temperature about one blade face to become lower than the temperature about the opposing blade face.

In one embodiment of the turbine, the blades are airfoil-shaped.

In one embodiment of the turbine, the blades are mounted between two concentric cylinders, the concentric cylinders being substantially coaxial with the rotational axis of the central shaft. In one embodiment of the turbine, the inner concentric cylinder is in mechanical connection with the central shaft.

In a second aspect, there is provided a power conversion machine comprising: a fluid accelerator, a throat having a fluid inlet and a fluid outlet, and the turbine as described herein disposed within the throat and rotatable therein, wherein the machine is configured such that fluid accelerated by the fluid accelerator is caused to pass through the throat so as to cause rotation of the turbine.

In one embodiment of the power conversion machine, the fluid accelerator is a conduit having a fluid inlet and a fluid outlet, the conduit fluid outlet being in fluid communication with the throat fluid inlet.

In one embodiment of the power conversion machine, the conduit is a convergent nozzle.

In one embodiment of the power conversion machine, the fluid accelerator accelerates the fluid velocity by means requiring energy input.

In one embodiment of the power conversion machine, the means requiring energy input is a fan configured to accelerate and drive fluid toward the turbine.

In one embodiment of the power conversion machine, the fan is rotatable within the throat, and is coaxial with the turbine.

In one embodiment of the power conversion machine, the means requiring energy input is a moving object to which the machine is attached. For example, the power conversion machine may be attached to an aircraft with movement of the aircraft forcing air through the machine

In one embodiment, the power conversion machine comprises a fluid decelerator configured to decelerate fluid exiting the turbine.

In one embodiment of the power conversion machine, the fluid decelerator is a conduit having a fluid inlet and a fluid outlet, the conduit fluid inlet being in fluid communication with the throat fluid outlet.

In one embodiment of the power conversion machine, the conduit is a divergent nozzle. In one embodiment of the power conversion machine, the throat is a Venturi-like throat. In one embodiment, the power conversion machine comprises two or more turbines as described, all turbines being coaxial.

In one embodiment, the power conversion machine comprises a fluid flow straightener configured to straighten to flow of fluid entering the throat or exiting the throat.

In one embodiment, the power conversion machine comprises two fluid flow straighteners, the first straightener configured to straighten to flow of fluid entering the throat, and the second straightener configured to straighten flow of fluid exiting the throat.

In one embodiment, the power conversion machine comprises more than two fluid flow straighteners placed in between a fan and a turbine, or between two consecutive turbines.

In a third aspect the present invention provides a method of generating power comprising the steps of: providing the power conversion machine as described herein, providing fluid flow to the turbine, the fluid flow being incident on the leading edges of the blades, the fluid flow being sufficient to cause the central shaft to rotate, and harnessing the power generated from the rotational output of the central shaft.

In one embodiment, the method comprises the step of providing energy input to the means requiring energy input (where present) so as to accelerate and drive fluid toward the turbine.

### BRIEF DESCRIPTION OF THE DRAWINGS

The drawings are not shown at any specific scale.

FIG. 1 shows an oblique view of a Thermal Airfoil Turbine of the invention.

FIG. 2 shows a front view of a Thermal Airfoil Turbine, as normally placed

FIG. 3 shows a lateral view of the Thermal Airfoil Turbine

FIG. 4 shows an oblique view of an airfoil, as used in a Thermal Airfoil Turbine.

FIG. 5 shows a view from above of a Thermal Airfoil Turbine at the upper side, showing only the airfoil on top of the inner cylinder of the Thermal Airfoil Turbine, so as to highlight the angled position of the airfoils.

FIG. 6 shows an oblique view of a section of a Thermal Airfoil Turbine, so as to highlight the angled position of the airfoils.

FIG. 7 shows a working diagram of a Thermal Airfoil Turbine, so as to highlight the mechanical operation of this device.

FIG. 8 shows a possible application of a Thermal Airfoil Turbine, used as the main or fundamental component of an Aeolian Generator.

FIG. 9A shows the front view of a possible application of a Thermal Airfoil Turbine used as a fundamental component of a moving Vehicle

FIG. 9B shows a lateral view of a possible application of a Thermal Airfoil Turbine used as a fundamental component of a moving Vehicle.

FIG. 10 shows an airfoil statically placed with an exaggerated attack angle of 45°, within an airflow of horizontal velocity V.

FIG. 11 shows how the airflow of horizontal velocity Vφ “sees” the former airfoil when it moves at a vertical velocity V_{L}=0.577735 Vφ.

FIG. 12 shows the power generated and power applied of a turbine, with certain specific sizes and configuration

FIG. 13 shows the forces acting on a blade when impacted by a fluid with velocity Vφ.

FIG. 14 shows schematically the constituent components of a Fluid Accelerating (FA) chamber or converging nozzle and its constituent parts.

FIG. 15 shows schematically the constituent components of an exhaust chamber or diverging nozzle and its constituent parts.

FIG. 16 shows schematically some truncated cones that coaxially conform with a central cone (shown in FIG. 14(d), and FIG. 15(d)) either a converging or a diverging nozzle.

FIG. 17 shows schematically a convergent flow sub-path formed with two coaxial truncated cones (TC7 and TC8) for improving the laminarity of the flow path.

FIG. 18 shows schematically (a) a longitudinal view of an energy conversion machine containing two turbines and two fluid straighteners; (b) a frontal view of the energy conversion machine; (c) a cross -sectional view of the Venturi-like throat of the energy conversion machine.

FIG. 19 shows schematically (a) a frontal view of an aerodynamic fluid turbine containing 8 airfoils; (b) a side view of the turbine.

FIG. 20 shows schematically a fluid straightener and some of its constituent parts.

FIG. 21 shows schematically (a) a longitudinal view of a simple energy conversion machine having 2 fluid turbines, 2 flow straighteners and no nozzles; (b) a cross-sectional view of the Venturi-like throat of the energy conversion machine.

FIG. 22 shows schematically (a) a longitudinal view of an energy conversion machine containing four fluid turbines and no fluid straighteners; (b) a frontal view of the energy conversion machine; (c) a cross-sectional view of the Venturi-like throat of the energy conversion machine.

FIG. 23 shows schematically (a) a longitudinal view of a simple energy conversion machine having a single fluid turbine; (b) Forces acting on a fluid turbine blade element, and velocities and angles involved.

FIG. 24 shows schematically (a) a frontal view of a mechanical axial fan; (b) a lateral view of an electric axial fan showing its motor M.

FIG. 25 shows the frontal and rear view of a typical axial fan moved by an electric dc brushless motor placed centrally in its stator.

FIG. 26 shows schematically two building blocks for implementing energy conversion machines and fluid panels using electric fans, namely, (d) flow straightener enclosed in box; (e) electric fan enclosed in box.

FIG. 27 shows schematically two building blocks for implementing energy conversion machines and fluid panels using electric fans, namely, (d) diverging nozzle enclosed in box; (d) converging nozzle enclosed in box.

FIG. 28 shows a schematic diagram of (a) a longitudinal view of an energy conversion machine implemented with four fluid straighteners and four electric fans; (b) a longitudinal view of an energy conversion machine implemented with eight electric fans and no fluid straighteners.

FIG. 29 shows schematically a longitudinal view of an energy conversion machine (air electric generator), implemented with eight electric fans and no fluid straighteners.

FIG. 30 shows schematically the longitudinal views of two possible implementations of an accelerated wind turbine built with (a) five flow straighteners and four thermal airfoil turbines; (b) five flow straighteners and four electric fans.

FIG. 31 shows schematically (a) the front view of an air motor implemented with a large fan at entrance of FA chamber, two thermal airfoil turbines and two fluid straighteners; (b) the longitudinal view of the air motor; (c) the front view of an air electric generator implemented with two electric fans and two flow straighteners; and (d) the longitudinal view of the air electric generator.

FIG. 32 shows schematically a symmetric vertical water motor with two thermal airfoil turbines and three fluid straighteners.

FIG. 33 shows schematically a fluid panel consisting of 8 energy conversion machines each containing 8 electric fans. This fluid panel may be used as a wind panel or as a water panel to generate electricity out of wind or water.

FIG. 34 shows schematically two floors of vertically separated fluid panels covering fluid flowing in four geographical directions containing a total of 128 electric fans.

FIG. 35 shows the equivalent circuit of a fluid electric generator.

FIG. 36 shows a schematic diagram of a vertical accelerated water electric generator.

FIG. 37 shows schematically a horizontal water electric generator submerged at a depth ho (For underwater electrical energy generation).

FIG. 38 shows two typical radial fans and their schematic representation.

FIG. 39 shows schematically four possible implementations of an open energy conversion machine using 2 radial fans and 4 axial fans placed in the straight section of the radial fans.

FIG. 40 shows in perspective two energy conversion machines with different dimensions that may be interconnected to form a tandem AFM; (a) longitudinal view of AFM 1; (b) frontal view of throat of AFM 1; (c) longitudinal view of AFM 2; (d) frontal view of throat of AFM 2.

FIG. 41 shows a longitudinal view of a tandem energy conversion machine containing 2 large turbines pertaining to the AFM 1 stage, and 4 smaller turbines pertaining to AFM 2 stage.

FIG. 42 shows schematically an experimental tandem air electric generator; (a) Rear view; (b) Front view; (c) Longitudinal view.

FIG. 43 shows schematically (a) empty chamber of a closed chamber toroidal fluid electric generator; with gradual transitions between the straight sections and the curved sections (two 180° bends); (b) empty chamber of a closed chamber toroidal fluid electric generator; with four 90° transitions between the straight sections and the curved sections.

FIG. 44 shows schematically a closed chamber fluid electric generator with two 180° bends. It includes two identical tandem energy conversion machines and may be used to generate electricity from air or water circulating within by the action of fans F1 and F2.

FIG. 45A shows schematically a closed chamber fluid electric generator with four 90° bends. It includes two identical tandem energy conversion machines, and may be used to generate electricity from air or water circulating within by the action of fans F1 and F2.

FIG. 45B shows schematically a Closed Chamber Accelerated Fluid Machine with four 90° bends (B1, B2, B3, and B4). It includes four fans (F1, F2, F3, and F4), four turbines T1, T2, T3, and T4), and ten flow straighteners. It can generate electricity from air or water circulating within by the action of the fans. The machine can contain more or less fans and turbines. Of course, the larger the number of fans and turbines the larger the power may be generated.

FIG. 46A shows schematically (a) a diagram of an open chamber FEG using 2 radial fans with eyes on opposite sides and 4 axial fans placed in the straight section joining both radial fans; (b) a tri-dimensional view of a closed chamber accelerated fluid machine for radial fans.

FIG. 46B shows schematically a longitudinal view of a DCAF machine containing two generator fans (turbines T1 and T2), and one motor fan F.

FIG. 46C shows schematically a longitudinal view of an asymmetrical AF machine containing one motor fan F and one generator fan (turbine T).

FIG. 47 shows schematically an aircraft with an accelerated wind turbine on its top

FIG. 48 shows a cargo ship carrying a stack of 5 wind voltage generators on deck and a submerged horizontal water electric generator.

FIG. 49 shows schematically a battery of six vertical water electric generators.

FIG. 50 shows a schematic diagram of a wind voltage generator array.

FIG. 51 shows schematically two orthogonally placed AW turbines.

FIG. 52 shows schematically side views of (a) an HAWT machine; (b) an AWT machine.

FIG. 53 shows a Schematic representation of the airflow motor showing 2 thermal airfoil turbines placed in the Venturi-like throat.

FIG. 54 shows converging and diverging nozzles.

FIG. 55 shows converging and diverging nozzles including flow straighteners.

FIG. 56 shows a basic construction module for the Venturi-like throat.

FIG. 57 shows a thermal airfoil turbine with 4 airfoils.

FIG. 58 shows a flow straightener (FS) module.

FIG. 59 shows a frontal view of a Thermal Airfoil Turbine having 7 airfoils.

FIG. 60 shows a perspective view of an aerodynamic airfoil

FIG. 61 shows various views and geometrical parameters of an airfoil.

FIG. 62 is a graph showing torque T developed on turbine axis as a function of the turbine rotational velocity n in rpm. (Na=10 airfoils, D=50 cm, d=25 cm, c=5.4 cm; Vφ=4.4 m/s).

FIG. 63 is a graph showing generated power and drag power for the turbine used for the graph of FIG. 62 as a function of the turbine rotational velocity in rpm

FIG. 64 is a graph showing the difference (PG−PD) as a function of the rotational speed of the turbine.

FIG. 65 shows an airfoil placed forming a static real attack angle with vector Vφ.

FIG. 66 shows Vector composition of velocities Vφ and Vv as related to the airfoil of FIG. 64.

FIG. 67 shows the difference in real and apparent attack angles of an airfoil.

FIG. 68 shows thermal airfoil turbines viewed as an aerodynamic sub-system.

FIG. 69 shows a power and air conditioning system using an airflow motor with two thermal airfoil turbines.

FIG. 70 shows a wind turbine using two thermal airfoil turbines.

FIG. 71 shows a wind turbine using four thermal airfoil turbines.

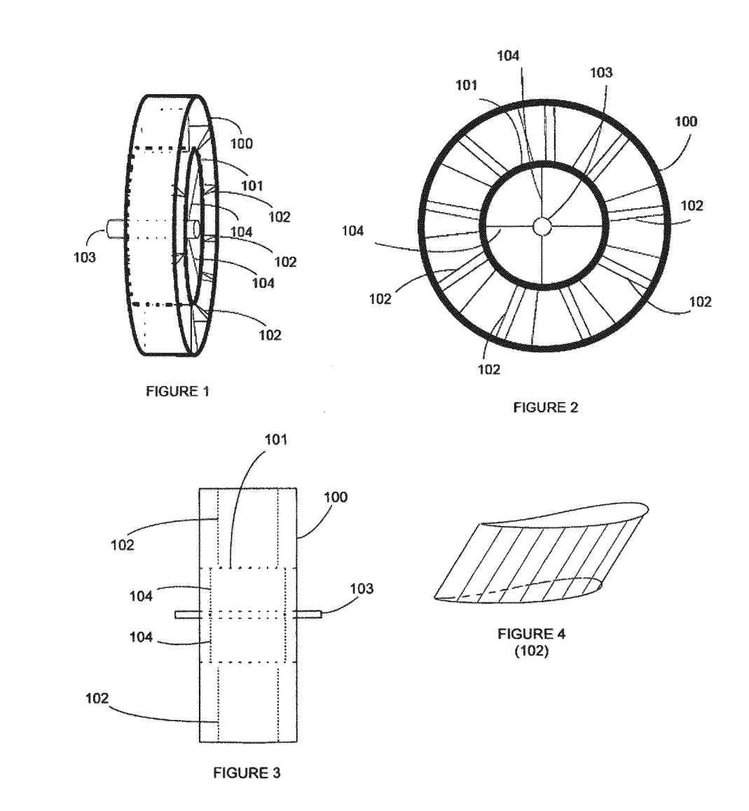

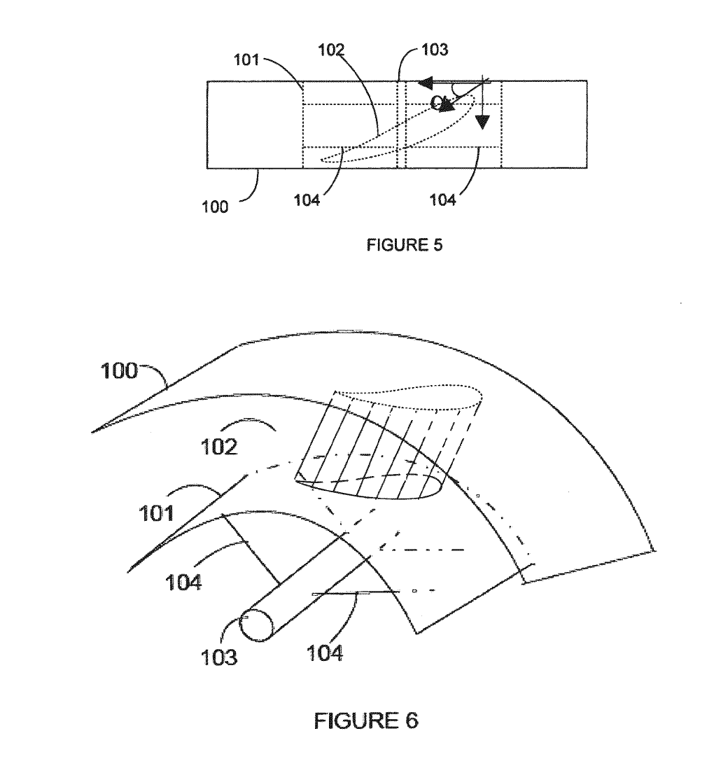

### DETAILED DESCRIPTION OF THE INVENTION

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” or “in some embodiments” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a method comprising step A and step B should not be limited to methods consisting only of methods A and B. Any one of the terms “including” or “which includes” or “that includes” as used herein is also an open term that also means including at least the elements/features that follow the term, but not excluding others. Thus, “including” is synonymous with and means “comprising”.

The present invention is predicated at least in part of the finding that an energy conversion mean having one or more turbines with particular features may generate similar amounts of power to conventional wind turbines but at a lower cost and/or greater efficiency. The present energy conversion turbine may be made with a great reduction in size, height, and weight, and may in some embodiments be portable. In some embodiments, the present turbines may achieve an efficiency higher than that set by Betz's limit.

The advantage of portability provides the ability to generate electrical or mechanical energy at the place of consumption, thereby potentially negating the need for power grids, long transmission and distribution lines.

Furthermore, the portable and compact nature of some embodiments of the present turbine allow for attachment to a moving land, sea or air vehicle so as to harvest considerable energy from the surrounding atmosphere or water when they are placed in direct contact with the environment.

In functional terms the present energy conversion turbine is, in some embodiments, able to transform the thermal power received from an incoming fluid flow (such as air or water, as an exemplary gas and liquid respectively), into mechanical power when the fluid impinges upon the airfoils of the turbine. This power may be recovered as rotational mechanical energy from the shaft of the device. The rotational mechanical energy may be used to drive an electrical generator of the type well known to the skilled artisan, or with optional gearing means, used to propel a vehicle.

In some embodiments, the velocity of the fluid entering the turbine is increased by means requiring energy input and in such situations, the power generated by the present turbine is greater than that input. In some circumstances, the output may be at least about 2, 3, 4, 5, 6, 7, 8, 9, or 10 fold that input.

The present turbine may comprise two or more concentric cylinders (and preferably two) and a series of airfoils (such as at least about 2, 3, 4, 5, 6, 7, 8, 9, 10, 11, 12, 13, 14, 15, 16, 17, 18, 19, or 20), which are suitably placed on and fixed between the cylinders, occupying part of the space separating both cylinders. The airfoils are positioned so as to provide a specific attack angle (and in some embodiments a fixed attack angle) with reference to the airflow direction.

The cylinders may be coaxial with a central shaft; such that at certain rotational velocities, the transformation of the thermal energy of the incident airflow into mechanical energy is effected. This energy may be used to drive either a mechanical system or an electrical system attached onto the shaft. The power that the incident airflow at a certain velocity applies to the airfoils spinning at a certain rotational velocity, is much less than the mechanical power generated by the rotating airfoils, and extracted from the thermal energy of the passing airflow, the relation between the generated power and the applied power can be greater than one, and indeed any multiple. In some embodiments the multiple may be ten or more.

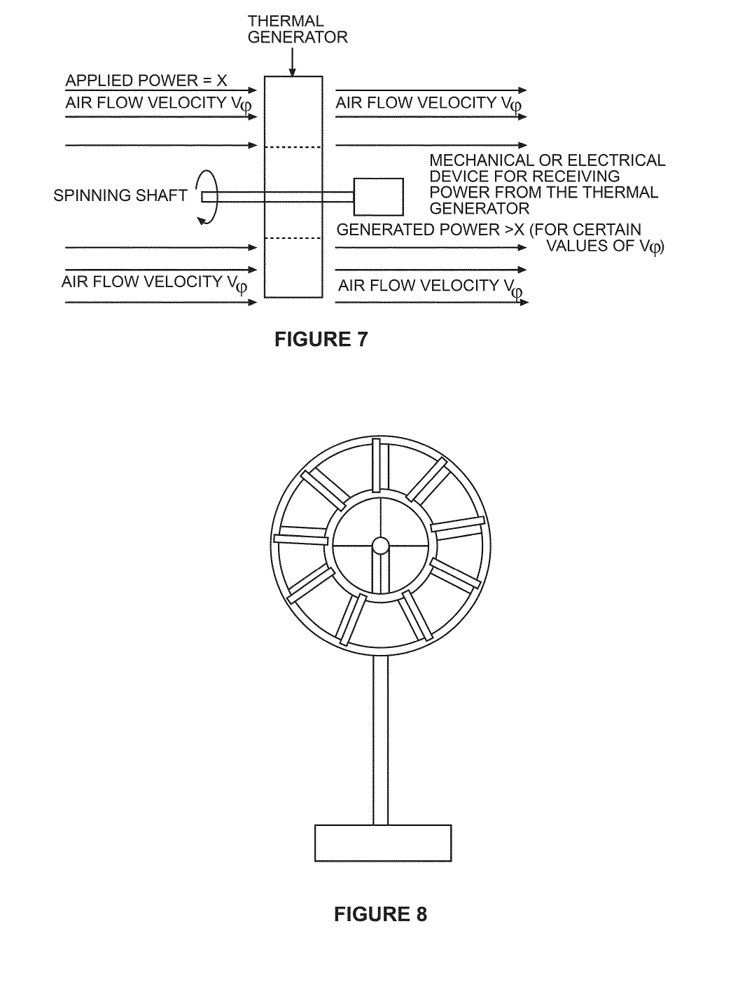

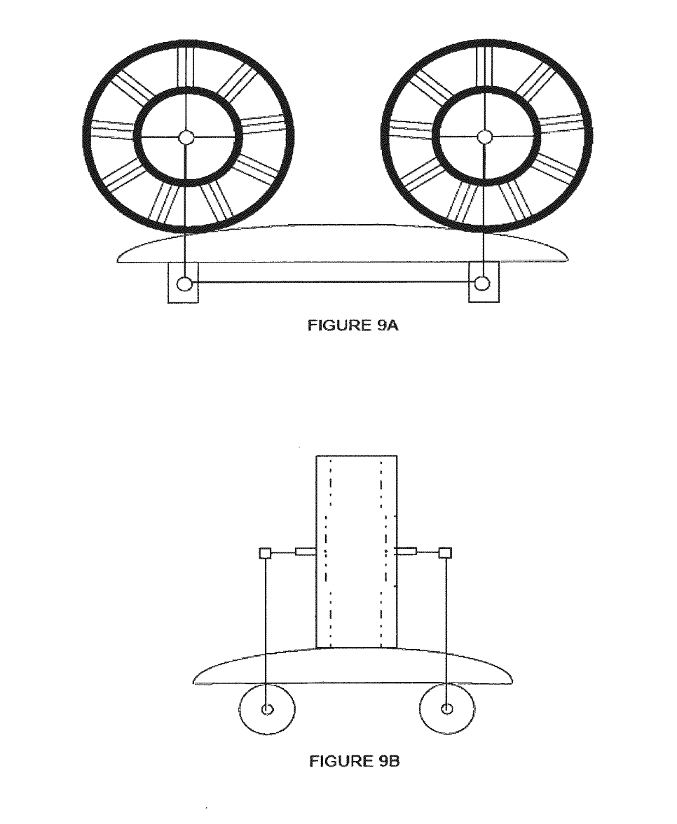

This amplified output power may be delivered to either a mechanical or an electrical element, attached to a rotational shaft, as shown in FIG. 7. The turbine is made with two concentric cylinders (100 and 101), with a series of aerodynamic airfoils (102) which are suitably placed and occupy partially the space between these two cylinders. The airfoils are typically fitted between the two cylinders such that no gaps are present between the airfoils and the cylinders. The embodiment of FIG. 7 is preferred only, and it is possible to achieve the same or similar function with other arrangements, such as where the outside cylinder is static with the cylinder inside rotating, or any other construction pattern that works equally well.

The airfoils placed between the two cylinders may form a predetermined angle (the attack angle) with reference to the airflow direction. The attack angle may be greater than zero, equal to zero or less than zero, or greater than about 10°, however embodiments with higher efficiencies have an exaggerated value of the attack angle of greater than about 15°, 20°, 25°, 30°, 35°, or 45°. In some embodiments the attack angle is in excess of 45°, and may be greater than about50°, 55°, 60°, 65°, 70°, 75°, 80°, or 85°, for instance. At such large attack angles (which are significantly higher than those typically used for airfoils in the aeronautical arts, whereby angles of up to about 10° are typical), the turbine produces more relative power gain, as demonstrated mathematically infra. By relative power gain it is meant the relationship of generated power/applied power is greater than unity.

In order to ensure that the turbine spins as smoothly as possible, the airfoils between the two cylinders should be placed symmetrically so as to provide for a balanced rotation. In some embodiments it is possible, however, to place the airfoils in another disposition with little or no negative effect.

The number of airfoils placed between the two cylinders of the turbine, may be as large as allowable with reference to the dimensions of the turbine overall, so as to obtain a maximum of generated power. Efficiencies are further improved where the airfoils are separated one to each other, a medium distance at least the width of the airfoils. The separation distance between the airfoils is to avoid aerodynamic interference between each other.

In theory, the size of the two cylinders of turbine is unrestricted, however practical manufacturing considerations may preclude the use of very large or very small elements.

Similarly, there are no theoretically restrictions as to the materials that may be employed to fabricate the airfoils and the cylinders. In practice, however, in order to achieve a light structure for the turbine and its easy handling, it is recommended to use plastic materials, resin, acrylic, among other materials for manufacturing the airfoils. For manufacturing the cylinders, a light alloy or light metal such as aluminum, or a light hard plastic may be used.

In order to support the weight of the whole turbine, its rotational shaft (103) may be strong enough, and therefore may be fabricated from a high tensile steel rod or similar material.

The rotational shaft is typically be placed in the center of the turbine, and fixed to the inner cylinder (101) with light and strong rods (104) of equal length. In one embodiment, 8 such rods are used. Alternatively another type of fixing means may be used to attach the center rotational shaft to the inner cylinder.

The airfoils between the two cylinders may be fixed with screws and nuts, a strong adhesive, welding or any other means deemed suitable by the skilled artisan.

It is preferred that all the inner and outer surfaces of the cylinders, and also the surfaces of the airfoils be fabricated to be smooth, so as to reduce the drag force exerted by the fluid flow against the surfaces, in order to reduce power losses due to the drag force.

The airfoils may have any geometrical configuration that function so as to have the effect of transforming the thermal energy of the passing airflow, into mechanical power in the shaft. In some embodiments, the airfoils are configured so as to provide a factor 1 or greater than 1 of the input power received for the airfoils from the airflow entering the turbine.

In one embodiment, the airfoils are the same or similar to those used in the aeronautical arts. In aeronautics, an airfoil-shaped body moved through a fluid produces an aerodynamic force. The component of this force perpendicular to the direction of motion is called lift. The component parallel to the direction of motion is called drag. Subsonic flight airfoils typically have a characteristic shape with a rounded leading edge, followed by a sharp trailing edge, often with a symmetric curvature of upper and lower surfaces. Foils of similar function designed with water as the working fluid are called hydrofoils.

Again in reference to aeronautics, the lift on an airfoil is primarily the result of its angle of attack and shape. When oriented at a suitable angle, the airfoil deflects the oncoming air (for fixed-wing aircraft, a downward force), resulting in a force on the airfoil in the direction opposite to the deflection. This force is known as aerodynamic force and may be resolved into two components: lift and drag. Most foil shapes require a positive angle of attack to generate lift. This “turning” of the air in the vicinity of the airfoil creates curved streamlines, resulting in lower pressure on one side and higher pressure on the other. This pressure difference is accompanied by a velocity difference, via Bernoulli's principle, so the resulting flow about the airfoil has a higher average velocity on the upper surface than on the lower surface. The lift force may be related directly to the average top/bottom velocity difference without computing the pressure by using the concept of circulation and the Kutta-Joukowski theorem

Returning back now to the use of airfoils in the context of the present invention, when the turbine rotates the airfoils' relative attack angle aA that the airflow “sees”, is different from the airfoils' real attack angle α_{R} depending on the rotational velocity. For instance, suppose that the airfoils' real attack angle α_{R} is 45°. In this condition when the angular velocity (RPM) of the turbine is zero, the airflow (with a horizontal linear velocity Vt), “sees” the airfoils with a relative attack angle α_{A} which is equal to the real attack angle α_{R} (that is to say, 45°). However, when the turbine reaches an RPM such that it makes the mean peripheral velocity equal to Vφ (RPMh), the airflow will “see” an airfoils' relative attack angle aA equal to zero. For another rotational velocity varying between zero and RPM h, the airfoils' relative attack angle aA will vary between 45° and zero.

Without wishing to be limited by theory in any way, it is proposed that when the airflow passes through the turbine's airfoils, the airflow above the airfoils travels at a greater velocity than that passing under the airfoils. Accordingly, the air pressure above the airfoil is less than the down pressure in the airfoils (Bernoulli equation), as a consequence the temperature above the airfoils becomes lower than the temperature below the airfoils. That is to say, the airflow loses thermal energy when passing through the turbine's airfoils. Part of this thermal energy lost is transmitted directly to the airfoils, and transformed into kinetic energy when the turbine rotates. Finally this energy is transmitted to the shaft of the turbine. Another part of the thermal energy lost in the upper side of the airfoils, is returned to the environment, when the airflow coming from the upper side of the airfoils, joins and hits the airflow passing downward the airfoils. With this mechanism the energetic equilibrium in the system is restored.

The particular RPM at which the turbine generates a maximum relative power gain (generated power/applied power) is a value lying somewhere between zero and RPM h. In this situation, supposing that the real attack angle is 45°, the airflow will “see” an apparent attack angle, which is very little, of the order of 15° (this occurs only for the RPM that generates maximum relative power gain). In this situation the drag force, and so the airflow's drag power applied to the airfoils will be very little. However, since the lift force of the airfoils in this situation, is far greater than the drag force, then the generated power will be far greater than the drag power, that is to say that there takes place a transformation of power due to the interaction between the turbine airfoils and the incoming airflow. This power transformation causes a relative power gain which is very large (and in some instances 10 or more).

The power generated by the turbine versus its rotational velocity RPM follows a curve that begins with zero RPM and zero generated power. Then, it goes to a maximum value of generated power at an intermediate value of RPM, and finally, it ends with zero generated power at a maximum value of RPM. The curve of the applied power begins with a maximum value at RPM equal to zero, and then the applied power diminishes as RPM increases. Finally this curve ends up with a minimum value of the applied power which is greater than zero.

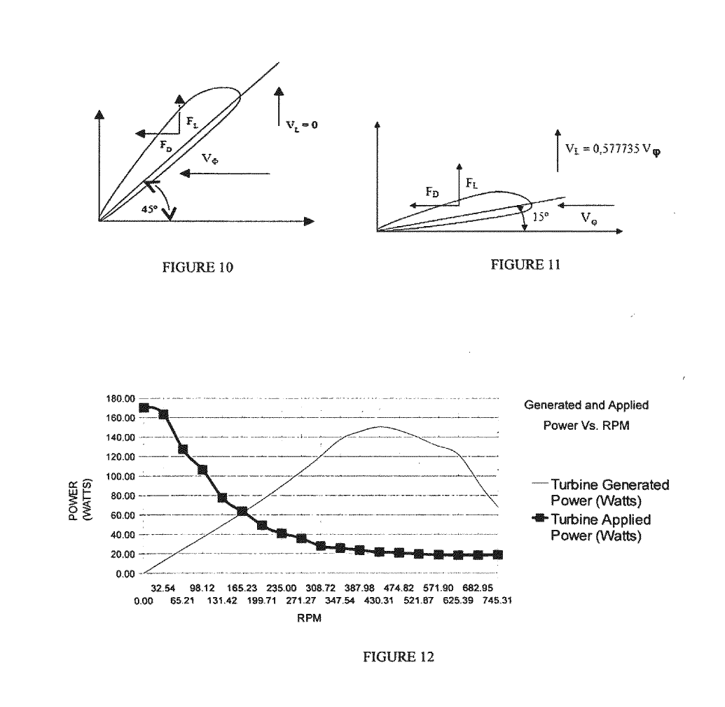

A brief and approximate calculation and only for explaining the working basis of the present turbine, is given below. Suppose that a static airfoil is placed initially at an exaggerated attack angle of 45°, within an airflow of velocity V_{φ}, as shown in FIG. 10.

In this situation the Drag Force FD is very large. Then:

Applied power=F_{D}*V_{φ};

Generated power=F_{L}*V_{L}=F_{L}*0=0

Now consider that the airfoil moves vertically with a velocity V_{L}=0.577735 Vφ. That is to say,

V_{L}/V_{φ}=0.577735=Tg30°.

In this condition the flow with velocity V_{φ}, “sees” the airfoil with an attack angle equal to 45°−30°=15° and the new condition that the airflow will “see” is shown in FIG. 11.

So in this new condition:

Power applied by the airflow to the airfoil=F_{D}*V_{φ}=P_{A}

Power generated by the airfoil=P_{G}=V_{L}*F_{L}=0. 577735 V_{φ}*F_{L}

So that

Power Gain=0.577735Vφ,×F_{L}/(F_{D}×V_{φ})=0.577735F_{L}/F_{D}

It is known in the aeronautical arts that many airfoils in this condition (attack angle of 15°) have a force relation

F_{L}/F_{D}

which is 30, 50 or even more, so that if one used for example

F_{L}/F_{D}=50

then the Power Gain=0.577735*50=28.88, this being an unexpectedly large gain.

It is to be noted that there is an exact geometrical calculation for the former analysis, but the numerical differences compared to the approximate calculation given above are minor

With these calculation bases and correcting for a circular movement, it is possible to obtain numerical values and curves. For instance for Turbine #1, with the following measures:
Diameter of outer cylinder: 0.5 m
Diameter of inner cylinder: 0.32 m
Length of cylinders: 16 cm
Number of airfoils: 9
Static angle of airfoils: 45°
Airfoils Dimensions Large: 8.9 cm×Width: 14 cm×Thickness: 1.5 cm
Airflow velocity: 16 m/s

And with the following experimental measurements for the airfoils used in Turbine #1:

TABLE 1
MEASURED AND EXTRAPOLATED
VALUES OF AN AIRFOIL

| ATTACK | | | EFFICIENCY = | |
|---|---|---|---|---|
| ANGLE | F_{L} (Gr) | F_{D} (Gr) | F_{L}/F_{D} | |
| 0 | 38.73 | 4.65 | 8.33 | MEASURED |
| 2.5 | 58.09 | 5.19 | 11.19 | VALUES |
| 5 | 83.66 | 5.81 | 14.4 | |
| 7.5 | 100.71 | 6.61 | 15.24 | |
| 10 | 120.84 | 7.59 | 15.92 | |
| 12.5 | 143.3 | 8.83 | 16.23 | |
| 15 | 165.78 | 9.91 | 16.72 | |
| 17.5 | 182.03 | 11.62 | 15.67 | |
| 20 | 195.98 | 13.48 | 14.54 | |
| 22.5 | 197.17 | 15.52 | 12.7 | EXTRAPOLATED |
| 25 | 199.26 | 20.98 | 9.5 | VALUES |
| 27.5 | 200.31 | 25.17 | 7.96 | |
| 30 | 201.36 | 31.46 | 6.4 | |
| 32.5 | 202.41 | 41.95 | 4.83 | |
| 35 | 203.46 | 52.44 | 3.88 | |
| 37.5 | 204.51 | 73.41 | 2.79 | |
| 40 | 205.56 | 89.14 | 2.31 | |
| 42.5 | 205.56 | 115.36 | 1.78 | |
| 45 | 206.6 | 120.61 | 1.71 | |

With all of the previous quantities, and applying corrections for the circular movement, and geometrical formulas outside of the scope of this abstract, the following table and FIG. 12 result were obtained for Turbine #1:

TABLE 2
Calculated power for Turbine 1

| | Turbine | Turbine | Turbine |
|---|---|---|---|
| | Generated | Applied | Relative |
| | Power | Power | Gain |
| RPM | (Watts) | (Watts) | Power |
| 745.31 | 68.03 | 18.55 | 3.67 |
| 682.95 | 93.55 | 18.27 | 5.12 |
| 625.39 | 121.79 | 18.24 | 6.68 |
| 571.90 | 130.53 | 18.68 | 6.99 |
| 521.87 | 139.35 | 19.49 | 7.15 |
| 474.82 | 146.76 | 20.77 | 7.06 |
| 430.31 | 150.58 | 21.54 | 6.99 |
| 387.98 | 145.75 | 23.49 | 6.20 |
| 347.54 | 137.74 | 25.55 | 5.39 |
| 308.72 | 120.68 | 27.78 | 4.34 |
| 271.27 | 104.74 | 35.67 | 2.94 |
| 235.00 | 89.75 | 40.95 | 2.19 |
| 199.71 | 75.53 | 49.27 | 1.53 |
| 165.23 | 61.88 | 63.62 | 0.97 |
| 131.42 | 49.07 | 77.48 | 0.63 |
| 98.12 | 36.51 | 106.30 | 0.34 |
| 65.21 | 24.51 | 127.25 | 0.19 |
| 32.54 | 12.37 | 163.27 | 0.08 |
| 0.00 | 0.00 | 170.20 | 0.00 |

Turbine #1 was built and measurements made with the previous mentioned parameters and with a real attack angle of 42.5°, and a maximum relative power gain (generated power/ applied power) of 10 was obtained. It is worthwhile to notice, that in all the previous calculation, the efficiency of the airfoils (F_{L}/F_{D}) was very low, reaching a maximum value of 16.72. In the aeronautical arts this is considered to be a very low value for an airfoil efficiency.

### Improvement of Performance by Use of Fluid Accelerator.

While useful, the turbine may be augmented with means for accelerating fluid on the upstream side, and optionally also means for decelerating fluid on the downstream side of the turbine. Two fundamental physical principles may exploited in the design and operation of the present energy conversion machine, namely, the fluid velocity multiplication that takes place within a fluid convergent nozzle, and the enormous mechanical power that may be developed by the lift force on a suitably designed fan blade or streamlined turbine airfoil as described supra.

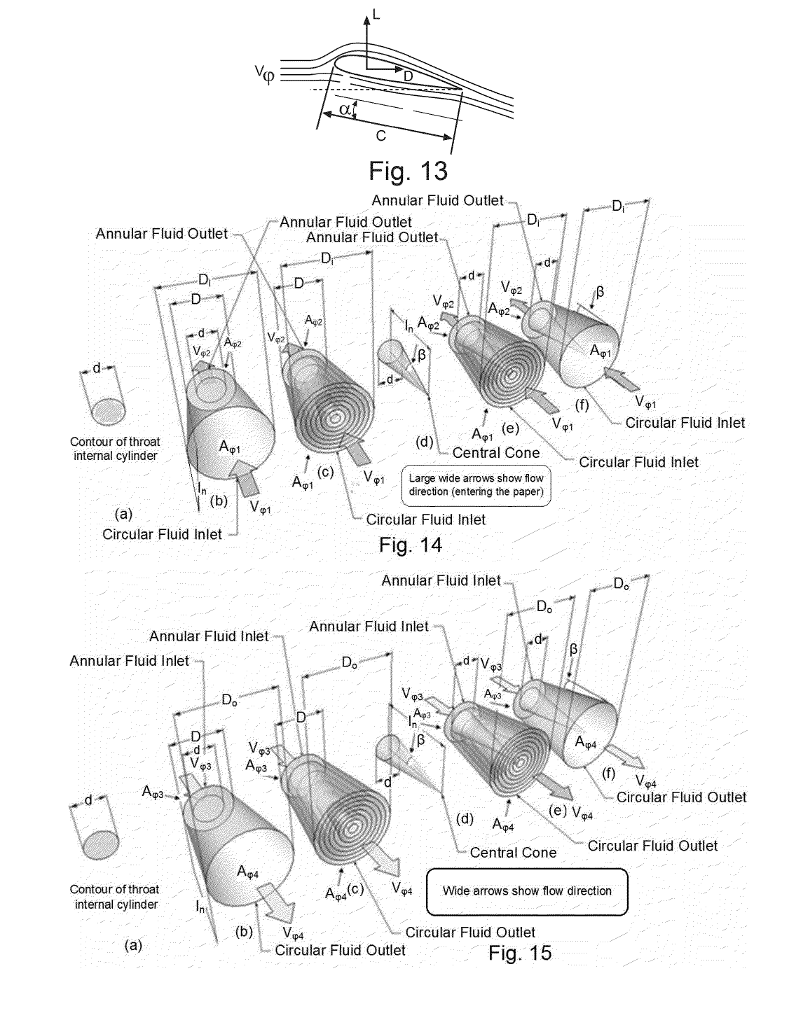

A fluid flowing past the surface of an airfoil-shaped body or fan blade, placed at a suitable attack angle a, exerts a surface force on it (FIG. 13). The lift force, L is the component of this force that is perpendicular to the oncoming flow direction. It contrasts with the drag force D, which is the component of the surface force parallel to the flow direction. The same forces appear in the case that the fluid is stationary and the blade moves through it with a velocity v_{φ}, as takes place on an airplane wing.

For a fluid flowing in a pipe or a duct and impacting a set of (one or more) rotary blades that has been suitable placed within the fluid passage, and facing the flow, the Reynolds Number is defined as Re=pcV_{φ}/μ where ρ and μ are the fluid density and the fluid viscosity, respectively; V_{φ} is the velocity of the free-stream fluid flow, and c is the chord of the blade. If the Reynolds Number is greater than about 500,000, and turbulence is somehow kept to a minimum, then the ratio L/D becomes large, usually much greater than 1. In this case, if forces acting on the blades are allowed to perform a mechanical work, it is well known that the mechanical power developed on the rotary shaft attached to the blades is proportional to V_{φ}³. Therefore, the useful power generated may be increased simply by augmenting the fluid velocity V_{φ} before the fluid flow strikes the blades. This is done by making the fluid flow pass first by an accelerating chamber or convergent nozzle.

Henceforth some fundamental assumptions are made: First, In order to properly apply the Bernoulli Equation, the fluid is assumed to be laminar, incompressible and inviscid (Page 99 of Ref.1, as cited as the end of this detailed description). Liquid fluids will be considered as incompressible. In the case of a gas fluid, like air, it will be considered as incompressible if the fluid flow speed striking the turbine or fan blades is kept below 0.3 Mach, i.e., below 102 m/s, for air. Fluid viscosity is assumed to be very small to ensure an inviscid fluid (Page 94 of Ref.1). Second, Reynolds Number for the turbine blades is not less than 500,000. Third, Internal surfaces in contact with the fluid inside the machine are very well polished, so, apart from the fluid entrance and the fluid exhaust, the machine has no fluid leakage.

Convergent and divergent nozzles may be used in a power conversion machine incorporating fluid acceleration and deceleration. FIG. 14 shows schematically several forms of a fluid-acceleration chamber (FAC or FA chamber), and its constituent parts. It is refer to it as a convergent nozzle as opposed to a divergent nozzle that may be used in the energy conversion machines as a fluid exhaust. A divergent nozzle, shown, schematically in FIG. 15, is just a convergent nozzle that has been rotated by 180° so that the convergent nozzle fluid entrance becomes the divergent nozzle fluid exit and vice versa.

The cross-sectional area as seen by the fluid flow at the entrance of the convergent nozzle is given by

Aₚ₁=(π/4)D₁² (1)

The cross-sectional area as seen by the fluid flow at the exit of the convergent nozzle is given by

A_{φ2}=(π/4)(D+d)(D−d) (2)

It may be shown by applying the continuity equation that if the fluid velocities at the entrance of the FAC and at the exit of the FAC are V_{φ1} and V_{φ2}, respectively, and the cross-sectional areas at the entrance of the FAC and at the exit of the FAC are A_{φ1} and A_{φ2}, respectively, then

V_{φ2}=(A_{φ1}/A_{φ2})V_{φ1} (3)

The parameter Fluid Velocity Multiplier k_{f} is defined as

k_{f}=(A_{φ1}/A_{φ2})=V_{φ2}/V_{φ1} (4)

Fluid velocity V_{φ2}may be made greater than V_{φ1} by making the multiplying factor kf greater than 1 , i.e., by making A_{φ1}>A_{φ2}.

If geometric parameters D and d are fixed so it will be the FAC exit cross-sectional area A_{φ2}, according to Eq. (2). Hence the fluid velocity multiplier kf may be increased by making the input cross-sectional area A_{φ1} bigger than the FAC exit area A_{φ2}. Since

A_{φ1}=(π/4)D₁² (5)

A_{φ1} may be increased by making input diameter D bigger. For this purpose the latter is defined as

D₁=D+kd (6)

Where k is an integer, (k=0, 1, 2, 3 . . . ). The value k=0 corresponds to the case when the energy conversion machine uses no convergent nozzle.

Then, by substituting Eq. (6) in Eq. (5)

A_{φ1}=(π/4)(D+kd)² (7)

substituting Eq. (7) and Eq. (2) in Eq. (4),

k_{f}(D+kd)²/(D+d)(D−d) (8)

The fluid-acceleration chamber may have many possible shapes, but to simplify its manufacturing and to minimize turbulence the shape shown in FIG. 14(e) is to be preferred. It consists basically of a cone with a circular base of diameter d, and length lₙ placed concentrically inside a larger truncated cone with circular entrance of diameter D₁, and annular outlet formed by minor circle of diameter d, and surrounding circle of diameter D. To ensure a convergent nozzle the inequality D₁>D>d>0 is fulfilled. It is possible to use a truncated cone with a cross-sectional shape other than a circular one, however the latter is preferred for the reasons pointed out supra. To keep turbulence losses to a minimum, the slope angle β formed by the cone walls and the cone axis, as is shown in FIG. 14(f), may be kept low, and in some embodiments not greater than 10°.

The length of the convergent nozzle may be may be calculated from the formula

Iₙ=kd/(2 tan β) (9)

As is shown at pages 3-7 of Ref. 2, the increase in wind velocity caused by a convergent nozzle brings about a reduction of a few degrees in the airflow temperature and this fact may be exploited to extract water out of the atmosphere as a useful byproduct of the convergent nozzle. As to the internal concentric truncated cones, shown in nozzles in FIG. 14(c) and FIG. 14(e), these are simply used as guide vanes to split the total flow entering the nozzle in several convergent sub flows for the purpose of making the fluid streamlines as straight as possible and to minimize intermixing and turbulence.

In some embodiments, the guide vanes are thin rigid elements that may be made of materials like metal, plastic, carbon fiber, glass fiber, etc. The larger the number of these sub nozzles the less the turbulence, but the greater becomes the drag force and the weight of the FA chamber.

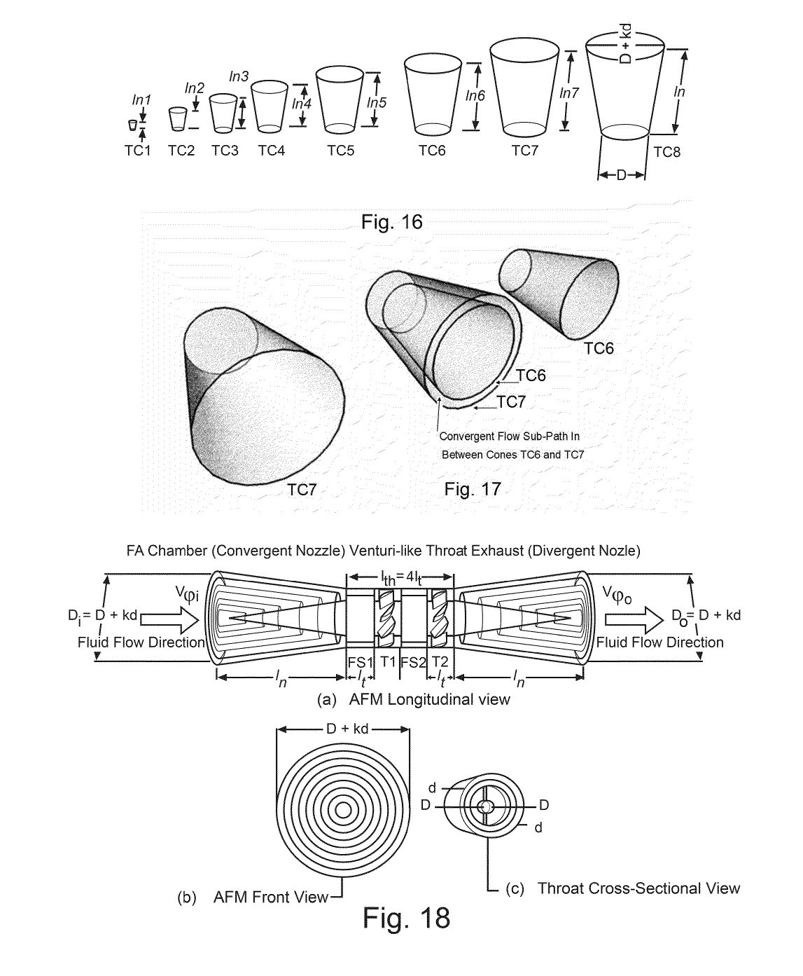

Hence a compromise becomes apparent. FIG. 16 shows the 8 truncated cones that make up the fluid-acceleration chamber shown in FIG. 14(c) and FIG. 14(e). The geometrical parameters (diameters and lengths of the truncated cones increase progressively from TC1 up to TC8, while keeping constant the slope angle β. For example the cone lengths may fulfill the following relationship:

l>ln₇>ln₆>ln₅>ln₄>ln₃>ln₂>ln₁>0

FIG. 17 shows the convergent flow sub-path formed by combining truncated cones TC6 and TC7 of FIG. 16. It is possible to further subdivide this sub-path by splitting it radially in two or more smaller sub-paths, but this is not done here so to improve the clarity of the figure.

In FIG. 15, several forms of a divergent nozzle and its constituent parts are shown. The divergent nozzle is another important component of an energy conversion machine, and it is used as the machine fluid exhaust. It is identical in shape to the converging nozzle previously described except that the fluid entering through its inlet with a speed V_{φ3} is decelerated and comes out with a much lower speed V_{φ4}, and the relationship between V_{φ3} and V_{φ4} is given by

V_{φ4}=V_{φ3}/k_{f} (10)

On the other hand, the divergent nozzle input and output cross-sectional areas, A_{φ3} and A_{φ4}, respectively, are also related by

A_{φ3}=(A_{φ4}/k_{f}) (11)

Where kf is given by Eq. (8)

k_{f}=(D+kd)²/(D+d)(D−d) (8)

And k is an integer, (k=0, 1, 2, 3 . . . ). The value k=0 corresponds to the case when the energy conversion machine uses no divergent nozzle.

The purpose of the divergent nozzle is to reduce the fluid speed V_{φ3} at its entrance, and preferably as much as possible to minimize fluid power loss at its exit. As in the case of the convergent nozzle, the slope angle β of the divergent nozzle is taken to be not greater than 10° so as to minimize turbulence. In the case of a symmetrical energy conversion machine, defined as one having convergent and divergent nozzles of identical shape and size, the divergent length Iₙ may be calculated also from Eq. (9).

FIG. 18(a) shows schematically a longitudinal view of an open chamber energy conversion machine containing two fluid turbines. Alternatively, instead of the fluid turbines, two electric fans may be used.

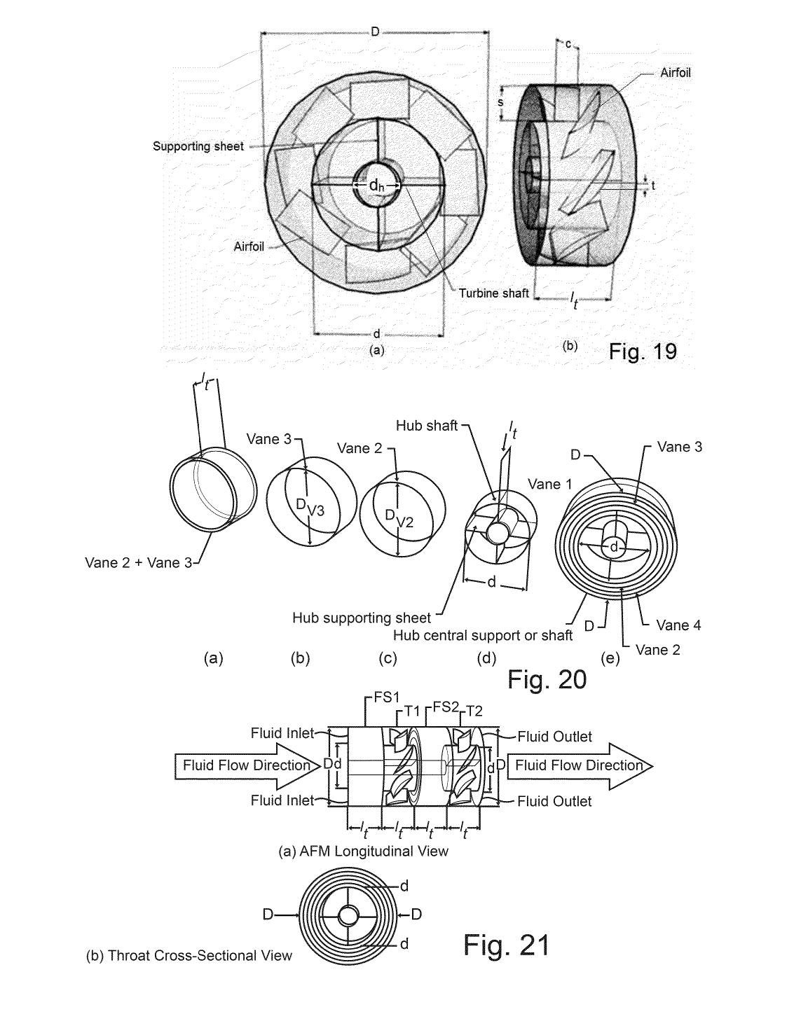

In some embodiments, the turbine is the same or similar to the Thermal Airfoil Turbine, as described in Reference 3. As an example of this turbine, FIG. 19 shows a schematic diagram of a fluid turbine consisting of eight airfoils placed on the periphery of an internal cylinder or hub of diameter d and surrounded by an external cylinder of diameter D, (D>d>0), as is shown in the frontal view in FIG. 19(a). The other dimension of the thermal airfoil turbine is its length lₜ, shown in the side view in FIG. 19(b), which also shows the dimensions of the airfoils, namely the chord c, the span s, and the thickness t. As to the maximum number of airfoils that may be placed in the turbine, the only restriction is that airfoils do not interact among them and that they occupy the annular fluid passage of dimensions (πd)(D−d)/2)(lₜ).

As shown in FIG. 18, the basic components of an accelerated fluid machine are: First: The Fluid Acceleration Chamber (FAC or FA chamber), which is the component in the form of a convergent nozzle where the fluid is accelerated. There are 4 possible varieties of the FA chamber, and they are shown in FIG. 18. FIG. 18(b) depicts the simplest FA chamber. It consists simply of a truncated cone having a large circular entrance with diameter D₁, and a smaller annular outlet defined by a large circle of diameter D and a smaller circle of diameter d. Dimensions D and d correspond to the large and the small diameter of the Venturi-like throat section that follows the FA chamber.

An alternative FAC shape is shown in FIG. 18(c), which is similar to the one shown in FIG. 18(a), but with the addition of several concentric vanes in the form of truncated cones. FIG. 18(f) shows another possible FAC shape, which is similar to the one shown in FIG. 18(b), but with the addition of a central cone, like the one shown in FIG. 18(d). Finally, FIG. 18(e) shows the FA chamber which offers the best performance, in terms of laminarity of the fluid. It is a combination of FA chambers shown in FIGS. 18(c) and 18(f), and it is the one appearing in FIG. 18. Second: The Venturi-like throat (referred to as “throat” herein), which is in some embodiments the straight and narrowest section of the energy conversion machine, where the fluid speed V_{φ} is a maximum and constant. The throat contains one or more aerodynamic fluid turbines similar to the thermal airfoil turbine.

An aerodynamic fluid turbine may be formed by a set of rotary streamlined airfoils or blades placed and attached around the periphery of an internal central circular cylinder of diameter d, and surrounded by another external circular cylinder of diameter D (D>d>0), as is shown in FIG. 19. The center of the internal cylinder is the hub, with a diameter dₛ<d, length lₜ, and houses the turbine shaft, as is shown in FIG. 19. Optionally the throat may additionally contain one or more Flow Straighteners, which are simply two concentric cylinders of diameters D and d, (D>d>0), as shown in FIG. 20(e), containing one or more guide vanes in the form of concentric cylinders placed in between cylinders of diameters D and d. FIGS. 20(b) and 20(c) show schematically vanes 3 and 2, with diameters Dᵥ₃ and Dᵥ₂, respectively, and FIG. 20(a) shows the fluid annular sub-path formed by vanes 2 and 3 combined. The diameters of the vanes satisfy the following inequality: d<Dᵥ₁<Dᵥ₂<Dᵥ₃<Dᵥ₄<D.

The primary function of the flow straighteners is to increase the laminarity of the flow before the fluid strikes the airfoils. There may be several cylindrical vanes in a flow straightener but again a compromise may be apparent between the number of vanes and its weight and the increase in drag force they bring about.

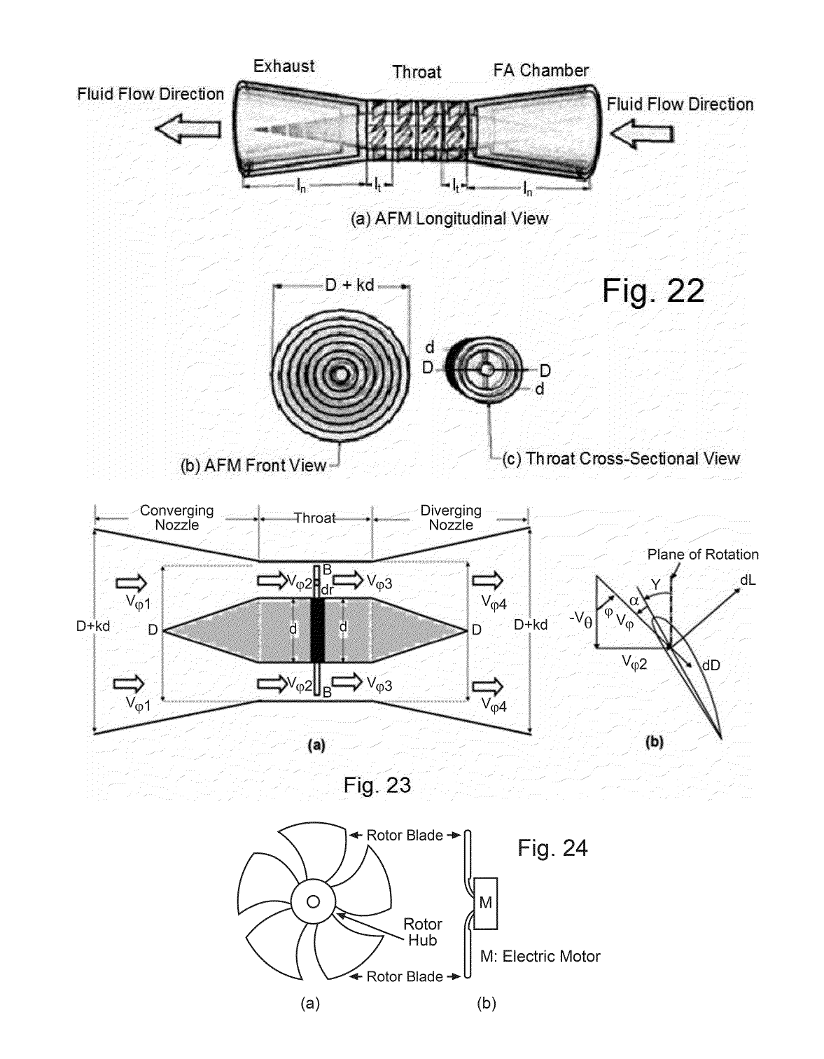

The Exhaust Chamber (which may be arranged by result of rotating a convergent nozzle like as shown in FIG. 14 by a 180° angle, and is therefore a divergent nozzle), and if the energy conversion machine is symmetrical, it has similar geometric dimensions, but it could have its larger diameter Do different from D, and its length lomay be also different from lₙ. The exhaust chamber acts as the fluid outlet to the environment. It is also possible for the energy conversion machine to contain just the Venturi-like throat and no nozzles, as the example shown in FIG. 21, but this arrangement is less efficient since it operates at a less fluid velocity due to the lack of the converging nozzle. And the lack of a divergent nozzle exhaust gives rises to turbulence and losses at the fluid outlet. Also it is possible to have only fluid turbines (or electric fans for that matter) and no fluid straightening separators in the throat section as is shown in FIG. 22 for an energy conversion machine containing just 4 turbines in its throat, but this arrangement is prone to operate with a less laminar fluid than the energy conversion machine shown in FIG. 18.

The purpose of the exhaust chamber is to gradually reduce the fluid velocity from its value v_{φ} in the throat down to the value v_{φo} just outside the exhaust chamber and thus to decrease the power of the exhaust fluid as much as possible. (See FIG. 15).

The total length of the energy conversion machines shown in FIGS. 18 and 22 is

L=2lₙ+lₜₕ (12)

Where lₜh is the throat length equal to 4lₜ for both machines. In general,

lₜₕ=Nlₜ (13)

Where N is the total number of spaces of length lₜ that may be accommodated in the throat length. The total width of the energy conversion machine is

W=D+kd (14)

A feature of the energy conversion machine is the fact that the fluid turbines are placed in a position perpendicular to the direction of the fluid flow, with their blades all facing the oncoming flow. As a result, all the turbine blades are impacted simultaneously by the fluid flow.

### Variations on Energy Conversion Machine Configuration

In general, energy conversion machines may be classified as open chamber or closed chamber energy conversion machines. In the open chamber variety the operating fluid may enter and leave the machine, as shown in FIGS. 18 and 22. On the other hand, closed chamber energy conversion machines to be explained later are hermetically closed to the external fluids.

There are at least two ways of having the fluid flow within the energy conversion machine: it may be artificially generated at the entrance of the FA chamber by one fan or within the throat by one or more fans. In this case the energy conversion machine may be open or closed.

Alternatively, if the fluid is external to the machine, it may be captured by the FA chamber by allowing it to enter the chamber. Hence, for an open chamber energy conversion machine, the FA chamber or converging nozzle has the following functions: 1. To capture or generate the fluid flow. 2. To increase the fluid velocity, and 3. To conduct the flow toward the Venturi-like throat. In the throat the flow will impinge on one or more sets of turbine foils or fan blades which in accordance to aero dynamical laws will extract part of the flow thermal energy. Thus the energy conversion machine may generate more mechanical energy than the input flow kinetical energy, as shown in the calculation results of Table I.

The open chamber energy conversion machine may be stationary and the external fluid flow may be a wind flow, a tidal flow, a submarine current, a stream, or a river current. Alternatively the machine may be mobile, and in contact with the external fluid, i.e., it may be carried by a vehicle moving at a velocity V_{φ1} through the surrounding fluid. In this case the FA chamber of the energy conversion machine may be used to capture the fluid and to increase its velocity up to a certain value V_{φ2}. In the event the energy conversion machine used is hermetically closed or placed within a fixed location like a house room, the fluid flow is created artificially by one fan placed within the FA chamber or one or more fans placed within the throat. In the latter case, the energy conversion machine may be open or closed.

As shown in FIGS. 18, 21 and 22, the Venturi-like throat is formed by one or more sections each consisting of two concentric cylinders of length lₜ and different diameter, the external one with diameter D, and the internal one, also called hub, with diameter d. Diameters may satisfy the inequality (0<d<D). In general, the external cylinder will be stationary, and the internal one may be stationary or rotary. There may be two types of sections, namely, flow straighteners and fluid turbines (instead of fluid turbines, fans may be used). Flow straighteners contain just a hub and one or more fluid director vanes, as shown in FIG. 20. As is shown in FIG. 19, fluid turbines consist of an internal cylinder or hub of diameter d, and a number of blades or foils placed around and over the periphery of the latter. The blades may rotate around the hub axis. Usually the turbines or fans will be placed in such a way that the diameter of the rotor will be the same as d, and the width or span s of the fan blades occupy totally or a large part of the empty space between the internal and external cylinders, as is shown in FIG. 19.

The Venturi-like throat houses the turbines or fans which are placed coaxially inside it. The fan shafts may be interconnected, or not. The purpose of the fans is to generate mechanical and/or electrical energy out of an incoming fluid that has been previously accelerated in a convergent nozzle. Usually the turbine airfoils or the fan blades are placed forming a setting angle γ with the flow direction of about 45 °, as may be seen in FIG. 19(b) and FIG. 23(b) for maximum L/D ratio, but making sure that stall does not take place. On the other hand, some of the fans may be used to add kinetic energy to the fluid in whose case they will not work as fluid turbines but rather as pumps (motor fans).

A particular variety of the acceleration fluid machine, the symmetrical energy conversion machine, is shown in FIGS. 18 and 22. It consists of the Venturi-like throat and identical convergent and divergent nozzles, both having the same length (lₙ), the same cone diameter (d), the same funnel internal diameter (D), and the same funnel external diameter (input diameter D,=output diameter D₀). See also FIGS. 14 and 17. Unless otherwise specified in the rest of this document it is assumed that D,=D₀=D+kd, where k=0, 1, 2, or a greater integer. The value k=0 corresponds to the case where the energy conversion machine uses no nozzle.

Mechanical Power Calculations Consider a fluid turbine (which may also be an electric fan, with driving motor M, like the one shown in FIG. 24), placed in the Venturi-like throat of an energy conversion machine, as the one shown schematically in FIG. 23(a). If the absolute velocity of the fluid entering the fluid accelerating nozzle of this energy conversion machine is v_{φ1}, then the absolute fluid velocities in the throat of the energy conversion machine, v_{φ2} and v_{φ3} are equal and given by

V_{φ2}=V_{φ3}k_{f}V_{φ1} (15)

Where the fluid velocity multiplier k_{f} is given by Eq. (8). It is worth noting than in a conventional wind turbine where no throat is present normally V_{φ3}<V_{φ2} because the turbine blades decelerate the incoming wind speed V_{φ2}. (Reference 4, page 6). But in an energy conversion machine due to the presence of the throat velocities V_{φ3} and V_{φ2} are the same if an inviscid fluid is assumed.

FIG. 23(b) shows the forces dL (Lift force) and dD (Drag force) acting on a blade element of chord c and area cdr located at a distance r from the turbine hub center. When fluid in the throat of velocity V_{φ2} strikes the plane of rotation perpendicularly, as shown in FIG. 23(a) and FIG. 23(b), turbine blade B sees the incoming fluid approaching with a relative velocity V_{φ} forming a flow angle φ with the plane of rotation. On the other hand, the blade B moves with a tangential force V_{B} related to velocities V_{φ} and V_{φ2} by

V_{φ2}=V_{φ}V_{B} (16)

The angle formed by the apparent velocity v_{φ} and the blade chord c is the attack angle a, and the angle formed by the chord c and the plane of rotation is the setting angle y. From FIG. 23 (b) it may be seen that angles α, ≢5 and φ are related by

φ=α+γ (17)

Henceforth it will be assumed that the turbine blades have a constant setting angle y, a constant thickness t, a constant chord c, and a constant span s. The latter is given by

s=(D−d)/2 (18)

From FIG. 23(b) it may be seen that velocities V_{φ2} and V_{φ} are related by

V_{φ}=V_{φ2}/sin φ (19)

If flow angle φ is less than 90°, it may be seen from Equations (19) and (15) that the following inequality is fulfilled for an energy conversion machine

V_{φ}>V_{φ2}>V_{φ1} (20)

Forces dD and dL are given by (Reference 4, page 10)

dD=C_{D}ρV_{φ}²cdr/2 (21)

dL=C_{L}ρV_{φ}²cdr2 (22)

Where CD=Drag coefficient of blade; CL=Lift coefficient of blade; p=Density of the accelerated fluid.

The torque on the blade element, dT, may be shown to be given by (Reference 4, p.11)

dT=ρV_{φ}²(C_{L} sin φ−C_{D} cos φ)crdr/2 (23)

This torque around the central axis of rotation causes the rotary movement of the blade element. Accordingly if the turbine has N_{b} blades, it may be readily shown that the average mechanical power developed by the turbine on its shaft is

P_{g}=N_{b}ωρV_{φ}²(C_{L} sin φ−C_{D} cos φ)c(D²−d²)/16 (24)

Where ω is the turbine rotational speed in radians per second which may be converted into n, revolutions per minute (RPM) by

ω=πn/30 (25)

By combining Eq. (24) and Eq. (25)

P_{g}=(π/480)ρ(C_{L} sin φ−C_{D} cos φ)N_{b}c(D²−d²)nV_{φ}² (26)

On the other hand, it may be readily shown that

n=15 [NₚρN_{b}(D²−d²)c(C_{L} sin φ−C_{D} cos φ)/(πlₜ)]^{1/2}V_{φ} (27)

Where lₜ is the turbine's moment of inertia about its rotational axis, and Nₚ is the total (integer or fractional) number of periods the turbine rotates to reach constant speed n, when starting from n=0. Nₚ is a quantity that may be measured experimentally for each turbine.

By substituting Eq. (27) into Eq. (26) the following relationship is obtained

P_{g}=[πNₚ/(16lₜ)]^{1/2 [ρ}N_{b}c(D²−d²)(C_{L} sin φ−C_{D} cos φ)]^{3/2}V_{φ}³ (28)

Equation (28) clearly indicates that in order to maximize the mechanical power generated by a single turbine it is more effective to increase velocity V_{φ} (By increasing fluid velocity V_{φ2} in the Venturi-like throat) than increasing factors (C_{L} sin φ−C_{D} cos φ), N_{b}, c and or (D²−d²). This approach may be used to design an energy conversion machine, and for this purpose the FA chamber is used to to increase the incoming fluid velocity V_{φ} so that the fluid reaches the Venturi-like throat with maximum speed V_{φ2}.

The total mechanical power generated may also be increased by augmenting the number of fluid turbines (or fans, for that matter). If Nₜ identical fluid turbines each with N_{b} blades are contained within the Venturi-like throat of an accelerated fluid machine, the total mechanical power generated by the Nₜ fluid turbines is:

P_{g}=(π/480)ρ(C_{L} sin φ−C_{D} cos φ)N_{b}Nₜc(D²−d²)nV_{φ}² (29)

Calculation of the Mechanical Power Gain for an AF Machine The input power of the fluid at the inlet of an energy conversion machine is given by

P_{φi}=ρA₁V_{φ1}³/2 (30)

Where Ai is the inlet cross-sectional area at the entrance of the FA chamber of diameter D+kd, as shown in FIG. 23(a), and given in general by

A₁=(π/4)(D+kd)² (31)

And the input fluid power may be expressed as

P_{φi}=(πΣp/8)(D+kd)²V_{φ1}³ (32)

But, by using Eq. (8),

(D+kd)²=(D+d)(D−d) k_{f} (33)

Then P_{φi} may be written as

P_{φi}=(πρ/8)(D+d)(D−d)k_{f}V_{φ1}³ (34)

By combining Eq. (19) with Eq. (15), V_{φ} may be expressed as

V_{φ}=k_{f}V_{φ1}/sin φ (35)

By substituting Eq. (35) in Eq. (26),

P_{g}=(π/480)ρ(C_{L} sin φ−C_{D} cos φ)N_{b}c(D²−d²)nk_{f}²V_{φ1}²/sin²φ (36)

Which for Nₜ identical AF turbines may be written as

P_{g}=(π/480)ρ(C_{L} sin φ−C_{D} cos φ)N_{b}Nₜc(D²−d²)nk_{f}²V_{φ1}²/sin²φ (37)

Let us now define the Mechanical Power Gain, or Efficiency, Gₚₘ, of the energy conversion machine as

Gₚₘ=P_{g}/P_{φi} (38)

And by substituting Equations (34) and (37) into Eq. (38), for Nₜ turbines

Gₚₘ=[k_{f}/(60 sin²φ)][ρ(C_{L} sin φ−C_{D} cos φ)N_{b}Nₜc](n/V_{φ1}) (39)

It may be seen from Equation (39) that the mechanical power gain Gₚₘ may be increased effectively by making the fluid velocity multiplier kf as large as possible and this may be done simply by increasing the value of the integer k for the accelerating nozzle as may be seen from Eq. (8). Another less effective way consists of increasing the ratio (n/V_{φ1}), and/or increasing the value of ratio CL/CD and/or parameters c, N_{b}, and Nₜ.

### Condition for Self-Sustained Movement of the Fluid Turbines

The Accelerated Fluid Turbine System may operate in a self-sustained regime if

Gₚₘ>1 (40)

According to Eq. (39) for an energy conversion machine this inequality is equivalent to

[k_{f}(60 sin²φ][ρ(C_{L} sin φ−C_{D} cos φ)N_{b}Nₜc](n/V_{φ1})>1 (41)

Equation (41) is the condition for an energy conversion machine to achieve a self sustained movement, and this is quite feasible to obtain as shown in the example below.

Numerical results are shown below for an Accelerated Wind Turbine For an Accelerated Wind Turbine (AWT), which is a particular type of an energy conversion machine in which the operating fluid is the wind, with parameters: D=50 cm; d=30 cm; CD=0.040163; C_{L}=0.46852; c=15 cm; s=10 cm; φ=45°; V_{φ}1=5 m/s; N_{b}=8 blades; Nₜ=4 turbines; n=900 rpm, and by applying Equations (8), (9), (15), (1 9), (32), (37) and (38), respectively, the results shown in Table I were obtained for k_{f}, lₙ, V_{φ2}, _{φ}, P_{φi}, P_{g}, and Gₚₘ, both for k=1, and k=2.

TABLE III
Power calculation results for an Accelerated Wind Turbine.

| | | | V_{φ1}, | | V_{φ}, | | | |
|---|---|---|---|---|---|---|---|---|
| k | k_{f} | lₙ, m | m/s | V_{φ2}, m/s | m/s | P_{φi}, W | P_{g}, W | Gₚₘ |
| 1 | 4 | 0.95 | 5 | 20 | 28.28 | 38.64 | 1,348.34 | 34.89 |
| 2 | 7.56 | 1.89 | 5 | 37.81 | 53.48 | 73.06 | 4,819.57 | 65.97 |

Thus for this particular AWT and wind speed it is possible to achieve a self-sustained motion and generate a mechanical power of 4.820 kW for k=2.

### Use of Electric Fans and Other Components for Implementing Energy Conversion Machines

Instead of aerodynamic fluid turbines, like the one shown in FIG. 19, whose blades or airfoils have been designed to achieve a C_{L}/C_{D} ratio as high as possible, accelerated fluid machines may also be implemented using conventional fans. FIG. 24 shows two possible types of axial fans that may be used for this purpose, namely, a mechanical fan (i.e., just a set of rotary blades, with no motor), like the one shown schematically in front view in FIG. 24(a); and an electrical fan (i.e., one composed of a rotary fan blade set plus a driving electric motor, M), as shown schematically in side view in FIG. 24(b). If the fan is mechanical, it may also be considered as a fluid turbine. Hence a mechanical fan may perform either as an air turbine, a water turbine or a wind turbine depending on whether the operating fluid is air, water or wind, respectively.

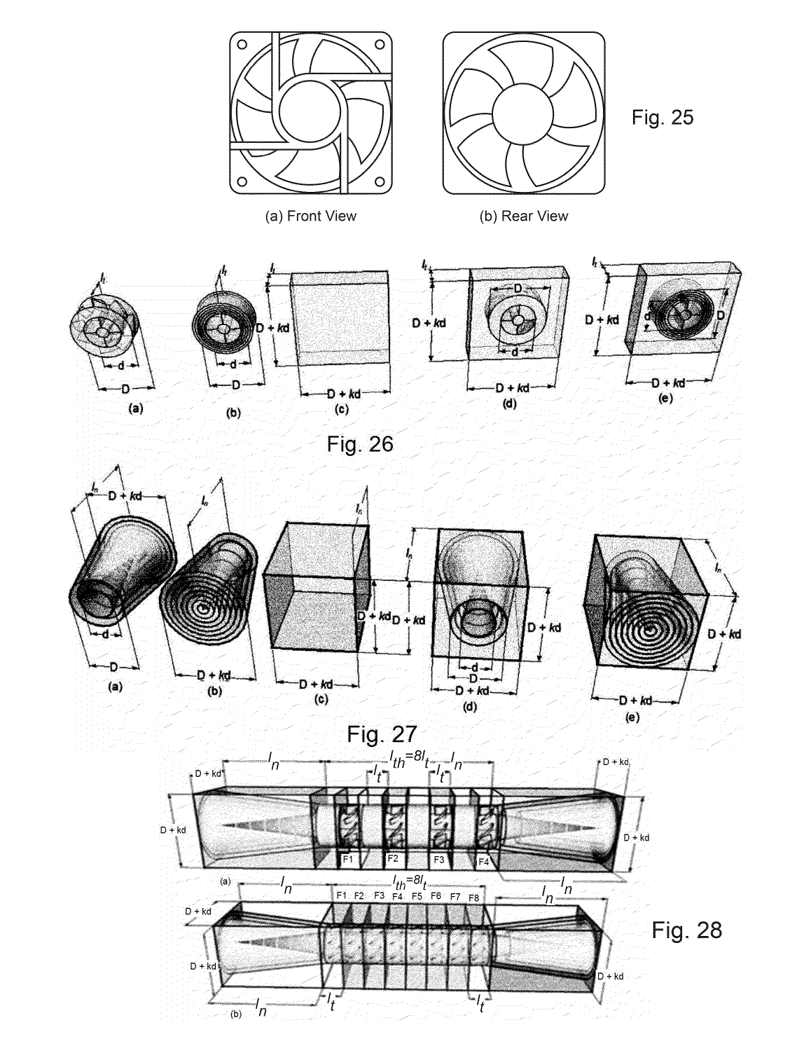

FIG. 25 shows the front and rear views of a typical commercially available axial electric fan that may be used instead of a fluid turbine. It includes a driving electric motor. The fan motor may be ac or dc, but the particular one shown in FIG. 25 is a brushless dc fan motor.

Henceforth, in order to differentiate the schematic diagram of an aerodynamic fluid turbine, like the one shown in FIG. 26(a), from that of a fan used for the latter the graphic representation shown in FIG. 26(e), which is the same representation of a fluid turbine but enclosed in a rectangular box, whose dimensions are chosen to be: (D+kd)×(D+kd)×(lt), as is shown in FIG. 26(c). These box dimensions are chosen to facilitate the construction of energy conversion machines using electric fans as some of their building blocks. Similarly, fluid straighteners, as the one shown in FIG. 26(b), are also enclosed in a similar rectangular box, as shown in FIG. 26(d), for the purpose of using them as building blocks of energy conversion machines implemented with electric fans.

Similarly, to facilitate modular construction of the energy conversion machines, both the divergent and convergent nozzles, like the ones shown in FIGS. 27(a) and 27(b), respectively, may be enclosed in rectangular boxes with dimensions (D+kd)×(D+kd)×(lₙ), like the one shown in FIG. 27(c). This results in the diverging and converging nozzle building blocks shown in FIGS. 27(d), and 27(e), respectively.

The front and back faces of both types of building boxes will normally be left open to allow the interconnection of modules, but the side faces will normally be closed to avoid fluid leakage. When interconnecting these building blocks together the fluid is allowed to flow from an open inlet nozzle of diameter D+kd to one or more electric fans placed coaxially in the throat only through the annular fluid passage bounded by external diameter D and internal diameter d, to finally exit the machine through an open outlet nozzle of diameter D+kd, if the latter is used, otherwise the outlet will be just one of the throat annular ends.

With the above mentioned building blocks it is possible to build a large variety ofenergy conversion machines. As an example, FIG. 28(a) shows an energy conversion machine having 4 electric fans and 4 fluid straighteners. FIG. 28(b) shows another energy conversion machine with 8 electric fans and no fluid straighteners. The throat length lₜh is the sum of the lengths of the fans and fluid straighteners coaxially placed one behind the other in the throat. For ease of manufacturing of the fan energy conversion machine, the length of fans and fluid straighteners is chosen to be the same, lₜ. In FIG. 29 another energy conversion machine implemented with 8 fans is shown. Then, if N is the total number of fluid straighteners and fans, then

lₜₕ=Nlₜ (42)

Assuming the fluid is incompressible, the maximum number of fans and fluid straighteners that may be placed coaxially within the throat is only limited by the shear stress appearing in internal walls and rotary blades due to the fluid viscosity μ that tend to close the flow passage as the number of fans is increased. Such an upper limit is established experimentally. If the fluid is a liquid (such as water) it may be considered incompressible for all practical engineering purposes (Page 29 of Reference 1). If the fluid is a gas like air it may be considered as incompressible if the flow velocity in the throat is kept below about 0.3 Mach (Page 128. of Reference 1). This is an important property of the present energy conversion machines which normally cannot be achieved in conventional wind turbines, because they are generally designed to extract kinetic energy from the incoming wind, thus reducing its speed. On the contrary, in an accelerated fluid machine the incoming fluid is first accelerated in the FA chamber before striking turbine airfoils or fan blades placed in the Venturi-like throat.

There are at least two possible modes of operation for the electrical motor of an electrical fan. It may operate either as an electrical motor proper, or as an electric generator. In the first case a power supply is connected to the motor leads in order to create or reinforce the fluid flow. In the second case the motor leads are connected to an electric load and the rotary fan blades may spin as the result of a previously accelerated fluid impacting onto them. The accelerated fluid may be produced by one or more electric fans acting as starting motors or, it may stem from a natural source like the wind, airflow or a water flow made to enter into the fluid acceleration chamber. When the latter situation takes place it may be considered that the fluid acceleration chamber has captured the external fluid flow. The fan blades mounted on the periphery of the fan rotor spin either when driven by the fan motor, or when impacted by the accelerated fluid flow. According to Faraday's Law, a voltage may be induced between the open leads of the fan motor that then performs as an electric generator capable of converting the rotational movement of the blades into an electrical current. Thus an electrical fan may operate either as a motor or as a generator. In the first case the fan will be referred to as a motor fan and in the second case either as a generator fan or a fluid (air, wind or water) turbine. The axes or shafts of the motor fan(s) and the generator fan(s) may be mechanically attached, or may be unattached but keeping always their co linearity.

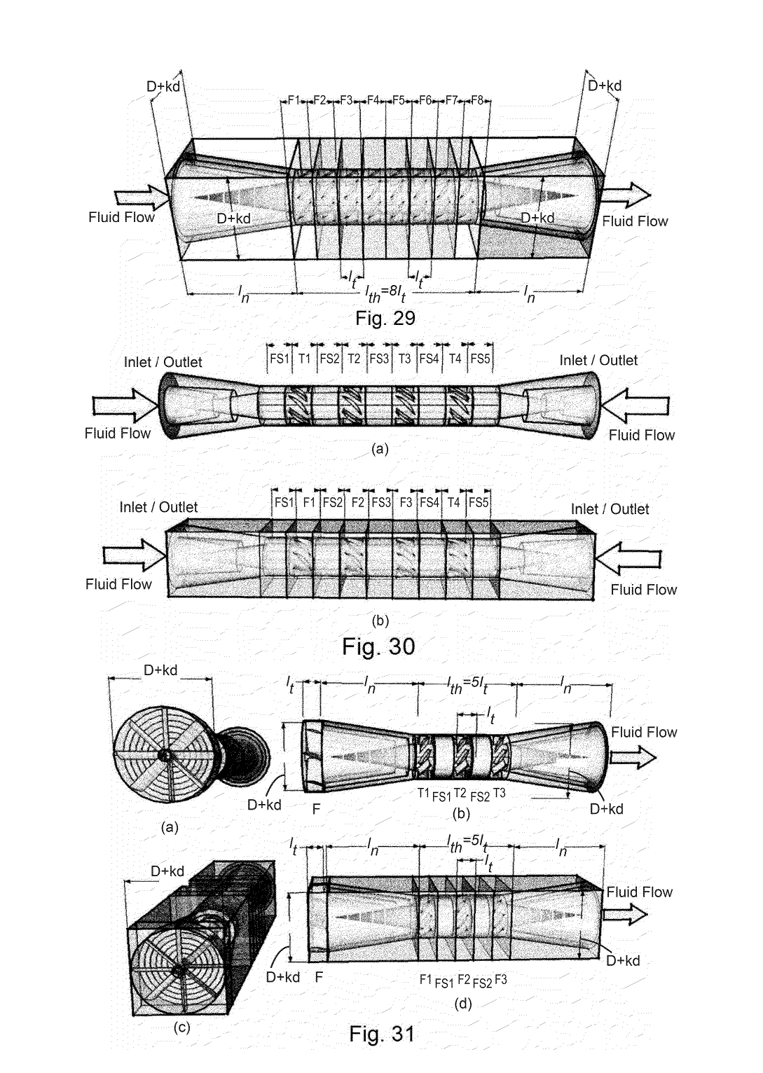

Enclosed within the Venturi-like throat there may be at least one fan working as a generator fan, but it is possible for one or more of the electric fans to perform as motor fans. For example, in FIG. 30, all the eight fans may operate as generator fans, but there are other possibilities. For example, fans F₁, F₃, F₅ and F₇may operate as motor fans, and fans F₂, F₄, F₆, and F₈ may operate as generator fans. Other motor-generator fan combinations are possible, but at any rate at least one of the fans operates as a generator fan in order to generate a useful power.

Both motor fans and generator fans may be physically identical or very similar, except perhaps for their internal electrical resistance. In fact, as is shown in Section Self Sustainable Fluid Electric Generator it is usually desirable for the total internal resistance of the generator fans to be much lower than the total internal resistance of the motor fans. In addition, the motor and the generator may be either dc or ac machines. Likewise, the blades of both motor fans and generator fans may be identical or very similar.

Accelerated Fluid Machines may be classified either as mechanical motors or as electric generators. In the first case there is no generation of electric energy, but just mechanical energy by mechanical fans or fluid turbines as their blades are rotated by a previously accelerated fluid. In the second case the mechanical energy generated is converted into electrical energy by one or more electric generator fans or by an ad hoc electric generator attached to the turbines shaft. Hence, depending on whether the intervening fluid is air or water, there are 5 main types of energy conversion machines, namely, the Air Motor (AM), the Water Motor (WM), the Air Electric Generator (AEG), the Water Electric Generator (WEG), and the Accelerated Wind Turbine (AWT). FIGS. 20, 21 and 22 show schematically examples of an Accelerated Wind Turbine, an Air Electric Generator, and a vertical Water Electric Generator, respectively.

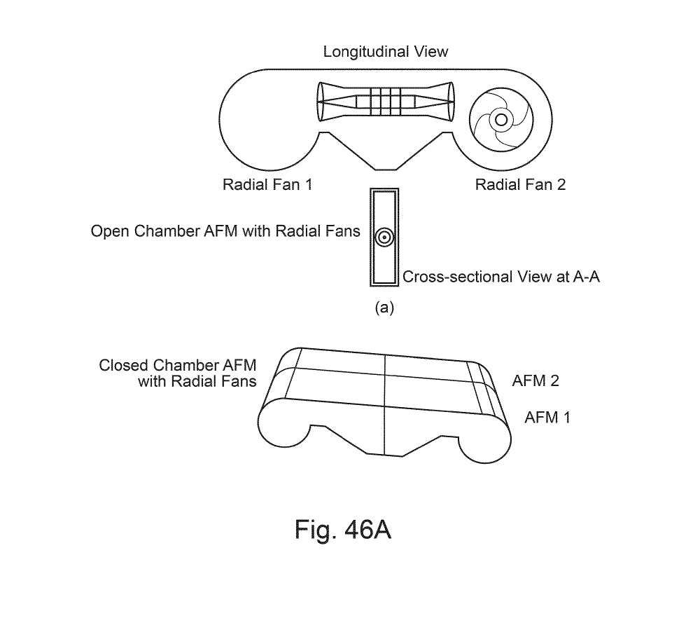

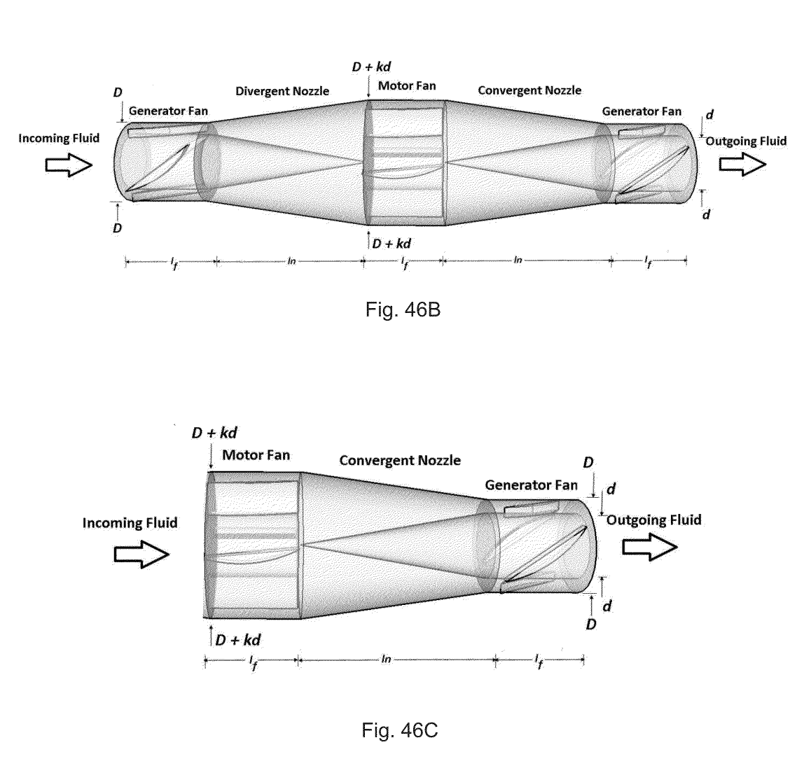

The AW turbine in the example shown in FIG. 30(a) is implemented with 4 thermal airfoil turbines, and the one shown in FIG. 30(b) is implemented with 4 electric fans. A novel feature of this wind turbine is that wind may enter and exit in two possible directions, and generate power for each of the directions. The AE generator shown in FIG. 31(a) is implemented with 3 turbines plus a large electric fan F at the entrance of the converging nozzle whereas the one shown in FIG. 31(b) is implemented with 3 electric fans plus the large fan F at the entrance of the converging nozzle. Alternatively, an AE generator can be implemented as a Diverging Converging Accelerated Fluid Machine (DCAF machine) as the one shown in FIGS. 46B and 46C.

Note that basically the same energy conversion machine shown in FIG. 18 may perform as an AWT, an AEG or a WEG machine, depending on whether the operating fluid is wind, air or water, respectively, with some small change for the AEG, i.e., the addition of a large fan F at the entrance of the fluid acceleration chamber.

Any suitable material, like plastic, metal, etc., may be used to manufacture the fluid acceleration chamber and the exhaust chamber, provided it is light and resistant to degradation by the environment. The internal walls of the chambers have to be as smooth as possible to minimize power losses caused by the wall shear stress. In the remainder of this specification it will be assumed that the internal walls of the chamber are perfectly polished and have no leaks.

Regarding the thickness of the chamber walls, it is desirable for it to be as little as possible in order to keep machine weight as low as possible, but without compromising its sheltering properties.

Regarding the fan blades of the energy conversion machine, they may be made out of plastic materials, resin, acrylic, or others. The two cylinders may be made with a light metal such as aluminum, or a light and hard plastic as well, etc., but weight may be minimized without compromising the material endurance and strength.

Important as to the possible values for the geometrical parameters D and d, the only requirement they may satisfy is: 0<d<D. As may be seen from Eq. (28), the useful power P_{g} generated by the fan or turbine blades is proportional both to (D²−d²) ^{3/2} and to V_{φ}³. Hence the greater the values of these quantities the greater the generated power will be.

It should be noted that although it is possible to use inlet and outlet terminations with k=0, (i.e., no nozzles)such embodiments are less preferred on the account of the larger turbulence of the exhaust terminations and the lack of the convergent nozzle to amplify the incoming fluid velocity.

According to Equations (4) and (10) it is readily apparent that the fluid acceleration chamber multiplies the incoming fluid velocity V_{φ} by a factor k_{f}, whereas the exhaust chamber divides the fluid velocity v_{φ3} in the throat by the same factor if the accelerated fluid machine is symmetrical. Of course the greater the value of k the greater will be the size of the machine, according to Eq. (9), the parameter kf, according to Eq. (8), and the generated power P_{g}, according to Eq. (37). On the other hand, the greater the value of k the smaller the output velocity v_{φ4}, according to Eq. (10), and the turbulence and power losses at the output.

The power P_{φ2} that is applied to the fan blades is

P_{φ2}=ρA_{φ2}V_{φ2}³/2 (43)

And the input power of the fluid at the inlet of the open chamber energy conversion machine is given by

P_{φi}=ρA_{φ1}V_{φ1}³/2 (30)

By combining Equations (3) (4), and (30)

P_{φ2}=k_{f}²P_{φi} (44)

Thus, according to Equations (8), and (44), the higher the value used for the parameter k the higher will be the fluid velocity multiplier kf and the fluid power P_{φ2} applied to the turbine blades. In conventional design of horizontal axis wind turbines the oncoming wind power P_{φi} is applied directly to the turbine blades. In contrast, in these Accelerated Wind Turbines there is applied first the oncoming wind power P_{φi} to the FA chamber to increase it k_{f}² times up to the power P_{φ2} which is then applied to the turbine blades. As a result the power P_{φ2} of the fluid impacting the wind turbines may be made many times bigger than the power P_{φi} of the external wind. This in turn results in accelerated wind turbines with much higher efficiency than conventional HAWT machines.

In what follows it may be stressed that if an energy conversion machine is shown as implemented solely with fans, it is clear that it may also be implemented with thermal airfoil turbines, and vice versa.

### Energy Space About an Energy Conversion Machine

A vehicle moving in a fluid with a certain velocity V_{φ1} gives rise to a flow of such a fluid at the same velocity. The flow is present in a certain finite neighborhood in contact with the moving vehicle. On account that this fluid flow contains thermal and kinetic energy, the space surrounding this vehicle may be considered as an energy space. The extent, boundaries and properties of the energy space at each point have as yet to be evaluated. However it is apparent that a suitable energy conversion machine placed in the vehicle in motion and in contact with this energy space will be able to extract part of the energy contained in the latter.

A fluid panel may include any structure composed of more than one energy conversion machine forming a wall or flat panel that may be attached to a vehicle or placed on a platform or on a stationary building for the purpose of capturing part of the energy contained within the surrounding energy space. Typically a fluid panel may be a Wind Panel or a Water Panel if the fluid in the energy space is a wind, or water, respectively. In the first case, the wind panel is attached to a vehicle, fixed building, or platform immersed in the energy field. Typically it may be mounted at the roof or on the sides of the vehicle and facing the wind, or it may be submerged in water if the vehicle moves in this medium.

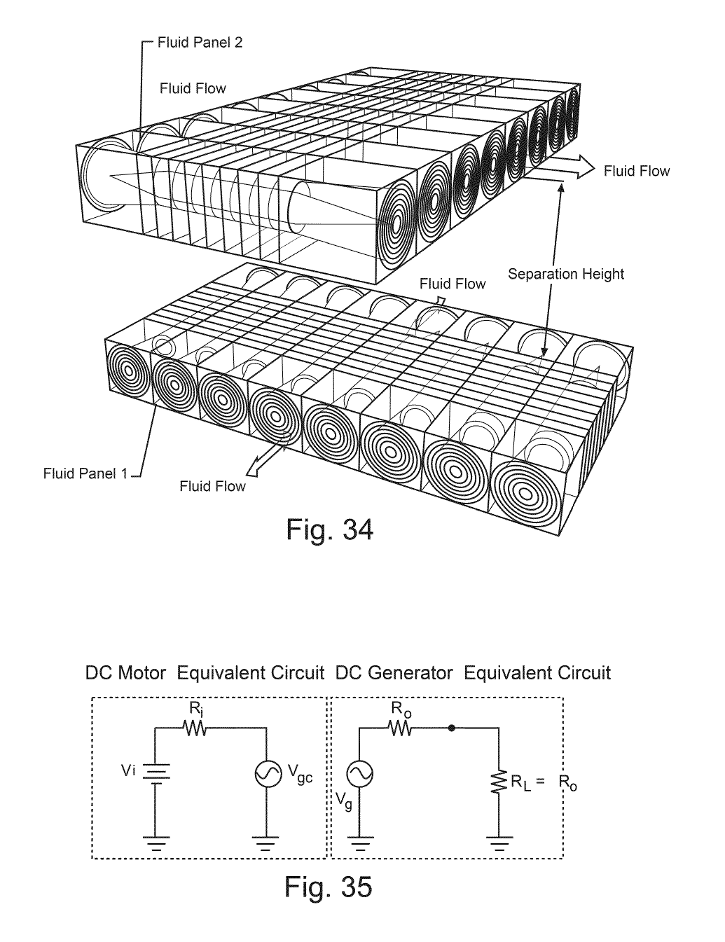

Fluid panels may alternatively be placed on a stationary structure, such as the roof of a house or building to extract energy from the wind or may be submerged and attached to the bottom of a body of water such as a stream, river, sea, etc., to extract energy from the underwater flows. A basic building block that may be used to implement a fluid panel is shown in FIG. 29 containing 8 electric fans. As to the maximum number of fluid turbines or fans that may be used in a building block this is determined experimentally as it is related to the shear stress developed in walls and blades. There may be a least one turbine or fan. FIG. 33 shows a fluid panel, consisting of 8 energy conversion machines each with 8 electric fans for a total of 64 electric fans, each of them operating as a generator fan. The bi-directional arrows show the direction in which the fluid may flow and produce an electric current in the electric fan leads. It is possible to combine two or more single fluid panels like the one shown in FIG. 33. For example, FIG. 34 shows a compound fluid panel consisting of two fluid panels placed orthogonally with each other to capture flows in 4 possible geographical directions. Other geographical directions may be covered with more fluid panels placed one on top of another and oriented in the desired directions. Of course, if the number of panels is increased so does the power that may be generated. For example, is the energy conversion machines used in the fluid panel of FIG. 33 were all identical accelerated wind turbines, each generating 1 kW, then the total power generated by the fluid panel would be 8 kW. As to the maximum number of fluid panels that may be placed one above another there is no limit, except for the maximum weight that the building or platform may support or the maximum drag force the vehicle may withstand.

A Fluid Electric Generator (FEG or FE generator) may be defined to include an energy conversion machine that produces electric energy out of a previously accelerated fluid flow.

To implement the FEG two fundamental elements are required: First, an accelerated fluid flow within the Venturi-like throat; Second, one or more electric fans placed coaxially within the latter in such a way that their hub diameters coincide with the diameter d of the inner cylinder, and the fan blades occupy partly or totally the empty space of width (D−d)/2 in the throat as is shown in FIG. 18(c), and FIG. 22(c).

At least one of the electric fans placed coaxially within the throat may be operated as a generator fan or turbine, i.e., its electric leads are not connected to a power supply but instead they are left open or connected to an electric load, and its blades are allowed to rotate as the result of being impacted by the accelerated fluid.

There are at least two ways for accelerating a fluid flow, namely: 1. by allowing the surrounding fluid external to the machine to enter the fluid acceleration chamber where it is accelerated on account of the continuity equation. In this case the FA chamber has the function of capturing part of the fluid surrounding the machine; 2. By artificially generating the fluid flow inside the Venturi-like throat by operating one or more fans as motors proper. This is done by connecting the motor fan electric leads to a power supply. In the first case, the fluid flow is accelerated within the fluid acceleration chamber reaching its final velocity V_{φ2} at the throat. When the fluid flow is artificially created, the fluid acceleration chamber may be open or closed. This may be done with the arrangement shown in FIG. 29, where one or more electric fans placed inside the throat are operated as motors to create or reinforce the fluid flow. At least one of the fans is operated as a generator, i.e., as a turbine to produce the output mechanical or electrical power.

In another arrangement, it is possible to place an electric fan with a diameter not greater than D₁=D+kd at the entrance of the FE generator, as is shown in FIG. 31 in which the fluid flow is created by the electric fan F placed at the left entrance. Electric fans F₁, F₂, and F₃ may all work as generator fans or one or more of them may operate as motor fans to reinforce motor fan F and accelerate further the fluid inside the throat.

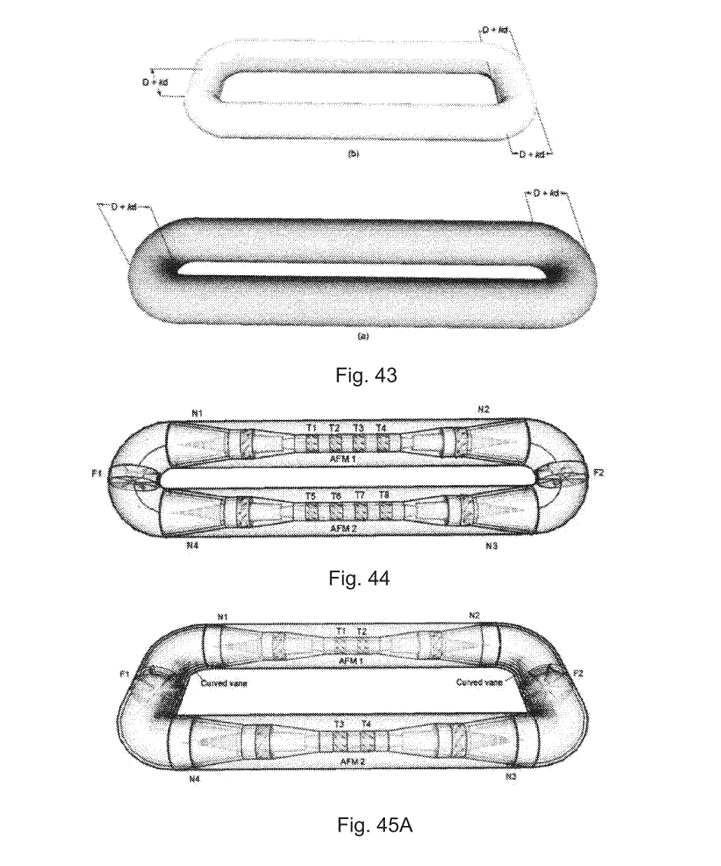

It should be noted that for accelerated wind turbines and for water electric generators fan F at left entrance in FIG. 43 is removed, and all the electric fans are placed in the throat (straight section of the FE generator) where the fluid velocity is a maximum, as is shown in FIG. 42 for an accelerated wind turbine, or in FIG. 44 for an accelerated water machine, or water motor. If turbines T1 and T2 are attached to an electric generator (not shown), the water motor becomes a fluid electric generator that may be used as a Vertical Water Electric Generator (See also FIG. 46A and Section A Vertical Accelerated Water Machine). On the other hand, a horizontal FEG that may be used as a Horizontal Water Electric Machine is shown in FIGS. 29 and 37. In all fluid electric generators the power supply used by the motor fans may be either ac or dc, depending on whether the fan motor is an ac machine or a dc machine. Also, in an FE generator the generator fan outputs may be connected in series to obtain the total generated voltage as the sum of the individual voltages generated by the fluid turbines. In addition, if two or more fan motors are used to generate the accelerated fluid, they may be connected in parallel in order to increase the speed of the accelerated fluid within the throat. As to the number of fans that may be used there may be as few as one or as many as there may be physically placed within the throat. The fans may all be placed onto the same shaft in whose case they all rotate at the same angular velocity. Or, they may be physically separated although maintaining its co linearity.

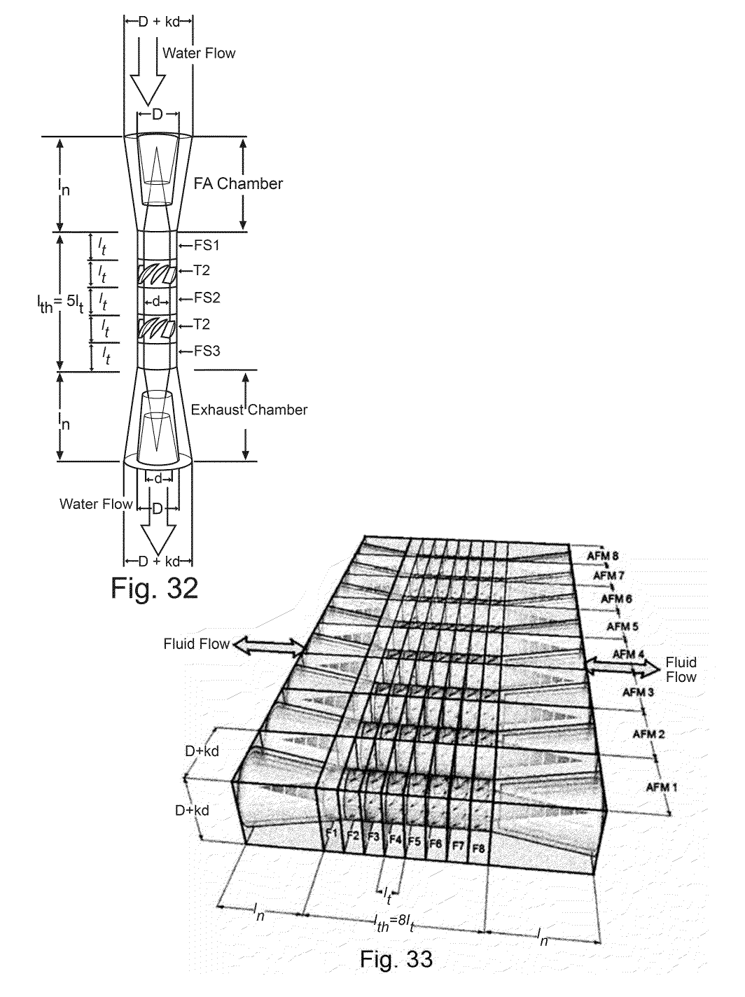

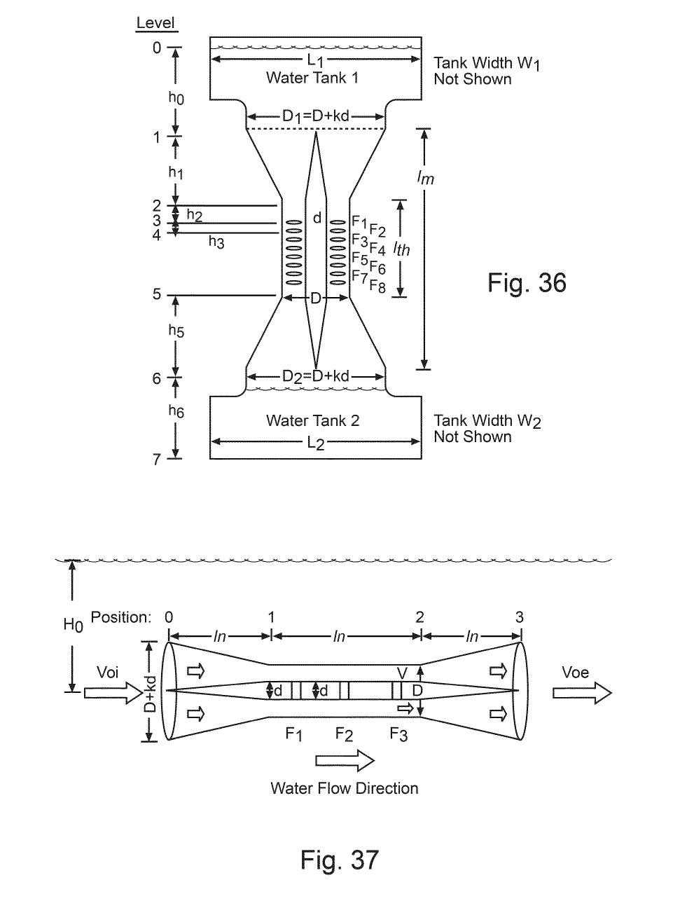

Both in the vertical water electric generator (WE generator), shown in FIGS. 32 and 36, as well as in the horizontal WE generator, shown in FIGS. 29 and 37, all fans are operated as generator fans. The diameter of the nozzles is chosen as D+kd, where k is an integer >0. The length lₜ of the top and bottom nozzles in the vertical WEG may be calculated from Eq. (9) but the top nozzle may be shorter than the bottom one on account of the fact the water flow is accelerating in the top nozzle but is decelerating in the bottom one which implies there is usually less turbulence in the top termination than in the bottom one.

### Accelerated Wind Turbine

A particular form of a fluid electric generator is the Accelerated Wind Turbine (AWT or AW turbine), an example of which is shown in FIG. 30. It is an energy conversion machine in which the external wind may enter through either one of its nozzle terminations. In the AWT mode of operation all of the motors of the fans (F₁, F₂, etc.) are disconnected from the power supply and the wind velocity is increased in any of the nozzles from its external value V_{φ} up to the maximum value V_{φ2} and then is conducted to the throat where it impacts the rotary blade set of the electric fans, The fan blades are then rotated by the accelerated wind, and as a result a voltage is induced in the electric leads of the fans that now operate as generator fans (i.e., like turbines). There may be as many fans as needed to achieve the required output power. The total induced voltage is equal to the sum of the individual voltages generated by the generator fans if these are connected in series.

By applying the continuity equation it may be readily show that the relationship between wind speeds v_{φ} and v_{φ2} is given by either one of the following equations

V_{φ2}=k_{f}V_{φ1} (15)

Where kf is given by Eq. (8) as

k_{f}=(D+kd)²/(D+d)(D−d) (8)

Example Assuming k=1 , v_{φ1}=20 Km/h; D=0.5 m, and d=0.31 m, the result is D+d=0.81 m; V_{φ2}=85.26 km/h. In other words, the fluid acceleration chamber in this case multiplies the entering wind speed by a factor greater than 4, which leads to a considerable increase in the generated power and efficiency of the AW turbine, as may be seen from Eq. (29) and Eq. (39) in Sections Mechanical Power Calculations and Calculation of the Mechanical Power Gain for an AF Machine.

Notice that in order to achieve a higher output power in a conventional horizontal axis wind turbine (HAWT), usually the size (length) of the blades is augmented to increase the area swept by the blades. However, usually no attempt is made to obtain higher output power by increasing the velocity of the incoming wind before it impacts the blades. In contrast, in the present Accelerated Wind Turbine, the velocity of the wind outside is increased in the fluid accelerating chamber by a speed multiplying factor kf, given by Eq. (8). This approach of raising the wind speed to increase the wind turbine efficiency is much more effective and economical than making the blade size bigger, taking into account that output power is proportional to the cubic power of the wind speed striking the blades, as shown in Eq. (28), Section Mechanical Power Calculations, and that a bigger blade means a heavier one, a greater moment of inertia lₜ, and hence, a lower turbine rotational velocity n, and a smaller generated power P_{g}, as shown by Equations (27) and (28).

### Electrical Power Calculations

The Fluid Electric Generator may be viewed as a system with one input and one output. The input is the electrical power applied to the electric motor or motors (by a battery, mains or a power supply). The output is the useful electrical power developed at the electric load. Also, the FEG may be initially viewed as composed of two main active components, namely, one equivalent electric motor, and one equivalent electric generator. The purpose of the electric motor is to produce the accelerated fluid. The purpose of the electric generator is to extract energy from the accelerated fluid and to convert it into electrical energy. Thus the FEG may be represented by the model shown in FIG. 35, assuming for convenience that the motor and the generator are DC machines. A similar analysis may be derived for AC machines. It is also assumed that the load resistance RI_{—} is matched to the generator Ro for maximum power transfer.

The electrical power gain of the FEG is defined as

Gₚₑ=Pₒ/ Pᵢ (45)

Where P₀ is the electrical power developed by the machine at the load resistance R_{L}, and Pᵢ is the electrical power applied by the power supply to the electric motor.

### Self-Sustainable Fluid Electric Generator

The FEG machine may operate as a self sustainable generator if the electrical power gain Gpe is greater than unity. The following will show that the FEG may be self sustainable if a certain relationship among the motor input resistance Rᵢ, the generator output resistance R₀, the applied input voltage vᵢ, and the electromotive force v_{g} is fulfilled. For the worst case of maximum input power, the counter electromotive force v_{gc}=0, and

Pᵢ=vᵢ²/Rᵢ (46)

But, for maximum power transfer it may be shown that

Pₒ=v_{g}²/(4Rₒ) (47)

For self-sustained operation, it is required that

Gₚₑ>1 (48)

This in turn requires that

Pₒ>Pᵢ (49)

Or

v_{g}²/(4Rₒ)>vᵢ²/Rᵢ (50)

From Eq. (50), the condition required for the FE generator to be self sustainable may be obtained:

v_{g}>2(Rₒ/Rᵢ)^{1/2}vᵢ (51)

For example, if the motor and the generator are chosen such that Rₒ=10⁻²Rᵢ then for self-sustained operation, it is required that

Vg>0.2Vj

FIG. 42 shows schematically an Air Electric Generator implemented with ordinary commercially available electric fans, like the ones shown in FIG. 25, and tested. Five electric fans were operated as generator fans, namely, G1, G2, G3, G4, connected in series, and. G5, connected in parallel. All of the fans used were DC brushless axial fans of three different types. Fans G1, G2, G3, and G4 were 48 V 0.45 A fans, with dimensions: 120 mm×120 mm×38 mm, and each having an internal (measured) resistance of about 340 Ohm On the other hand, fans M1, M2 and M3 were used as motor fans and connected in parallel to generate the airflow. These were 48V 3A fans with dimensions 120 mm×120 mm×38 mm, and each having an internal (measured) resistance of about 60 Ohm. Referring to the equivalent circuit for motors and generator fans (FIG. 35), the total internal resistance of the motor fans was R,=20 Ohm The total output resistance of generator fans connected in series was 1360 Ohm In order to fulfill the condition for self-sustaining movement, as stated in Inequality (44), it was necessary to reduce this large resistance to about R₀=5.25 Ohm. This was done so by connecting fan G5 in parallel with the series combination of generator fans G1, G2, G3, and G4. Fan G5 had the following features: 12 V, 4.40 A, dimensions: 120 mm×120 mm×38 mm, and with an internal (measured) resistance of about 5.25 Ohm The following experimental results were obtained with the arrangement of FIG. 42:
Input voltage: vi=14.95 V

Output voltage in open circuit: 15.54 V
Input power Pi=11.18 W
Output power Po=11 .5 W Since Inequality (49) was fulfilled it may be concluded that this rather AE generator behaves as a self-sustainable machine.

### A Vertical Accelerated Water Machine

The Vertical Accelerated Water Machine is in one embodiment an open chamber accelerated fluid machine positioned in a vertical or upright position between a superior reservoir or water tank 1 , and an inferior reservoir or water tank 2, as shown in FIG. 36. Both tanks may have similar dimensions and, for simplicity and ease of mass manufacturing the machine, it will be taken that D=D₂=D+kd, and h₁=h₅. In the example shown in FIG. 36, eight fans have been placed within the throat. However, there may be as few as one fan and as many as there may be placed in length l_{f} of the throat. If all the fans are mechanical, i.e., if they just generate mechanical energy, the vertical accelerated water machine becomes a Vertical Accelerated Water Motor, or just a Water Motor (WM) for short. But, if the fans are electrical and some or all of them convert the energy extracted from the water flow into electric energy, then the machine becomes a Vertical Accelerated Water Electric Generator or simply a Water Electric Generator (WEG or WE generator).

It will be assumed that water tank 1 is large (compared to nozzle diameter D₁), and in contact with the atmosphere both at level 0 and at level 1, where some tiny perforations may be made to allow the entrance of air but not water leak. Therefore pressure at level 0 of water tank 1 is p₀=0, and at level 1 is pi=0. Water velocity at level 0 is V₀=0, and at level 1 is:

V₁=√[2gh₀] (52)

But according to the continuity equation, water flow velocity al level 2, is given by

V₂=A₁V₁/A₂ (53)

Where the cross sectional areas A₁ and A₂ seen by the falling water stream at levels 1 and 2 are

A₁=π(D+kd)²/4 (54)

A₂=π(D+d)(D−d)/4 (55)

V₂=(D+kd)²V₁/[(D+d)(D−d)] (56)

Note that water velocity at level 2 is obtained by multiplying velocity at level 1, V₁ by the Water Velocity Multiplier factor k_{f}, given by

k_{f}=[(D+kd)²/(D+d)(D−d)] (8)

Which is always greater than 1 if 0<d<D, which is always the case for an energy conversion machine.

Length h₁ of the AWM may be chosen to prevent cavitation from taking place by ensuring that water pressure al level 2, p₂, satisfies the following relationship

p₂>Water vapor pressure pᵥ=−97.09 kPa, at 30° C. (57)

On the other hand, by applying Bernoulli Equation to a water flow line between levels 1, and 2, it is obtained, assuming a steady, inviscid, and incompressible flow,

p₂=(½)ρ(V₁²−V₂²)+ρgh₁ (58)

p₂=(ρ/2)(V₁²)(1−k_{f}²)+ρgh₁>pᵥ (59)

h₁=(1/ρg)p₂+(k_{f}²−1)h₀ (60)

For the accelerated water machine to be realizable it is required then that

p₂>pᵥ (61)

And

h₁>0 (62)

Now defining p₂ₘᵢₙ as the minimum value of pressure p₂ that makes height h₁ as given by Eq. (60) equal to zero.

Thus, from Eq. (60):

p₂ₘᵢₙ=(1−k_{f}²)(ρgh₀) (63)

Now defining k_{fmax} as the maximum value of k_{f} for which p₂ₘᵢₙ=pᵥ. This is an upper bound for factor kf to fulfill realizability conditions:

p₂>p₂ₘᵢₙ>pᵥ (64)

h₁>0 (65)

And

k_{f}<k_{fmax} (66)

Thus

k_{fmax}=√[1−(pᵥ/ρgh₀)] (67)

If Inequalities (64) and (66) are satisfied, cavitations will not take place.

For example, supposing h₀=0.3 m, D=0.5 m, and d=0.3 m, p=995.7 Kg/m³, g=9.8 m/s², then

k=1:

kfmax=5.85

kf=4<kfmax

k=2:

kfmax=5.85

k_{f}=7.56>kfmax

So, discarding k=2, and taking k=1. Then

V₁=√[2(9.8)(0.3)]=2.42 m/s

V₂=k_{f}V₁329.70 m/s

And

p₂min=(1−k_{f}²)(pgho)=−43,910.37 Pa

Taking

p₂=Δ40,000.00 Pa>Δ43, 910.37 Pa>pᵥ=−97,090 Pa

Then,

H₁=(1/pg)P2+(kf²−1)h₀=0.40 m

Note that in order to get V₂=9.70 m/s with a free water jet using just gravity, the required tank depth h₀ plus the termination length hi would have been:

h₀+h₁=V₂²/(2 g)=4.8 m

Whereas with the water motor for achieving the same speed it is only required that

h₀+h₁=0.3+0.4=0.7 m, and p₂=−40 KPa,

An 85.42% height reduction results. This is a definite advantage of the present accelerated water energy conversion machine over conventional hydraulic machines, and may be achieved by by making h₁>0, and p₂>P2min—By applying Bernoulli Equation at levels 2 and 3 and noting that V₂=V₃ the following equation is obtained

p₃=p₂+ρgh₂ (68)

If P₂>pv, then p₃, p₄, etc., will all be greater than pᵥ, and no cavitations will take place.

For example, assuming h₂=0.25 m, and the same geometrical parameter values as before,

P3=P2+Pgh₂=−40,000.00+(995.7)(9.8)(0.25)

p₃=−37,560.54 Pa>pᵥ=−97,090 Pa

### Power Calculations for a Vertical AW Machine

Suppose that Nr identical axial fans (water turbines), each with Nb blades, are placed within the water velocity enhancer of cross-sectional area A₂ given by Eq. (55). Then for the following parameters, with just one turbine (Nₜ=1), having N_{b}=8 blades, blade coefficient values: C_{D}=0.040163; C_{L}=0.46852, blade span s=0.09 m; blade chord c=0.175 m, D=0.5 m, d=0.3 m, φ=45 °, h₀=0.15 m, n=900 rpm, and by applying Equations (8), (52), (53), (19), (30), (29), (38), (63), (67), (60), and (9), respectively, the results shown in Table IV are obtained for the parameter k_{f}, fluid velocities V and V₂, relative fluid velocity V_{φ}, input flow power P_{φ}i, generated mechanical power P_{g}, mechanical power gain Gₚₘ; P2ₘᵢₙ; k_{fm}ax; h₁, and nozzle length lₙ. The calculations were done for two values of parameter k, namely:

k=1, and k=2, and assuming p₂=−18,000 Pa>p₂ₘᵢₙ; P=995.7 kg/m³; g=9.8 m/s².

For k=1 , generated power P_{g} (37.438 kW) is much greater than input power P_{φi} (1.262 kW), and may be used to drive an electrical generator, which in turn may be used to power a pump and the remaining electric appliances of the house. Alternatively the pump may be driven directly by the rotary water turbines. Thus for this particular AW machine it is possible to achieve self sustained motion (Gₚₘ=29.68>1), and generate a mechanical power of 37.438 KW. Of course, the power generated may be increased by a factor Nₜ simply by using Nₜ>1 water turbines. Even substantially better results are obtained for k=2, as may be seen from the results of Table II. Since for k=1, lₙ turned out to be greater than h-i , the length of the top nozzle is taken as h−i=0.41 m rather than In=0.95 m, with very little increase in turbulence as the water flow accelerates in the upper nozzle.

TABLE IV
Power calculation results for a Vertical Accelerated Water Machine

| k | k_{f} | V₁, m/s | V₂, m/s | V_{φ}, m/s | P_{φi}, W | P_{g}, W | Gₚₘ | p_{2 min}, Pa | kₜₘₐₓ | h₁, m | lₙ, m |
|---|---|---|---|---|---|---|---|---|---|---|---|
| 1 | 4 | 1.71 | 6.86 | 9.70 | 1,262 | 37,438 | 29.68 | −21,955 | 8.21 | 0.41 | 0.95 |
| 2 | 7.56 | 1.71 | 12.97 | 18.34 | 2,385 | 133,822 | 56.11 | −82,246 | 8.21 | 6.58 | 1.89 |

### Conditions for the Vertical Accelerated Water Machine

In order to make realizable the accelerated water energy machine the following conditions may be satisfied

hₒ>0 (69)

h₁>0 (70)

p₂>p₂ₘᵢₙ (71)

And p₂min is given by Eq. (63) for the symmetric AW Machine. Equation (69) implies that water tank 1 may never be allowed to empty. If a water pump is used for replenishing the water tank 1 it is required then that the refill time of the latter may be less than the time required to empty it. Accordingly the water flux Qₚ from the water pump is greater than the water flow Q−i, that is to say

Qₚ>Q₁ (72)

Where

Q₁=A₁V₁ (73)

### A Horizontal Water Machine

An open chamber horizontal water machine may be implemented using an open chamber AW machine like the one shown in FIGS. 18 and 22. It may be stationary or mobile. In the first case they may be placed and fixed under the water surface or on the bottom of the sea, river or lake to operate with tidal, submarine or under water currents. In the second case, it may be implemented with axial electric fans as shown in FIG. 37. The machine may be submerged in water and attached to a moving sea, lake or river vehicle to take advantage of the speed of the moving vehicle that gives rise to a water flow that may be captured and accelerated by the converging nozzle of the machine. Any water vessel, like a ship, a submarine, etc., may carry under the water surface and attached to it an open chamber Water Electric Generator to generate partially or totally the electricity required by the vessel. (See FIG. 48).

The design of a horizontal water electric generator is very similar to that of the vertical water electric generator as explained supra with reference to the Vertical Accelerated Water Machine, except that gravity has no effect in this circumstance. Additionally the water pressure po at depth ho and at the entrance of the machine is

pₒ=pgh₀ (74)

This is greater than atmospheric pressure, as may be seen from FIG. 37.

Consider the horizontal water electric generator shown schematically in FIG. 37 containing 3 electric fans and submerged at a depth h₀.

For the water flow line between positions 0 and 1 inside the WE generator, and assuming steady, inviscid, and incompressible flow Bernoulli Equation may be written as

pₒ+p(V₀²)/2=p₁+ρ(V₁²)/2

Hence

pᵢ=pₒ−ρ(V₁²−V₀²)/2

But

V₁²=k_{f}²V₀²

And

V₀=V_{φi}

And kf is given by Eq. (8). Then

p₁=pₒ−p(k_{f}²−1)V₀²/2 (75)

If V₀ and ho are known, then kfmay be chosen to make sure that pi will be greater than −97,090 Pa to prevent the occurrence of cavitations.

Thus

k_{fmax}=√{1+[2(p₀−pᵥ)/ρV₀²]} (76)

And

V₀ₘₐₓ=√{2(p₀−pᵥ)/[ρ(k_{f}²−1)]} (77)

Of course, the higher the value of po, the higher may be the values of k_{fmax} and V₀ₘₐₓ.

### Radial Fans

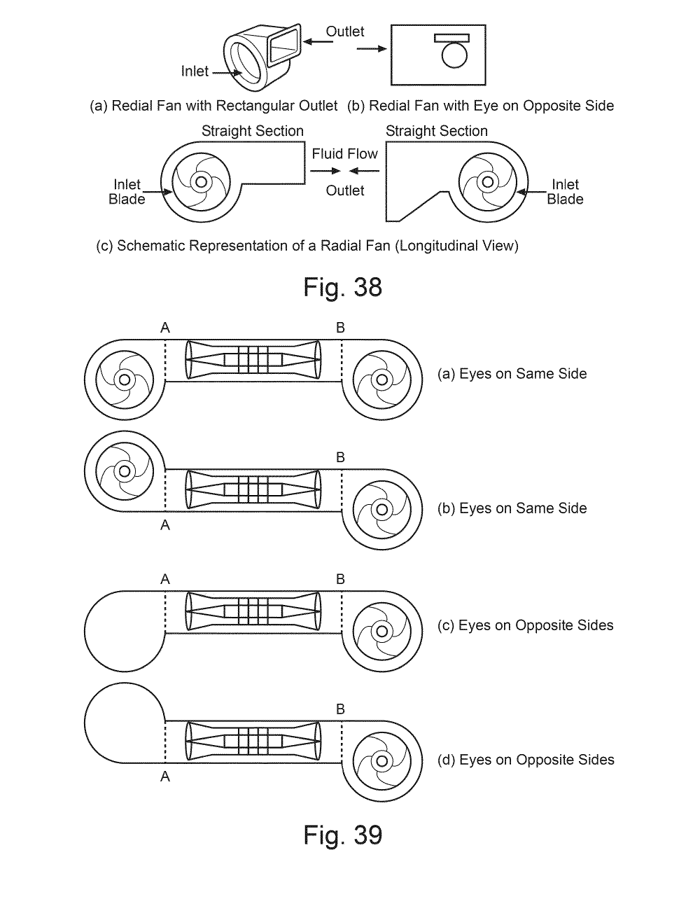

In FIGS. 38(a) and 38(b) two commercially available radial fans are depicted, and in FIG. 38(c) a schematic diagram of them is shown. The inlet is where the fluid usually enters the fan, and the outlet is where the fluid usually comes out of the fan. The inlet consists of the eye and the rotary blades. As the blades rotate fluid is sucked in through the casing eye, flows in a radial fashion outward and comes out through the outlet or discharge. The outlet cross-sectional area may be round or rectangular, for example.

Open Fluid Acceleration Machine with Radial Fans

The open fluid acceleration machine using radial fans may be implemented by connecting by their straight section two radial fans like the ones shown in FIG. 38, and placing the Venturi-like throat for axial fans in the straight section as shown in FIG. 39. This is an open chamber FE generator, implemented with two radial electric fans, one operating as a motor fan and the other operating as a generator fan. Additionally 4 electric axial fans are placed within the fluid acceleration chamber positioned in the straight section joining both radial fans. The axial fans may all work as generator fans or some of them may work as motor fans and the others as generator fans. Of course there may be less or more than 4 axial fans in the throat.

### Tandem Accelerated Fluid Machines

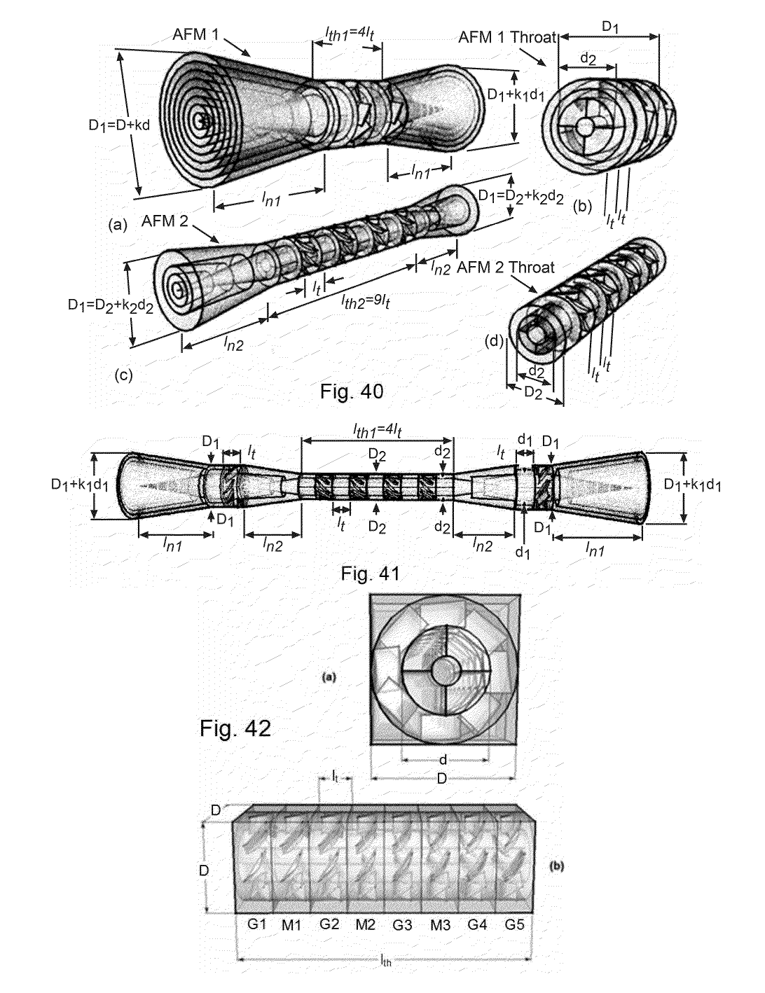

Two or more energy conversion machines of different cross-sectional areas, like the ones shown in FIG. 40 may be connected together in tandem, using an arrangement similar to the one shown in FIG. 41. The requirement for achieving this interconnection is that the throat external diameter of both machines satisfies the following relationship

D₂+k₂d₂D₁ (78)

Where this the throat diameter of the machine 1, as shown in FIGS. 40(b),₂ and d₂ are, respectively, the outer and inner diameter of the throat of machine 2, and k₂ is an integer (k₂=0, 1, 2, 3, . . . ). And the larger diameter of nozzles of machine 1 is given by

D₁+k₁d₁ (79)

Where k₁ is an integer (k₁=0, 1, 2, 3 . . . ).

On the other hand, if the fluid speed at the entrance of AFM1 nozzle is v_{φ} fluid speeds in AFM1 throat and AFM2 throat are, respectively,

V_{φ1}=k_{f1}V_{φi} (80)

V_{φ2}=k_{f2}V_{φ1}=k_{f1}k_{f2}Vφ1 (81)

Where k_{f1} and k_{f2} are given from Eq. (8) by

k_{f1}=(D₁+k₁+d₁)²/[(D₁−d₁)(D₁−d₁)] (82)

k_{f2}=(D₂+k₂d₂)2/[(D₂+d₂)(D₂−d₂)] (83)

Eq. (81) may be generalized for j turbines in tandem (j=2, 3 . . . etc.), and the fluid velocity in throat of nth turbine may be written as

V_{φj}=k_{f1}k_{f2} . . . k_{fj}V_{φ1} (84)

Where

k_{fj}=(Dⱼ+kⱼdj)²/[(Dj+dj)(Dj−dj)] (85)

Of course if power generated separately by each energy conversion machine are P_{g1}, P_{g2}, P_{g3}, etc., the total power P_{g} generated by j machines in tandem will be

P_{g}=P_{g1}+P_{g2}+ . . . P_{gj} (86)

### Closed Chamber for AF Machines

Accelerated Fluid Machines may also be implemented in a closed chamber arrangement, where the operating fluid (typically air or water) is confined and not allowed to escape to the environment. Two possible shapes for the closed chamber that may be used for axial fans and thermal airfoil turbines are the constant cross-sectional area toroids, shown in FIG. 43. FIG. 43 (a) shows the plan view of an empty chamber toroid, the 2-leg (180° bends) toroid, with gradual transitions between the straight sections and the curved sections. FIG. 43(b) shows the plan view of another empty chamber toroid, the 4-leg (90 ° bends) toroid. FIG. 44 shows a fluid voltage generator consisting of two tandem identical energy conversion machines, like the one shown in FIG. 41, each placed in the straight section of a 2-leg toroid and consisting of 4 small turbines of diameters D₂ and d₂ plus two larger turbines of diameters D and di.

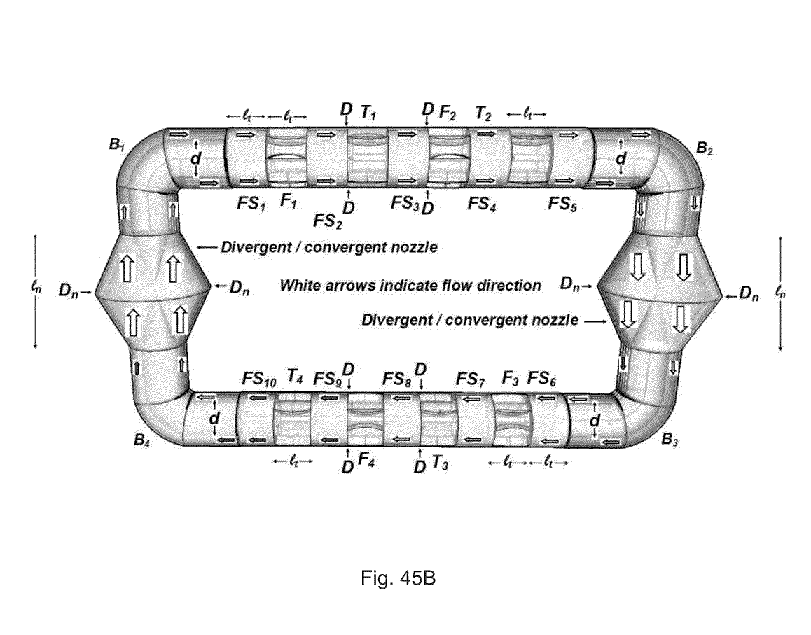

In addition, two large similar electric fans, each of diameter D₁+kd₁; are placed in the middle of the curved section of the toroid for the purpose of creating the fluid that will make the turbines spin, after being accelerated in the accelerating nozzles N₁ and N₃. The fluid created by the fans is made to circulate in a single direction, for example clockwise and is decelerated in diverging nozzles N₂ and N₄. FIG. 45A shows another closed chamber fluid voltage generator using a couple of electric fans, of diameter D₁+kd₁, each positioned in a curved section of the toroid. Additionally, two identical tandem energy conversion machines are placed in the straight sections of the toroid. Each tandem machine contains two small turbines of diameters D₂ and d₂ plus two larger turbines of diameters D₁ and d₁. To minimize turbulence arising in the 90° bends due to the variation of centrifugal force therein curved concentric stationary cylindrical vanes are placed inside each curved section.

FIG. 45B shows another closed chamber fluid voltage generator using four electric fans, four turbines, and ten flow straighteners. Al, of these components are placed in the straight sections (throats) of the machine. To minimize turbulence arising in the 90° bends due to the variation of centrifugal force therein curved concentric stationary cylindrical vanes are placed inside each curved section.

A third shape for the closed chamber that may be used with radial (centrifugal) fans consists of two identical open chamber energy conversion machines for radial fans, like the one shown in FIG. 46A(a), placed side by side, one against the other in such a way as to close all the eye openings to prevent from any fluid leakage, as is shown in FIG. 46A(b).

The closed fluid acceleration chamber may be used in all energy conversion machine applications, except for wind generator applications that require an open chamber. On the other hand, the open fluid acceleration chamber in any of its varieties may be used in all AFM applications including accelerated wind turbine applications.

In the next sections various possible applications of the accelerated fluid machines are proposed.

### Mobile AF Machines in Land, Air, and Sea Vehicles.

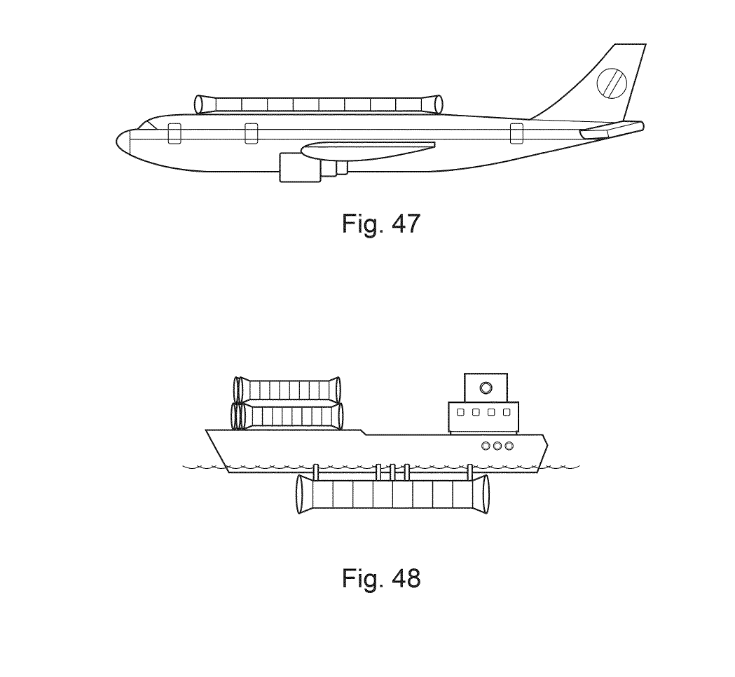

Any moving land, air or water vehicle may generate all or part of the electricity it requires by using an Accelerated Fluid Electric Generator, either in open chamber or in closed chamber fashion, attached to the structure of the vehicle. In FIGS. 47 and 48 some applications of the open chamber accelerated fluid machine are shown. In all of these applications the speed of the fluid entering the open chamber accelerated fluid machine is the same as the velocity of the vehicle. However the fluid velocity is further increased within the FA chamber of the energy conversion machine. Alternatively, a fluid panel containing several energy conversion machines to capture part of the surrounding fluid flow may be mounted on the vehicle instead of a single energy conversion machine. .

### A Battery of Water Electric Generators

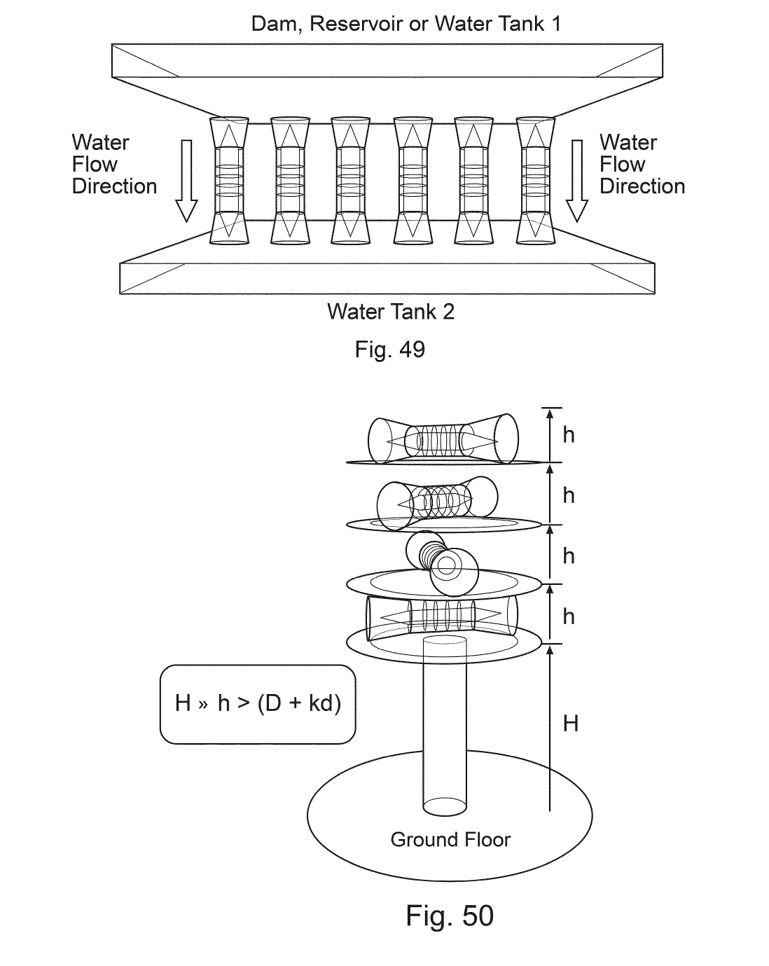

For high power requirements, a battery of several water electric generators fed from the same water tank or reservoir may be used, as is shown in FIG. 49. Alternatively, a water panel may be placed horizontally submerged under any body of water where there are underwater currents

### An Accelerated Wind Turbine Array

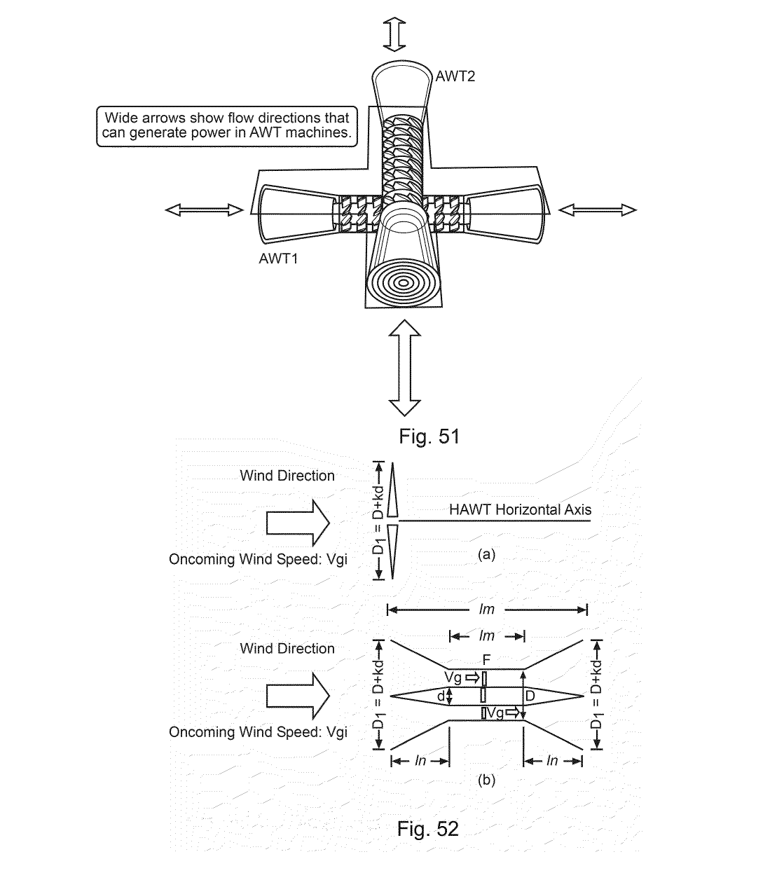

For capturing wind coming from several directions, several Accelerated Wind Turbines each pointing at a different direction may be placed in horizontal platforms separated vertically from each other, as shown in FIG. 50, or one on top of the other separated by a tray, as is shown in FIG. 51. The array may also be formed with one or more wind panels, as described in Section Fluid Panel

The main embodiment presented herein is the accelerated fluid machine and its variations, namely, the water electric generator, the air electric generator, and the accelerated wind turbine. Combinations of energy conversion machines like the fluid panel and the tandem energy conversion machines have also been proposed to achieve higher power generation. It is proposed to employ symmetrical energy conversion machines and electric brushless dc axial fans with high flowrate Q to implement each of them.

A preferred manner to implement the air electric generator, the design process may be divided into two parts, namely, the mechanical power calculations, and the electrical power calculations. The mechanical power calculations are carried out as explained in sections Mechanical Power Calculations, Calculation of the Mechanical Power Gain for an AF Machine, and Condition for Self-Sustained Movement of the Fluid Turbines. The purpose of these calculations is to determine the required number of fans, Nₜ, the number of revolutions per minute, n, for a given fluid speed V_{φ1,} the input power P, the generated power P_{g}, and the mechanical power gain Gₚₘ to ensure a self sustainable movement, i.e. Gₚₘ>1. Once this is achieved the electric power calculations are carried out as explained in sections Electrical Power Calculations, and Self Sustainable Fluid Electric Generator, keeping in mind that the electrical power gain Gₚₑ may be greater than 1 for self sustainability; hence the total input resistance R, of the motor fan(s), the total output resistance R₀ of the generator fan(s), applied input voltage vᵢ; and the generated voltage v_{g}may fulfill Inequality (51).

For example, assuming an air electric generator having D=0.5 m, d=0.3 m, Nₜ=4 identical fans, each with N_{b}=8 blades; n=900 rpm, and the following blade parameters: C_{D}=0.040163; C_{L}=0.46852, span s=0.09 m; chord c=0.175 m, φ=45°, k=1, and V_{φ1}=8.25 m/s. Then, by applying Equations (8), (9), (15), (19), (32), (37) and (38), respectively, the results shown in Table V were obtained for kf, nozzle length lₙ, v_{Φ}2, v_{φ}, input fluid power P_{φi}, generated mechanical power P_{g}, and mechanical power gain Gpm.

TABLE V
Power calculation results for an air electric generator

| | | | V_{φ1}, | | | | | |
|---|---|---|---|---|---|---|---|---|
| k | k_{f} | lₙ, m | m/s | V_{φ2}, m/s | V_{φ}, m/s | P_{φi}, W | P_{g}, W | Gₚₘ |
| 1 | 4 | 0.95 | 8.25 | 33 | 46.67 | 173.58 | 4,282.65 | 24.67 |

A preferred manner to implement an Accelerated Wind Turbine is shown schematically in FIG. 52(b). Let us first compare the power gain obtainable with a conventional horizontal axis wind turbine and with an Accelerated Wind Turbine. FIG. 52 shows the side views of both machines. Let us assume the maximum diameter of both machines is the same, namely D,=D +kd. In order to make the performance comparison between both machines, it will be assumed that the AW turbine has just one fan, and that the three blades of both machines have the same value for coefficients Ci_{—} and CD.

The power P_{φi} of the incoming wind flow at the entrance of both machines is given by:

P(ₚi=TTp(D+kd)²v_{φ1}³/8 (87)

According to Betz's Law for conventional wind turbines, the maximum power P, a HAWT may capture from the incoming wind is 59.3%, i.e., HAWT power efficiency≦59.3%.

From Eq. (26), it may be readily shown that for a HAWT with N_{b} blades, chord c, the useful mechanical power generated, P_{g}, is given by

P_{g}=(π/480)p(C_{L} sin<p−C_{D} cos φ)N_{b}c[(D+kd)²−d²)]nv_{φ1}² (88)

For this AWT, on the other hand, Eq. (26) is used to calculate P_{g}

P_{g}=(π/480)p(C_{L} sin φ−C_{D} cos<p)N_{b}c(D²−d²)nv_{φ}² (26)

Where V_{φ} is given by Eq. (35) as

V_{φ}=k_{f}V_{φ1}/sin φ (35)

And the mechanical power gain (Efficiency) for both machines is defined as

Gₚₘ=P_{g}/Pi (38)

Equations (87), (88), (26), (35), and (38) may be used to design a HAWT and an AWT.

Example Assuming the following data to be the same for both HAWT and the AWT machines: v_{φ1}=10 m/s N_{b}=3 blades, k=2, coefficient values: C_{D}=0.040163; C_{L}=0.46852, D=0.5 m, d=0.3 m, blade chord c=0.15 m and n=900 rpm. Then, by applying previous data and Equations (8), (9), (35), (87), (88) or (26), and (38), obtained respectively are the results shown in Table VI for the fluid velocity multiplier kf; nozzle length lₙ, relative fluid velocity in AWT throat, v_{φ}; input power P_{φi}; generated mechanical power P_{g}, and mechanical power gain Gₚₘ. Observe that the power generated by the HAWT is 110.61 W, whereas the power generated by this AW turbine is 1,807.34 W, i.e., 16 times greater. On the other hand, for this AWT the power gain Gₚm exceeds 100%, which is not possible for the HAWT.

TABLE VI
Power Calculation Results for an HAWT and an AWT machine

| Ma- | | | | V_{φ1}, | | | | |
|---|---|---|---|---|---|---|---|---|
| chine | k | k_{f} | lₙ, m | m/s | V_{φ}, m/s | P_{φi}, W | P_{g}, W | Gₚₘ |
| HAWT | 2 | NA | NA | 10 | NA | 584.45 | 110.61 | 0.19 |
| AWT | 2 | 7.56 | 1.89 | 10 | 106.95 | 584.45 | 1,807.34 | 3.09 |

### Airflow Motor Embodiment

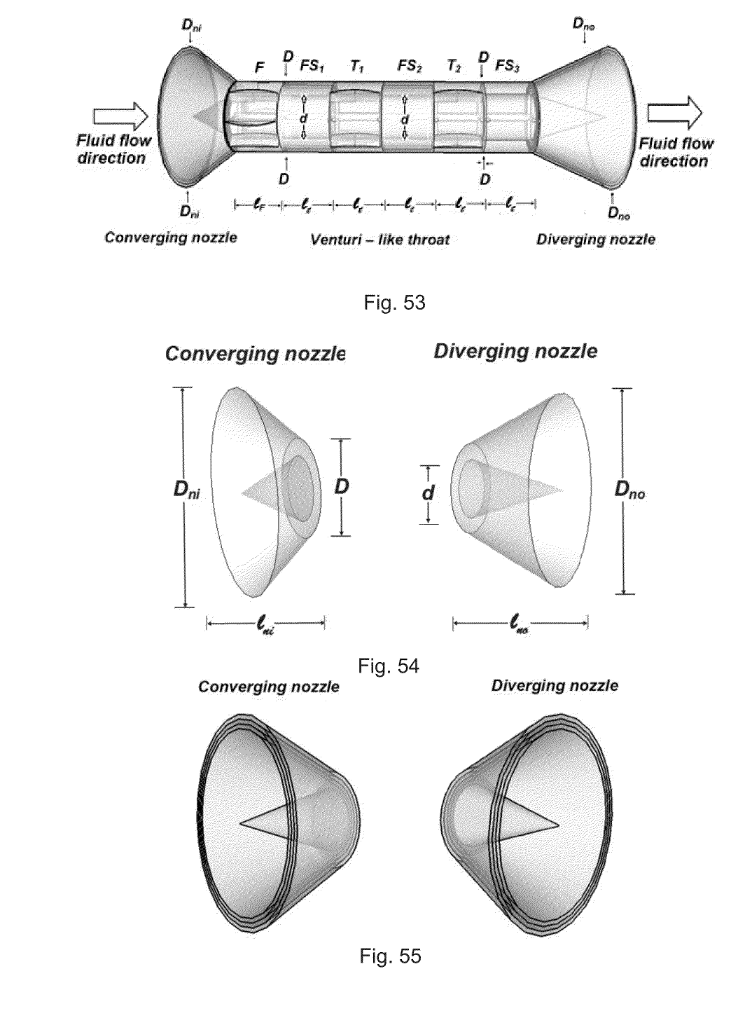

The Airflow Motor is an apparatus capable of converting part of the thermal energy carried by an internally accelerated airflow into a significant amount of mechanical energy which can be much greater than the applied mechanical energy used to move a fan that produces the airflow. The Airflow Motor in this preferred embodiment is composed of a housing or empty chamber consisting of a converging inlet nozzle, a Venturi-like throat, a diverging outlet nozzle; a fan, and one or more thermal airfoil turbines (Reference B1) that are placed within the Venturi-like throat, as shown in FIG. 53.

The converging inlet nozzle and the diverging outlet nozzle are funnel-cone terminations which purpose is, respectively, to accelerate the incoming airflow or to decelerate the outgoing airflow.

FIG. 53 shows an inlet nozzle and an outlet nozzle, and FIG. 54 shows the same nozzles but including thin separation layers inside the space between the internal cone and the larger truncated cone. These layers are very light and they act as flow straighteners to make the airflow produced by the fan as laminar and straight as possible and thus achieve a higher turbine efficiency. It is also possible for the empty chamber to contain just the Venturi-like throat and no funnel-cone termination, but this arrangement is less efficient.

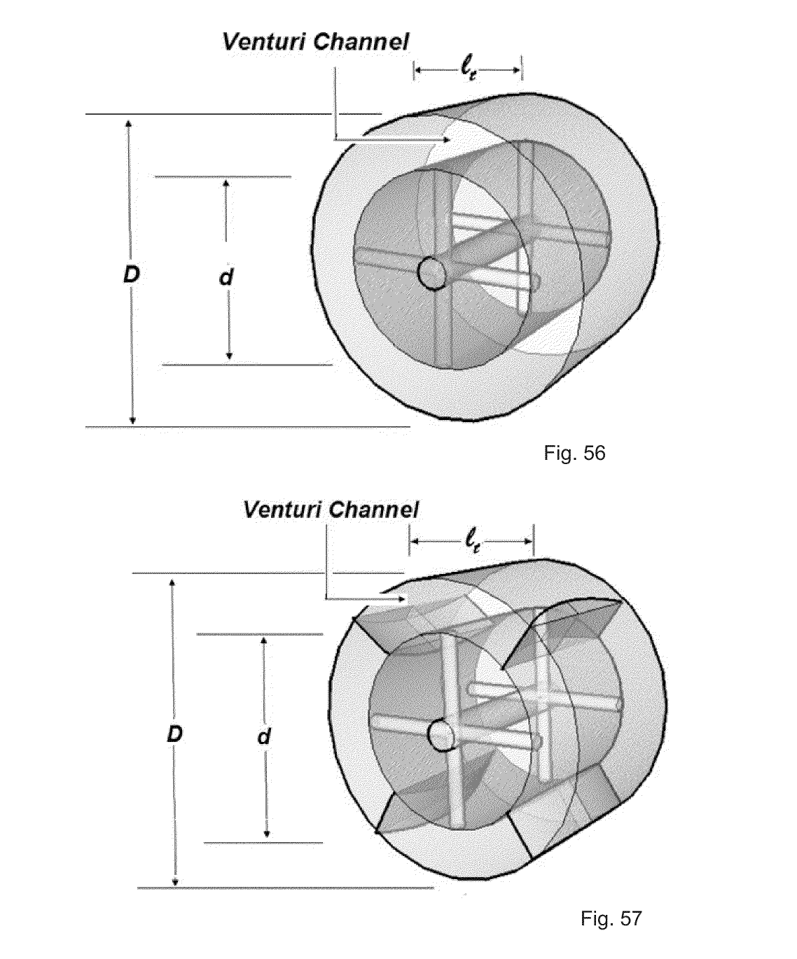

The Venturi-like throat is the straight and narrowest component of the airflow motor and is placed between the inlet nozzle and the outlet nozzle. It is formed by concentric cylinders, the exterior cylinder having an internal diameter D, and the interior one having an external diameter d (0<d<D). In the air passage formed in the Venturi-like throat, the airflow velocity Vφ reaches its maximum value. The Venturi-like throat can be built by joining together basic construction modules, each of length lt and formed by two concentric cylinders, as the one shown in FIG. 56

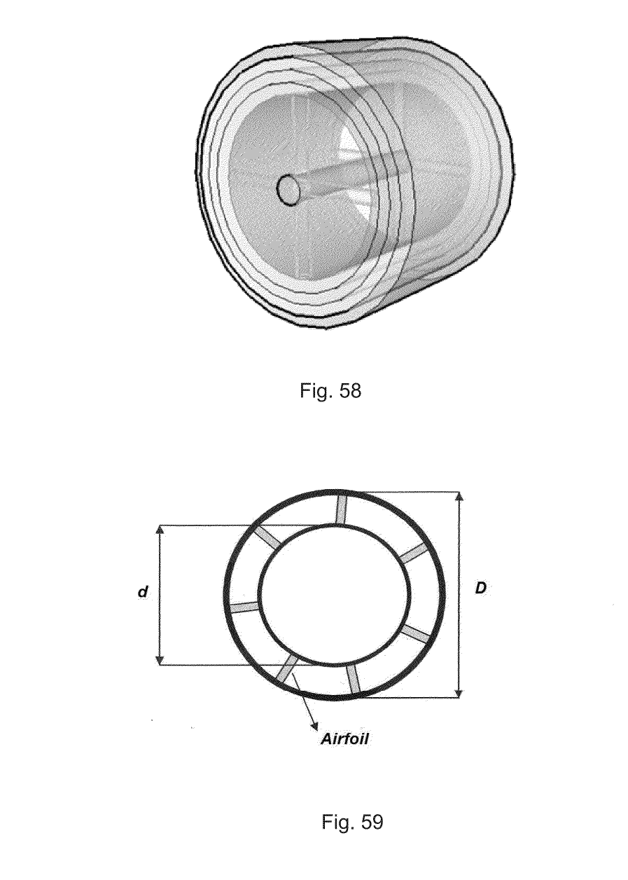

The purpose of the basic construction module is either to house one thermal airfoil turbine, as shown in FIG. 57, or to serve as an airflow straightener containing a number of concentric circular layers, as shown in FIG. 58. It can also be used to house the fan placed at the beginning of the throat as shown in FIG. 53.

The purpose of the fan is to produce the airflow destined to impact the airfoils of the thermal airfoil turbines. The fan can be placed at the entrance of the inlet nozzle or at the entrance of the Venturi-like throat. In the latter case the transversal dimensions (large interior diameter D and small external d) may coincide with the transversal dimensions of the thermal airfoil turbines. The fan can be driven either by an electric motor, or in small scale applications by a drill attached to its shaft.

The thermal airfoil turbine is the most fundamental part of the airflow motor. FIG. 57 shows a thermal airfoil turbine having 4 power generating elements or airfoils; an external cylinder of internal diameter D; and an internal cylinder of external diameter d over whose external surface the airfoils are placed separated from each other as uniformly as possible. Further down the minimum separation between adjacent airfoils will be established.

When the turbine is placed in the Venturi-like space, the airflow produced by fan F flows in a passage of cross-sectional dimension (D−d)/2, the Venturi Channel. The cross sectional area Ai of the Venturi channel is given by

Ai=(π/4)(D+d)(D−d), m² (B1)

If the Venturi-like throat is empty, i.e., if it does not contain any turbine, the power consumed by the empty chamber when an airflow of velocity Vφ flows in the Venturi-like throat is given by

P_{ec}=(½)ρAiVφ3, W (B2)

The airfoils are a fundamental part of the Thermal Airfoil Turbine. For better performance of the turbine it is recommended to use well recognized commercial aerodynamic airfoils such as models SD-7037 and HN-227 PRO, or 4-digit, 5-digit and 6-digit NACA airfoils.

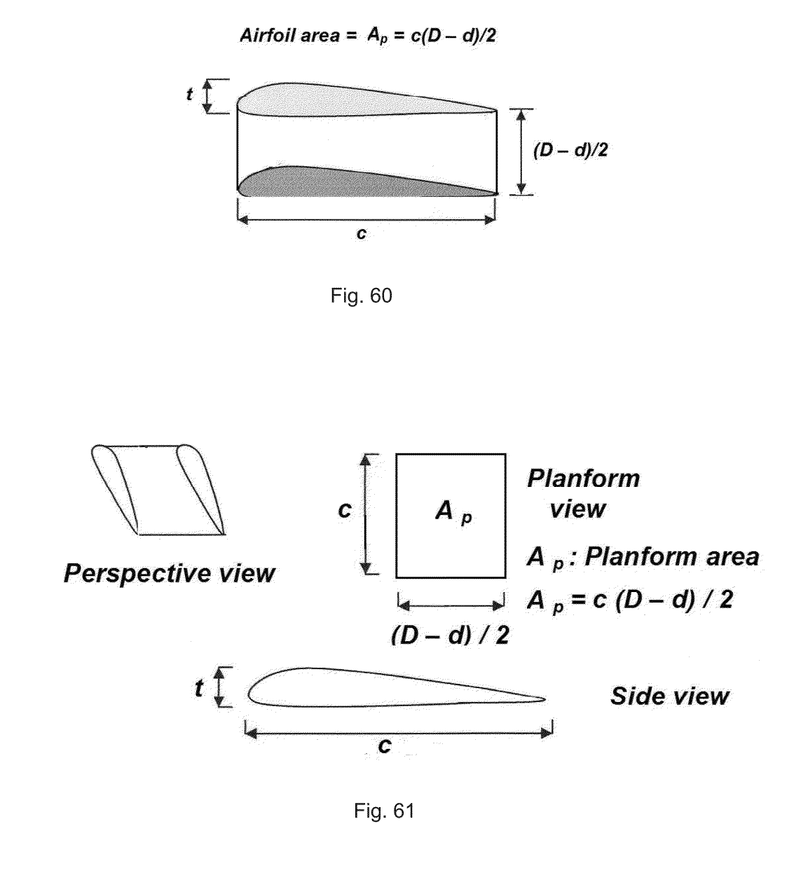

FIG. 60 shows a perspective view of an aerodynamic airfoil, showing its length or chord c, its thickness t and its height or span (D−d)/2.

FIG. 61 shows three views and some geometrical parameters of an airfoil. In conventional wind turbines usually the airfoil height (D−d)/2 is much greater than chord c. In contrast, in order to achieve a greater airflow velocity Vφ and higher efficiency, in thermal airfoil turbines the chord c is usually much greater than the height (D−d)/2. In other words, in thermal airfoil turbines usually the horizontal dimension predominates over the vertical dimension (D−d)/2 for the purpose of achieving a better performance, a reduced size and reduced weight. In some embodiments, the horizontal dimension it at least about 1.1, 1.2, 13, 1.4, 1.5, 1.6, 1.7, 1.8, 1.9, 2, 3, 4, 5, 6, 7, 8, 9, 10, 15, 20, 25, 30, 35, 4, 45 or 50-fold the vertical dimension.

When an airflow with a velocity Vφ hits on the airfoils, there appear on them two perpendicular forces (Reference B2), namely, a drag force FD which opposes the airflow velocity, and a lift force FL, which generates a torque T on the turbine shaft causing the turbine to spin with a rotational speed n (in rpm). The value of the rotational speed depends on the value of the load driven by the turbine. At maximum load, the turbine does not rotate (n=0), and the torque T is a maximum. When the turbine has no load attached to its axis, n is a maximum (free-running condition), and the Torque is zero.

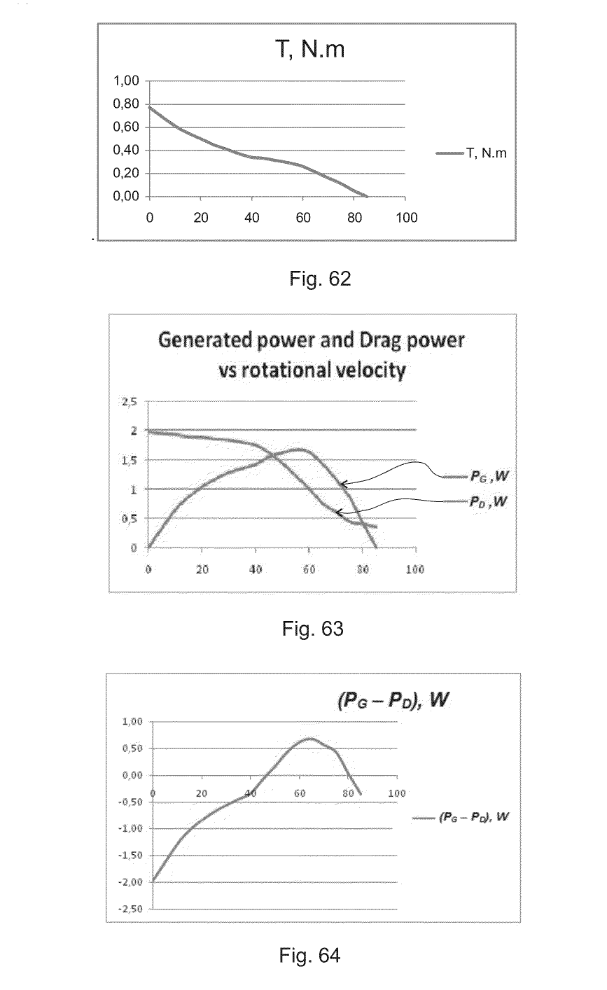

FIG. 62 shows the Torque versus n curve of a typical low-power turbine as a function of the load, for an airflow velocity Vφ=4.4 m/s. Two powers arise as the result of forces FD and FL, which respectively are the drag power PD, which is the power consumed by the thermal airfoil turbine, and the generated power PG, which is the power generated by the lift force FL acting on the airfoils.

The generated power PG is given by

P_{G}=(π/30)(T)(n), W (B3)

As shown in FIGS. 60 and 61, the airfoils have a chord length c, and a height or span h=(D−d)/2. The planform area of each airfoil is given by

Ap=(c)(D−d)/2, m² (B4)

The drag power and the generated power are given respectively by

P_{D}=(½)ρNₐNsC_{D}Ap cos αV_{φ}³, W (B5)

And

P_{G}=(½)ρNₐNₛC_{L}Ap sin αV_{φ}³, W (B6)

Where Na is the number of airfoils, Ns is the number of identical stages in the turbine placed in the Venturi-like section. CD and CL are respectively the drag coefficient and the lift coefficient of the airfoil at airflow velocity V_{φ}, and for a Reynolds number given by

R_{N}=(V_{φ}c/v)cos α (B7)

Where v is the fluid kinematic viscosity (equal to 1.46×10 ⁻⁵ for air), and a is the static attack angle of the airfoils. Although in the prototypes to be presented further down use is made of rectangular airfoils like the ones shown in FIGS. 60 and 61, with constant chord length, other shapes that provide even greater planform area and thus greater powers and efficiencies may be used, such as the trapezoidal shape, which have a side longer than the other, i.e. a variable chord length. FIG. 63 shows an experimental curve of the powers P_{D} and P_{G} consumed and generated, respectively, by a very low power thermal airfoil turbine, having Na=10 airfoils, D=50 cm, d=25 cm, and c=5.4 cm. The airflow velocity is V_{φ}=4.4 m/s.

From FIG. 63 it can be seen that for this particular turbine and for rotational speeds extending between 55 rpm and 80 rpm, the generated power P_{G} (red curve) is above the drag power P_{D}. FIG. 64 shows the difference P_{G}−P_{D} versus the rotational speed. The maximum difference between PG and PD for this particular turbine occurs at a speed n=65 rpm, and is equal to 0.68 W.

A thermal airfoil turbine may be designed to operate at the range of rotational speeds at which the difference P_{G}−P_{D} is positive, and within this range it is sought to operate at or near the rotational speed (and load) that produces the maximum value for difference P_{G}−P_{D}. In the case of this particular turbine, the optimum load is the one corresponding to n=65 rpm.

The input mechanical power Pi to the thermal airfoil turbine is defined as

Pᵢ=P_{ec}+P_{D} (B8)

Where Pec is the power consumed by the empty chamber as given by Eq. (B2).

The efficiency of the thermal airfoil turbine is defined as

ηₜ=(P_{G}/P_{D}) (B9)

And the airflow motor efficiency is defined as

η_{AM}=(P_{G}/P₁)(100) (B10)

In the case of the thermal airfoil turbine given above as an example, the following values for power and efficiencies were obtained with Vφ=4.4 m/s and n=65 rpm,

P_{D}=1.012 W; P_{ec}=7.715 W; P_{I}=8.727 W; P_{G}=1.634 W

ηₜ=(1.634)(100)/(1.012)=1.6146

η_{AM} =(1.634)(100)/(8.727)=18.72%

The turbine efficiency and the airflow motor efficiency for this particular turbine are very low. However, the airflow motor is generally designed for the purpose of obtaining as large values as possible for both efficiencies ηₜ and η_{AM}. Airflow motor efficiencies greater than 50% are possible if the thermal airfoil turbine and the empty chamber are properly designed.

It is worth noting that the above values of P_{D}, P_{ec}, and P_{G} for this example turbine were obtained for an airflow velocity Vφ1=4.4 m/s. However if the airflow velocity is increased to a velocity Vφ2>Vφ1 all of these power values are increased by a factor (Vφ2 /Vφ1)³. Hence if airflow velocity were duplicated to Vφ=8.8 m/s, all previous power values would be increased by a factor of 8.

### Power Calculations for the Thermal Airfoil Turbine

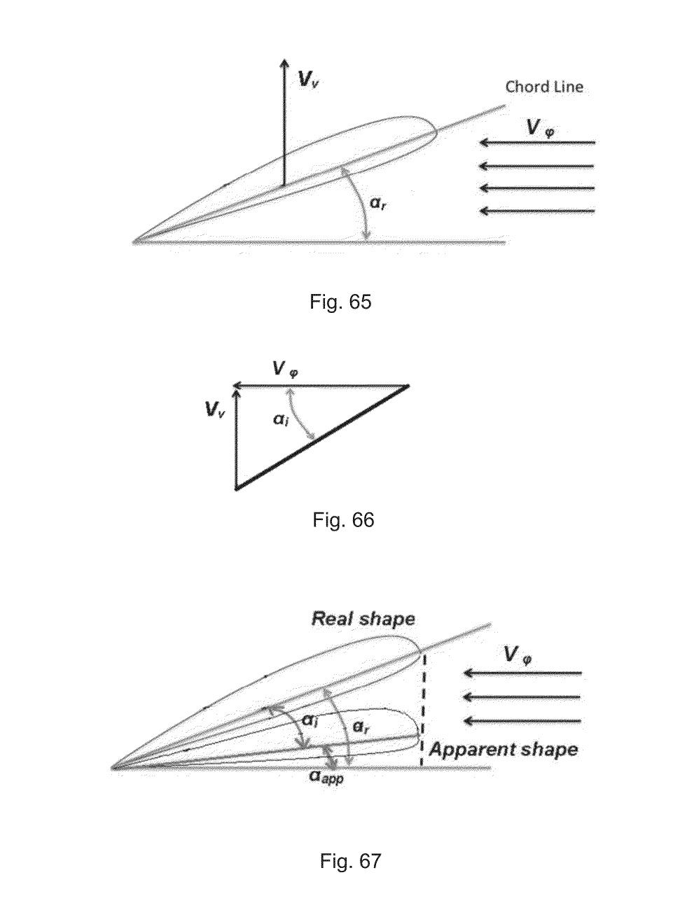

In order to establish mathematically the performance of the thermal airfoil turbine, power calculations are made for an aerodynamic airfoil whose cross-sectional area is inclined forming a real attack angle ar, and which is free of moving vertically with a velocity Vᵥ in the presence of a horizontal airflow of velocity Vφ, as appears in FIG. 65.

Making a composition of the velocities obtains the vector diagram of FIG. 66. The angle between both velocities is αi, the induced angle. From this diagram

Vᵥ=V_{φ} tan αᵢ (B11)

By carrying out a point by point graphical analysis (not shown) it may be shown that the velocity vector Vφ “sees” the airfoil as having an apparent angle, αₐₚₚ, instead of the actual (or real) angle, as shown in FIG. 67. In other words, the airflow sees the airfoil as having a length, an attack angle and a shape which is different from the actual static values.

From the graph in FIG. 64, the following expression can be written

αₐₚₚ=αᵣ−α_{I} (B12)

i.e., the airflow “sees” the airfoil as having an apparent angle which is equal to the difference between the real angle and the induced angle.

For the particular case in which the induced angle and the real angle are equal (αᵣ=α_{I}), the apparent angle would be zero, i.e., the airfoil appears before the airflow as having an attack angle equal to zero. In this case the following takes place:
a) The apparent area of the airfoil, Aₐₚₚ, is given by Aₐₚₚ=Aᵣ cos αᵢ, i.e., the airfoil appears smaller before the airflow
b) As a consequence, both values of the airfoil coefficients C_{L} and C_{D} increase. In other words, the original static values of the lift and drag coefficients are different from the values of these in a dynamic situation, i.e., for Vᵥ>0. (dynamic airflow coefficients)
c) The apparent thickness of the airfoil increases and its size decreases

Under these conditions the following expressions can be written

Vertical velocity: Vᵥ=V_{T} tan αᵢ

Lift force: FL

F_{L}=C_{L}ρAₐₚₚVφ²/2=(C_{L}ρAᵣVφ²/2)cos αᵢ (B13)

Drag force: F_{D}

F_{D}=C_{D}ρAₐₚₚVφ²/2=(C_{D}ρA_{ri Vφ}²/2)cos αᵢ (B14)

Where

Aₐₚₚ=Apparent area of airfoil as seen by airflow velocity Vφ

Aᵣ=Real area of airfoil

Using the above expressions, the respective powers are given by

Vertical power generated:

P_{G}=F_{L}Vᵥ=(C_{L}ρAᵣVφ²/2)cos αᵢVφ tan αᵢ₌

P_{G}=F_{L}Vᵥ=(C_{L}ρAᵣVφ³/2)sin αᵢ (B15)

Drag power consumed:

P_{D}=F_{D}Vφ=(C_{D}ρAᵣVφ²/2)cos αᵢVφ=

P_{D}=(C_{D}ρAᵣVφ³/2)cos αᵢ (B16)

Reynolds Number

R_{N}=VφLₐₚₚ/v=(VφLᵣ/v)cos αᵢ (B17)

Where v is the airflow kinematic viscosity; Lₐₚₚ is the apparent length (apparent chord) of the airfoil, and Lᵣ is the real airfoil length (real chord)

Airfoil Efficiency=ηₜ=Power generated/Power consumed=

ηₜ=(C_{L}/C_{D})tan αᵢ (B9)

From the above expressions it can be concluded

(a) The power generated is greatly established by the flow velocity Vφ, and if the inclination angle and induction angle increase this power increases as sin ai, whose maximum value is 1

(b) The drag power, in contrast, decreases as cos αᵢ. However for an effective decrease of cos αᵢ and the drag power, the vertical velocity is very large

(c) The power efficiency improves as ai increases, but there may be an inclination of the airfoil and the vertical velocity may be large in order to obtain such an improvement

(d) Since the Reynolds Number diminishes as ai increases, then airfoil coefficients CL and CD require a large value of the flow velocity Vφ, so that they can reach values where the bubble effects decrease and allow a better performance of the airfoils

(e) According to Eq. (B11), in order to increase Vv, it is convenient to increase the induced angle αI, in such a way that αapp=αᵣ−α_{I} tends to zero, and ai tends to the static attack angle a,. This is a desirable situation because then the airfoil efficiency CL/CD increases and so also do both the airflow motor efficiency and the useful power generated. For such reasons the static attack angle αr is chosen to be large enough, for example in the range 35≦αᵣ<55. Larger values of the static attack angle αᵣ may be less preferred because according to Eq. (B 17) the Reynolds number can decrease too much, which will lead in turn to a reduction of the airfoil efficiency C_{L}/C_{D}. This feature of the thermal airfoil turbine contrasts with that of conventional turbines in which the static attack angle αᵣ is usually very low (tending to zero). Hence conventional turbines have relatively smaller efficiency (less than 59.3, according to Betz's law). However thermal airfoil turbines can have a much higher efficiency because they operate at a much higher value of the static attack angle αr (Typically at least about 45° and up to about 50°, or up to about 55°).

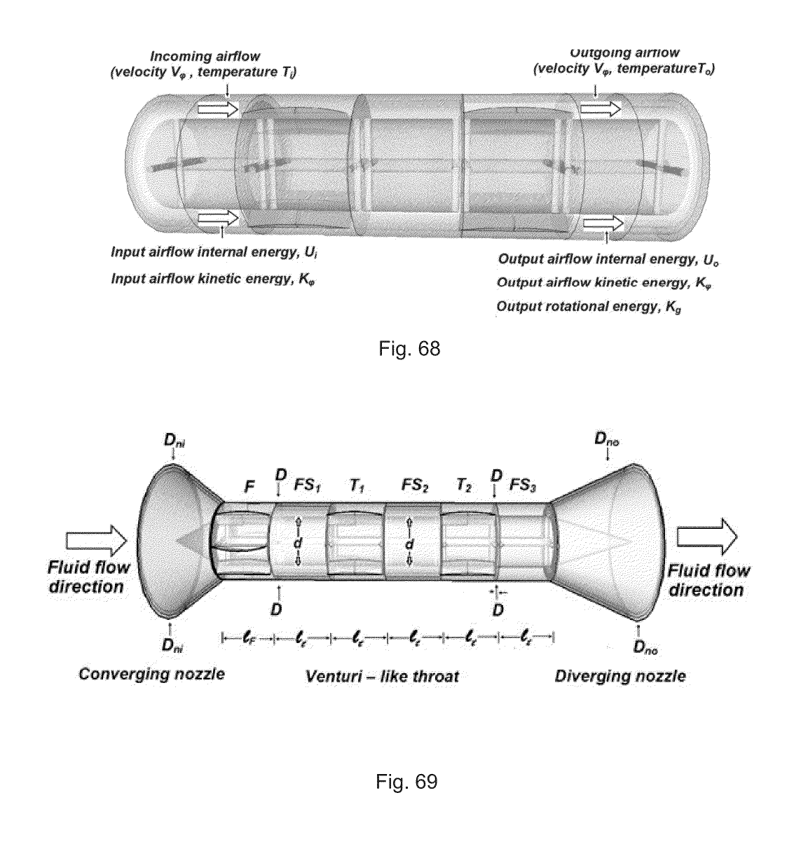

(f) Since in a thermal airfoil turbine the airflow “sees” the airfoil at an apparent angle approaching 0°, the airfoil is almost transparent to the airflow. As a result the airfoils do not decelerate significantly the airflow, i.e., the airflow velocity Vφ entering the turbine remains practically the same as the airflow velocity at the output of the turbine. (See also FIG. 68). This feature of the thermal airfoil turbine allows the placement of one or more identical turbines after the first one to increase the airflow motor efficiency and the generated power. This is not possible in conventional wind turbines because they extract the energy from the kinetic energy of the incoming airflow, so the outgoing airflow has a smaller velocity. In contrast, the thermal airfoil turbine does not extract the energy from the kinetic energy of the incoming airflow. Instead they extract only part of the internal (thermal) energy of the incoming airflow. In fact, the changes in velocity, pressure, and temperature occur along the airfoil, but the velocity remain the same both before the leading edge of the airfoil and after the rear edge of the airfoil.

(g) It can be noted that as the inclination of the airfoil increases so does the vertical velocity, but in contrast the lift force decreases because it depends on the factor cos αᵢ. Hence for an infinite vertical velocity, the power generated is not infinite on account of the fact the lift force diminishes to zero, and, as indicated by Equation (B15), the power generated has a limit determined by the airflow velocity Vφ.

### Thermal Airfoil Turbines as an Aerodynamic Sub-System

Thermal airfoil turbines can be viewed as an aerodynamic subsystem, as the one shown in FIG. 68. This subsystem has two energy inputs, namely, the input airflow internal energy Uᵢ which is proportional to the temperature difference (Tᵢ−Tₐ) of the incoming airflow, where Tₐ is the absolute zero temperature (−273° C.), and the input airflow kinetic energy Kφ which is proportional to Vφ².

In contrast, at the output of the subsystem there appear three energies, namely, the output internal energy Uₒ which is proportional to the temperature difference (Tₒ−Tₐ) of the outgoing airflow; the output airflow kinetic energy, which is practically the same as the input kinetic energy on account of the fact that the outgoing flow velocity and the incoming airflow velocity remain practically the same if power losses in the throat (Bearing losses and drag losses in the cylinders) are neglected; and the output rotational energy K_{g} which manifests itself in the torque that arises on the turbine shaft. Since Tₒ is always less than Tᵢ, this implies that Uₒ<Ui. The difference Uo−Ui there appears as the output rotational energy K_{g}. Hence, energy balance is maintained (Uᵢ+Kφ=Uₒ+Kφ+K_{g}).

Several proof of concept (POC) prototypes for the airflow motor now follow. An aim is to design a low-power airflow motor prototype with an efficiency exceeding 50%. For evaluating the performance of the airflow motor, as a benchmark or reference the theoretical maximum efficiency of a horizontal axis wind turbine (HAWT) will be used, which according to Betz's law is 59.3%.

In order to maximize the air motor power efficiency, powers P_{D} and P _{ec} are minimized, and at the same time power P_{G} is maximized.

### Minimization of P_{ec}.

If Vφ is constant it can be seen from Eq. (B2) that the power consumed by the empty chamber, P_{ec}, can be minimized by reducing the cross sectional area Aᵢ of the airflow passage within the Venturi-like throat. According to Equation (B1), this can be done by making the product (D+d)(D−d) as small as possible while keeping the airfoil height (D−d)/2 greater than zero. In the prototypes to be presented the following values were chosen: airfoil height=9 cm; D=50 cm and d=32 cm. At Vφ=20 m/s, the theoretical power consumed by the empty chamber, according to Eq. (B2), is P_{ec}=570.35 W.

Maximization of turbine efficiency.

According to Eq. (B9), in order to maximize the thermal airfoil turbine efficiency ηₜ, the ratio (P_{G}/P_{D}) is maximized An effective way of achieving this is by increasing the Reynolds Number R_{N}. As is shown in Ref. B4, as the Reynolds number increases so does the maximum lift/drag ratio. This means it is possible to both increase the power generated by the turbine and the turbine efficiency simply by increasing the Reynolds number. This can be done, according to Eq. (B7) by increasing either the airflow speed Vφ in the Venturi throat, or the airfoil chord length, c, or by increasing both. If maintain the current framework is maintained (empty chamber) of the airflow motor by keeping unchanged parameters D=50 cm and d=32 cm, both PG, ηₜ and η_{AM} simply can be augmented by increasing the length c as much as possible. However there is an upper limit to the maximum value of c. It can be shown that the chord length, the number of airfoils Na, the attack angle and the diameter d of inner cylinder are related by

c=πd/(Nₐ sin α) (B18)

And the horizontal width we of the internal and external cylinders is given by

w_{c}=c cos α (B19)

By combining Equations (B18) and (B 19), the following relationship is obtained for the chord length c as a function of parameters d, Nₐ and w_{c}

c=[(πd/Nₐ)²+w_{c}²]^{1/2} (B20)

Rearranging Eq. (B20)

Nₐc=[(πd)²+(Nₐw_{c})²]^{1/2} (B21)

On the other hand, by combining Equations (B4) and (B6)

P_{G}=(¼)ρNₐcC_{L}(D−d)sin αVφ³ (B22)

Hence, in order to obtain a generated power P_{G} as large as possible one way of doing it is by increasing the product Nₐ c as much as possible. But according to Equation (B21), this can be done by increasing either d, or w _{c}, or both. For this prototype the value of d was fixed at d=32 cm. Table A below shows the values calculated for the product Nₐ c, for d and N a fixed at d=32 cm and Nₐ=4 blades, for values of the cylinder width w c varying between 16 and 20 cm.

TABLE A
Chord c and product (Nₐ c) as a function
of parameters d, Nₐ and w_{c}

| d, cm | Nₐ | w_{c}, cm | c, cm | Nₐ c |
|---|---|---|---|---|
| 32 | 4 | 16.00 | 29.79 | 119.17 |
| 32 | 4 | 18.00 | 30.91 | 123.65 |
| 32 | 4 | 20.00 | 32.12 | 128.48 |
| 32 | 4 | 16.00 | 26.50 | 106.00 |

For comparison purposes the value of the product (Nₐ c) is shown to correspond to the values d=32 cm, Na=4 airfoils, w_{c}=16 cm, and c=26.50 cm, which were used in Prototype #2. For this airflow motor P_{G}=210.47W, and P_{D}=32.57 W were obtained, for an airflow velocity equal to 22.38 m/s (See Table D below). However, it can be seen from Table A, that there is room for improvement if greater values for c, for w c, or both are chosen. For example, with d=32 cm, Nₐ=4 airfoils, w_{c}=20 cm, c=32.12 cm, and Nₐc=128.48 cm, which represents an improvement of (128.48−106)/106*100=21.21%. It is to be expected that P_{G} for these values will increase at least in the same proportion up to P_{G}=255.10 W, and by using a turbine with two identical stages (Nₛ=2) it is possible to reach P_{G}=510.2 W.

### Effect of the Decrease of Airfoil Height and Increase of Airfoil Chord Length on Generated Power

One way of increasing the power generated by the thermal airfoil turbine, P G, consists in decreasing the airfoil height (D−d)/2, and/or increasing the airfoil chord c. In fact, from Eq. (B22) if parameters of a turbine 1 are changed to convert it into a turbine 2, keeping the same static attack angle a, it can be shown that

(P_{G2}/P_{G1})=[ρ₂Nₐ₂c₂C_{L2}(D₂−d₂)/ρ1Nₐ₁c₁C_{L1}(D₁−d₁)](V_{φ2}/V_{φ1})³ (B23)

Now, assuming there is no change in the air density (ρ₂=ρ₁), and that lift coefficients do not change appreciably (C_{L2}=C_{L1}), Eq. (B23) can be written as

(P_{G2}/P_{G1})=[Nₐ₂c₂(D₂−d₂)/Nₐ₁c₁(D₁−d₁)](Vφ₂/Vφ₁)³ (B24)

Eq. (B24) can be used to calculate the relation (P_{G2}/ P_{G1}) when the number of airfoils (Nₐ) changes, and the airfoil height (D−d)/2, and/or the airfoil chord c change.

For the specific case where the number of airfoils is kept the same (Nₐ₂=Nₐ₁), Eq. (B24) can be rewritten as

(P_{G2}/P_{G1})=[c₂(D₂−d₂)/c₁(D₁−d₁)](Vφ₂/Vφ₁)³ (B25)

But, from the continuity equation:

(Vφ₂/Vφ₁)³=[(D₁+d₁)(D₁−d₁)/(D₂+d₂)(D₂−d₂)]³ (B26)

Now plugging numerical values of geometric parameters in Equations (B25) and (B26) to obtain the relationship (P_{G2}/P_{G1}). For example, assuming D₁=D₂=0.5 m; d₁=0.32 m; d₂=0.36 m; c₁=0.265 m; c₂=0.29 m

(V_{φ2}/V_{φ1})=1.226 (B27)

(V_{φ2}/V_{φ1})³=1.8424 (B28)

And

P_{G2}=1.568 _{PG1} (B29)

These results indicate that by reducing airfoil height from 0.09 m to 0.07 m, and by increasing the chord length c from 0.265 m to 0.29 m, the airflow velocity Vφ increases by a factor of 1.226, and the generated power increases by a factor of 1.568.

### Minimum Separation Between Airfoils

It can be shown that the separation s between the airfoils placed over the internal preferably satisfy the following relationship

s≦πd/Na (B30)

On the other hand, it can be shown that

s=c sin α (B31)

To avoid inter-airfoil interference, s=c. From Eq. (B23)

Nₐ≦πd/s (B32)

Nₐ≦(πd)/(c sin α) (B33)

And

c≧(πd)/(Nₐ sin α) (B34)

For Nₐ=4 airfoils, d=0.32 m y α=50°

c=(π0.32)/(4 sin 50°)=0.328 m (B35)

For c=0.32 m, and N ₐ=4 airfoils, the minimum separation between consecutive airfoils is from Eq. (B24)

s=(0.32)sin 50°=0.245 m (B36)

For c=0.32 m, d=0.32 m y α=50°, it is not possible to increase Nₐ beyond Na=4.

### Procedure for Evaluating the POC Prototypes

In order to attain maximum efficiency and maximum useful power with the airflow motor, a suitable load is attached to the turbine shaft so that this operates at the rotational speed at which the difference P_{G}−P_{D} is a maximum. In the case of the example turbine given before this occurs at n=65 rpm, as shown in FIG. 64. A suitable load can be an electric generator geared up to the turbine shaft. Another possibility consists of using the fan F as a load for the turbine, so the turbine shaft is attached to the fan shaft, but a suitable gear may be used to reduce the maximum rotational speed (which occurs when the turbine is in the free-running condition, at which T=0 and P_{G}=0) to the value of n for which the difference P_{G}−P_{D} is a maximum. The last alternative is preferred.

The procedure consists then in routinely testing several gear sets until finding one that produces maximum value for P_{G}−P_{D}. First, the turbine is placed in the Venturi throat of the airflow motor. An electric drill attached to the fan shaft is used to move the fan blades and thus create the airflow that is going to impact the turbine airfoils. First the turbine is tested in its free-running condition, i.e., when its shaft is not attached to the fan shaft. Both the torque T_{d0}, N.m, applied by the drill to the fan and the fan speed nFo are measured. With these two values the power applied by the drill to the fan is calculated by the formula

P_{d0}=(π/30)T_{d0}n_{F0}, W (B37)

Next the turbine is geared-up to the fan, using the gear set that produces maximum P_{G}. In this condition, both the drill torque T_{d} and the fan rotational speed nF are measured. The power P_{d} supplied by the fan under this condition is calculated from the formula

P_{d}=(π/30)T_{d}n_{F}, W (B38)

If P_{d} turns out to be less than P_{d0} this means that the turbine is actually generating power and produces an extra torque Tₑ above T_{d0} on the fan shaft that helps to reduce the power P_{d} applied by the drill to the fan. In this condition, the total torque T_{f} applied to the fan shaft is

Tᵣ=T_{d0}+Tₑ (B39)

This torque T_{f} can then be used to calculate the total power P_{f} applied to the fan both by the drill T_{d0} and the turbine Tₑ. This power can then calculated by the formula

P_{f}=(π/30)T_{f}n_{F}, W (B40)

In order to calculate P_{f}, the extra torque Tₑ is evaluated first, as is shown below.

### Evaluation of the Extra Torque Te

This torque is necessary to overcome the drag power P_{D} introduced by turbine airfoils plus the gear losses P_{g}. Gear losses P_{g} can be estimated as 7.5 W per turbine, and drag power P_{D} can be calculated from the well known formula

P_{D}=(½)ρC_{D}AₚNₛNₐVφ³ cos α, W (B41)

Where ρ is the air density, ρ=1.23 kg/m3, CD is the airfoil drag coefficient, and Aₚ is the planform area of airfoils given by

Aₚ=c(D−d)/2 (B42)

Nₐ is the number of airfoils, Vφ is the velocity of the airflow in the Venturi section, α is the attack angle, and Nₛ is the number of identical stages in the turbine placed in the Venturi section.

The total power loss PLoss is then given by

P_{Loss}=P_{D}+NₛP_{g} (B43)

On the other hand P_{Loss} and the extra torque Tₑ are related by the formula

P_{Loss}=(π/30)Tₑn_{F}, W (B44)

Hence

Tₑ=(30/π)(P_{Loss}/n_{F}), N.m (B45)

### Calculation of Power Generated, Drag Power, Turbine Efficiency, and Airflow Motor Efficiency

The power generated PG by the turbine can be calculated from

P_{G}=P_{f}−P_{d}, W (B46)

Drag power PD is calculated from

P_{D}=P_{f}−P_{d0}, W (B47)

Turbine efficiency ηₜ is defined as

ηₜ=(P_{G}/P_{D}) (B48)

Finally, the airflow motor efficiency η_{AM} is defined as

η_{AM}=(P_{G}/P_{d})100 (B49)

### Evaluation of the Proof of Concept Prototype.

Several POC prototypes of the airflow motor have been designed, built and tested and values on performance have been obtained. The main features Prototype #3, are shown in Table B below. The main parameters of this airflow motor prototype having a two stage turbine, and operating at a fan rotational velocity of 1412 rpm, are given.

TABLE B
Parameters of Prototype #3

| Parameters of Prototype | #3 |
|---|---|
| D, m | 50 |
| d, m | 32 |
| Chord length, c, m | 26.5 |
| C_{D} (estimated to calculate drag losses) | 0.09 |
| Number of airfoils/stage, Nₐ | 4 |
| Number of stages, Nₛ | 2 |
| (Nₛ Nₐ c), cm | 212 |
| Venturi airflow velocity, V, m/s | 23.5 |
| Attack angle, α, ° | 50 |

In Table C measured values for several quantities are shown

TABLE C
Measured values for Prototype #3

| n_{F0}, rpm | T_{d0}, Nm | n_{F}, rpm | T_{d}, Nm |
|---|---|---|---|
| 1,412 | 5.328 | 1,412 | 3.2 |

### Calculations

Using measured values of Table C, and parameters of Table B, the following quantities were calculated.

From Eq. (B37),

P_{d0}=(π/30)T_{d0}n_{F0}=(π/30)(5.328)(1,412)=787.82 W

From Eq. (38),

P_{d}=(π/30)T_{d}n_{F}=(π/30)(3.2)(1,412)=473.17 W

It can be observed that Pa turned out to be less than NO. This result means that the 2-stage turbine is in fact generating power.

From Eq. (B42) and Table 2,

Aₚ=c(D−d)/2=(0.265)(0.5−0.32)/2=0.02385 m²

From Eq. (B41) and Table 2,

P_{D}=(½)ρC_{D}AₚNₛNₐVφ³ cos α=

PD=(½)(1.23)(0.09)(0.02385)(2)(4)(23.9)3 cos 50=92.67 W

From Eq. (B43) and Table B, with P_{g}=7.5 W, and Nₛ=2 stages,

P_{Loss}=P_{D}+NₛP_{g}=92.67+(2)(7.5)=107.67 W

Now, by substituting above result in Eq. (B45)

Tₑ=(30/π)(P_{Loss}/n_{F})=Tₑ=(30/π)(107.67/1,412)=0.73 N.m.

And, by substituting previous value in Eq. (39), with Td0=5.328 N.m.,

T_{f}=T_{d0}+Tₑ=5.328+0.73=6.056 N.m.

Now, from Eq. (40),

P_{f}=(π/30)T_{f}n_{F}=(π/30)(6.056)(1412)=895.47 W

And, from Eq. (B46) and previous result, the generated power PG, is

P_{G}=P_{f}−P_{d}=895.47Δ473.17=422.3 W

From Eq. (B47), drag power, PD, is calculated as

P_{D}=P_{f}−P_{d0}=895.47−787.82=107.65 W

Finally, from previous results and Equations (B48) and (B49), the turbine efficiency ηₜ, and the airflow motor efficiency η_{AM} can be calculated, respectively, as

ηₜ=(P_{G}/P_{D})=(422.3/107.65)=3.92

η_{AM}=(P_{G}/P_{d})(100)=(422.3/473.17)(100)=89.25%

In Table D below, values of P_{D}, P_{G}, P_{d}, ηₜ, and η_{AM} are shown for 3 POC prototypes of the airflow motor built and tested.

TABLE D
Performance Results for three POC Prototypes of the Airflow Motor

| Airflow | | | | Nₛ | | | | | | |
|---|---|---|---|---|---|---|---|---|---|---|
| Motor | | | C, | Nₐ c, | V_{φ}. | | | | | |
| Prototype | Nₐ | Nₛ | cm | cm | m/s | P_{D}, W | P_{G}, W | P_{d}, W | ηₜ | η_{AM},% |
| #1 | 5 | 1 | 18 | 90 | 22.7 | 40 | 140 | 540 | 3.5 | 25.93 |
| #2 | 4 | 1 | 26.5 | 106 | 22.4 | 32.57 | 210.47 | 487.47 | 6.46 | 43.18 |
| #3 | 4 | 2 | 26.5 | 212 | 23.9 | 107.65 | 422.3 | 473.17 | 3.92 | 89.25 |

### Preliminary Conclusions

1. From Table D it can be seen that as the product (N ₛ N ₐ c) from the value 90 cm of Prototype #1, to the value 106 cm of Prototype #2, up to the value 212 cm of Prototype #3, the power generated P_{G} increases from 140 W, to 210.47 W, up to 422.3 W, respectively, and the airflow motor efficiency η_{M} increases from 25.93%, to 43.18%, up to 89.25%. Greater values of the generated power P_{G}, and airflow motor efficiency i Am can undoubtedly be achieved simply by increasing even more the product (N ₛ N ₐ c). The latter can be done by increasing the number of stages, Ns, the number of airfoils per stage, Nₐ, or the chord length c, or all of them. However, Nₐ only can be increased to before reaching the value where the phenomenon of airfoil interference appears.

2. For practical reasons it is not recommended to increase the number of stages beyond N ₛ=2. Instead it is a better option to increase the value of the chord length c, which implies increasing the value of the turbine horizontal width w c, according to Equations (B33) and (B34).

3. The airflow motor efficiency of Prototype #3 reaches 89.25% which far beyond the Betz limit (59.3%). To the best of Applicant's knowledge no prior art turbine can achieve such a high efficiency.

4. A self sustained movement airflow motor (i.e., a motor efficiency above 100%) may be obtained. One possible way of achieving this is, for example duplicating the chord length c of by Prototype #3 (i.e., by making c=53 cm), but this calls for increasing the cylinder lengths w c from 16 cm up to w c=53 cos 50°=34.07 cm, according to Eq. (B 19). In addition to that, the diameter d of the internal cylinder has also to be increased. All of this requires a structural change of the whole system.

### Further Test Results for Prototype #3

The following values were obtained for the airflow motor with 2 identical turbines of 4 airfoil each, airfoil chord c=0.265 m; airfoil height=0.09 m; D=0.5 m; d=0.32 m, and using a gear ratio 1:2.56 for the turbine geared up to the fan.

TABLE E
Measured results for the Airflow motor and turbines in free-running
condition

| Turbine | | T_{drill}, | | | | |
|---|---|---|---|---|---|---|
| Condition | n_{fan}, rpm | N · m | T_{fan}, N · m | P_{drill}, W | Pfan, W | P_{G}, W |
| Free | 1,363 | 4.54 | 4.54 | 648.30 | 648.30 | 0.00 |
| running | | | | | | |
| Free | 1,412 | 4.88 | 4.88 | 720.77 | 720.77 | 0.00 |
| running | | | | | | |
| Free | 1,555 | 5.91 | 5.91 | 962.68 | 962.68 | 0.00 |
| running | | | | | | |

TABLE F
Measured results for the Airflow motor and turbines geared up to fan.

| Turbine | | | T_{fan}, | | | | | |
|---|---|---|---|---|---|---|---|---|
| Condition | n_{fan}, rpm | T_{drill}, N · m | N · m | P_{drill}, W | Pfan, W | P_{G}, W | ηₜ | η_{AM}, % |
| Geared Up | 1,363 | 2.98 | 5.74 | 452.42 | 819.51 | 394.08 | 2.30 | 92.63 |
| Geared Up | 1,412 | 3.15 | 6.16 | 465.98 | 911.11 | 445.13 | 2.34 | 95.53 |
| Geared Up | 1,555 | 3.63 | 7.47 | 591.11 | 1,216.91 | 625.80 | 2.46 | 105.87 |

### Conclusion

When operating the fan at 1,555 rpm, Prototype #3 was capable of generating 625.8 W and the efficiency for the airflow motor reached 105.87%. By duplicating the fan rotational speed the airflow motor can be expected to produce 5 kW and even a much higher efficiency. Hence the goal to design a POC prototype with efficiency greater than 50% has been achieved in excess.

### Airflow Motor as an Air Conditioning System and Power Generator

As explained farther above and shown in FIG. 68, the airflow temperature Tₒ at the output of a thermal airfoil turbine sub-system is always lower than the airflow temperature Tᵢ at its entrance. This fact can be exploited to implement an air conditioning system which at the same time serves as a power generator that can be used to drive an electric generator or to move a vehicle. FIG. 69 shows such a system containing just two thermal airfoil turbines. However the system can contain one or more thermal airfoil turbines. Of course, the larger the power generated by the system, the larger will be the reduction of temperature in the outgoing airflow.

### Airflow Motor as an Efficient Wind Turbine

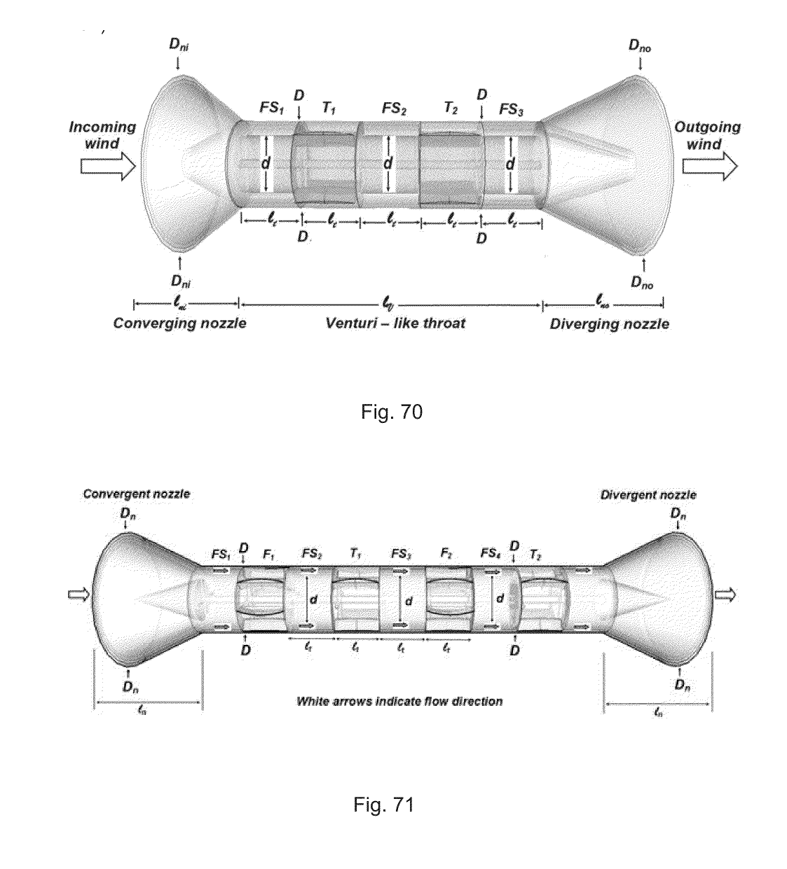

FIG. 70 shows an arrangement that can be used as a wind turbine. It is just an airflow motor in which the fan has been removed, and the wind is allowed to enter in the converging nozzle. Although the wind turbine shown in FIG. 70 contains just two thermal airfoils turbines there can be one or more thermal airfoil turbines placed in the Venturi-like throat. Of course, the greater the number of turbines the greater will be the efficiency and generated power that can be achieved, for example the version shown in FIG. 71 which has four turbines. This wind turbine can have efficiency much greater than the Betz limit (59.3%). The whole structure is fixed onto a horizontal platform and placed at a height and oriented at a direction where the wind velocity is likely to be above 0.2 m/s (0.72 km/h).

### REFERENCES

Reference 1: Fundamentals of Fluid Mechanics, Sixth Edition SI Version, By: B. R. Munson, D. F. Young, T. H. Okiishi, and W. W. Huebsch. Publisher: John Wiley & Sons, 2010

Reference 2: United States Patent Application Publication, Use of Air Internal Energy and Devices, by Hirshberg, I, Pub. No. : US 2008/0061 559 A1, Pub. Date: Mar. 13, 2008

Reference 3: United States Patent Application Publication, Thermal Airfoil Turbine, by Luis Indefonso Solorzano, Pub. No.: 2011 0097209 A1, Pub. Date: Apr. 28, 2011

Reference 4: Wind Turbine Blade Analysis using the Blade Element Momentum Method, Version 1.1 , by Grant Ingram, Creative Commons Attribution-ShareAlike 3.0 Unported License, Oct. 18, 2011.

Reference B1. Published United States Patent Application NO.20110097209 (Solorzano), Luis Reference B2. Vennard, John k., “Elementary Fluid Mechanics”. 4th Edition. Published 1940/00/ . . . Publisher John Wiley & Sons Inc.

Reference B4. Miley, S. J., “A catalog of low Reynolds number airfoil data for wind turbine applications/S. J. Miley “(http://wind.nrel.gov/public/library/3387.pdf)

In the description provided herein, numerous specific details are set forth. However, it is understood that embodiments of the invention may be practiced without these specific details. In other instances, well-known methods, structures and techniques have not been shown in detail in order not to obscure an understanding of this description.

In the following claims, any of the claimed embodiments can be used in any combination.

1. An energy conversion turbine comprising:
a central shaft having a rotational axis,
a plurality of blades in mechanical connection with and disposed around the central shaft, . wherein the turbine is configured such that fluid flowing about the blades causes the temperature about one blade face to become lower than the temperature about the opposing blade face such that at least part of the thermal energy of the fluid is transferred to the blades and transformed into kinetic energy.

2. The energy conversion turbine of claim 1 wherein the blades are airfoil-shaped.

3. The turbine of claim 1 wherein the blades are mounted so as to present an angle of attack of at least about 10° with reference to the rotational axis of the central shaft.

4. The turbine of claim 3 wherein the horizontal dimension of a blade is greater than the vertical dimension of the blade.

5. A power conversion machine comprising:
a fluid accelerator,
a throat having a fluid inlet and a fluid outlet, and
the turbine of claim 1 disposed within the throat and rotatable therein, wherein the machine is configured such that fluid accelerated by the fluid accelerator is caused to pass through the throat so as to cause rotation of the turbine.

6. The power conversion machine of claim 5 wherein the fluid accelerator is a conduit having a fluid inlet and a fluid outlet, the conduit fluid outlet being in fluid communication with the throat fluid inlet.

7. The power conversion machine of claim 6 wherein the conduit is a convergent nozzle.

8. The power conversion machine of claim 5 wherein the fluid accelerator accelerates the fluid velocity by means requiring energy input.

9. The power conversion machine of claim 8 wherein the means requiring energy input is a fan configured to accelerate and drive fluid toward the turbine.

10. The power conversion machine of claim 9 wherein the fan is rotatable within the throat, and is coaxial with the turbine.

11. The power conversion machine of claim 8 wherein the means requiring energy input is a moving object (optionally an aircraft or a ship) to which the machine is attached.

12. The power conversion machine of claim 5 comprising a fluid decelerator configured to decelerate fluid exiting the turbine.

13. The power conversion machine of claim 12 wherein the fluid decelerator is a conduit having a fluid inlet and a fluid outlet, the conduit fluid inlet being in fluid communication with the throat fluid outlet.

14. The power conversion machine of claim 13 wherein the conduit is a divergent nozzle.

15. The power conversion machine of claim 5 wherein the throat is a Venturi-like throat.

16. The power conversion machine of claim 5 comprising two or more turbines of claim 1, all turbines being coaxial.

17. The power conversion machine of claim 5 comprising a first fluid flow straightener configured to straighten the flow of fluid entering the throat, and/or a second fluid flow straightener configured to straighten flow of fluid exiting the throat.

18. A method of generating power comprising the steps of:
providing the power conversion machine of claim 5,
providing fluid flow to the turbine, the fluid flow being incident on the leading edges of the blades, the fluid flow being sufficient to cause the central shaft to rotate, and
harnessing the power generated from the rotational output of the central shaft.

19. The method of claim 18 comprising the step of providing energy input to the means requiring energy input (where present) so as to accelerate and drive fluid toward the turbine.
